(19) United States
(12) Patent Application Publication
(10) Pub. No.: US 2017/0157613 A1
(43) Pub. Date: Jun. 8, 2017

(54) SYSTEMS AND METHODS FOR THERMAL CYCLING

(71) Applicant: Coyote Bioscience Co., Ltd., Beijing (CN)

(72) Inventors: Xiang LI, Beijing (CN); Chen LI, Hefei (CN); Yuguang HAN, Chengde (CN); Huiying FENG, Beijing (CN)

(21) Appl. No.: 15/356,156

(22) Filed: Nov. 18, 2016

Related U.S. Application Data
(63) Continuation of application No. PCT/CN2015/079499, filed on May 21, 2015.
Application No. PCT/CN2015/079499 is a continuation-in-part of application No. PCT/CN2014/078022, filed on May 21, 2014.

(51) Int. Cl. B01L 7/00

(52) U.S. Cl. CPC B01L 7/52; B01L 2200/18; B01L 2300/0654

(57) ABSTRACT

Systems and methods for low voltage power thermal cycling are provided. A nucleic acid amplification device comprising a thermal cycler and a detector is capable of operating using a low operating voltage, such as 12 V. The nucleic acid amplification device may include a portable energy storage device that can provide operating power. The nucleic acid amplification device may be powered by a vehicle and deployed to remote locations.

### CROSS-REFERENCE

This application is a continuation of PCT Patent Application Serial No. PCT/CN2015/079499 filed on May 21, 2015, which is a continuation-in-part of PCT Patent Application Serial No. PCT/CN2014/078022 filed May 21, 2014, each of which is incorporated herein by reference in its entirety.

### BACKGROUND

Nucleic acid amplification methods permit selected amplification and identification of nucleic acids of interest from a complex mixture, such as a biological sample. Nucleic acid of interest can be amplified via amplification methods known in the art, such as thermal cycling based approaches including polymerase chain reaction (PCR). During or following amplification of the nucleic acid of interest, the products of amplification can be detected and results of the detection interpreted by an end user. Traditional nucleic acid amplification and detection methods typically involve a thermal cycling apparatus that requires a high voltage power input. Real-time PCR techniques involve the use of a detector that can detect a signal from a sample undergoing nucleic acid amplification in real-time. The combined thermal cycling and detection require a degree of power input that limits the use of the thermal cycler.

Point-of-care (POC) testing has the potential to improve the detection and management of infectious diseases in resource-limited settings with poor laboratory infrastructure, or in remote areas where there are delays in the receipt of laboratory results and potential complications to following up with patients. However, many challenges face performing nucleic acid amplification in POC settings. For instance, if a high voltage power input is needed to perform real-time PCR, the thermal cycler will have limited portability. For example, batteries may be quickly drained using such traditional systems. Similarly, the power sources that can be used to power such devices are limited, thus preventing full use of a thermal cycler in different environments and situations.

### SUMMARY

A need exists for improved systems and methods for low power thermal cycling. Such low power thermal cycling may permit thermal cycling apparatuses to be portable and operable in different situations. For example, the thermal cycling apparatuses may be taken out into the field or into portions of the country where regular power sources are not readily available. The use of low voltage power may also permit the thermal cycler to be charged in transit or be charged by power sources that may otherwise not be able to accommodate traditional thermal cycling devices. These features can greatly improve the ability to perform thermal cycling in different point-of-care (POC) settings.

An aspect of the present disclosure provides a device for conducting a nucleic acid amplification reaction involving multiple thermal cycles, the device comprising: an automated thermal cycler configured to (1) receive at least one sample comprising a target nucleic acid and an agent that detects amplified target nucleic acid, and (2) alternatively heat and cool the sample; and a detector configured to detect an optical signal from the sample while the amplification reaction is in progress without removing the sample from the device, wherein the optical signal is related to the amount of amplified target nucleic acid in the sample, wherein the device is configured to operate with no more than a total of about 48 V of electricity.

The device may be configured to operate with no more than a total of 12 V of electricity. The device may be configured to operate when powered by a vehicle battery. The device may be configured to operate when powered by an external battery pack.

In some embodiments, the sample is contained in one or more sample containers. The one or more sample containers may be test tubes with container tops. The automated thermal cycler may comprise a heating block having a plurality of indentations configured to accept the one or more sample containers. The weight of the device per indentation may be no more than 0.2 kg. The device may be dimensioned to hold the sample containers have a height of no more than 21 mm.

The sample may further comprise reagents for nucleic acid amplification. The automated thermal cycler may be capable of controlling a temperature of the sample to within plus or minus 0.5 degrees C. In some implementations the detector may detect the optical signal as a fluorescent signal from the sample. A sealed light transmission path is provided between the sample and the detector.

The automated thermal cycler and the detector may be provided within a housing. The housing may be no more than about 15 cm tall. A length of the housing may be no more than about 15 cm. Optionally, the device has a greatest dimension of no more than about 15 cm. The device may weigh no more than about 2 kg.

The device may further comprise a power connector configured to connect the device to a power source of no more than 24 V. The power connector may be configured to connect the device to a power source of no more than 12 V. In some implementations, the power connector can be a plug. The power connector may be configured to be plugged into a charging port within a vehicle. The device may further comprise an adaptor configured to be plugged into a charging port within a vehicle that is configured to removably connect to the power connector.

The agent that detects amplified target nucleic acid can be a nucleic acid binding dye. The dye may be a DNA-intercalating dye. The dye may be SYBR® Green, EvaGreen®. The agent that detects amplified target nucleic acid can be a nucleic acid probe capable of specific hybridization to the target nucleic acid. The probe may be a Taqman probe.

Another aspect of the present disclosure provides a suitcase comprising a device as described above or elsewhere herein; and a battery pack configured to power the device as previously described. The device and the battery pack may be stored in separate compartments of the suitcase. The suitcase may further comprise a dry bath and a centrifuge.

Another aspect of the present disclosure provides a method for conducting a nucleic acid amplification reaction comprising multiple thermal cycles. The method may comprise: (a) providing the device as previously described; and (b) powering the device with no more than a total of 12 V.

Another aspect of the present disclosure provides a method of deploying a device for conducting a nucleic acid amplification reaction at a user location, comprising providing power to the device using a vehicle while the vehicle is in operation, wherein the device comprises (a) an automated thermal cycler configured to (1) receive a sample comprising a target nucleic acid and (2) alternatively heat and cool the sample, and (b) a detector configured to detect an optical signal from the sample; and using the device at the location to effect (a) alternatively cooling and heating the sample using the automated thermal cycler and (b) detecting the optical signal from the sample while the alternative cooling and heating are occurring, or has been completed without removal of the sample or a portion thereof from the device.

In some embodiments, no more than a total of about 12 V is used to power the automated thermal cycler and the detector. The power provided by the vehicle may be no more than about 12 V. The power provided by the vehicle to power the device may be used to charge a battery of the device. The battery may be a lithium battery. The battery may be provided within a portable battery pack. The battery pack may be configured to be charged with no more than a 12 V input, and provides no more than a 12 V output to power the automated thermal cycler and the detector.

The power provided by the vehicle may be used while the device at the location. The vehicle may be traveling to the location while the vehicle is in operation. The power may be provided to the device from a battery of the vehicle.

The sample may be received in the automated thermal cycler within one or more sample containers. The one or more sample containers can be test tubes with container tops. The automated thermal cycler can comprise a heating block with a plurality of indentations configured to accept the one or more sample containers. The weight of the device per indentation may be no more than 0.2 kg. The sample containers may have a height of no more than 21 mm.

In some embodiments, the sample further comprises reagents necessary for performing the nucleic acid amplification. The automated thermal cycler may be capable of controlling a temperature of the sample to within plus or minus 0.5 degrees C. The optical signal can be a fluorescent signal from the sample. The method may further comprise providing a sealed light transmission path between the sample and the detector.

The automated thermal cycler and the detector may be provided within a housing. The housing may be no more than about 15 cm in height. Optionally, a length of the housing is no more than about 15 cm. The device may weigh no more than about 2 kg.

The sample may comprise an agent that detects amplified target nucleic acid. The agent may be a nucleic acid binding dye. The dye may be a DNA-intercalating dye. The dye may be SYBR® Green, or EvaGreen®. The agent that detects amplified target nucleic acid can be a nucleic acid probe capable of specific hybridization to the target nucleic acid. The probe may be a Taqman probe.

Another aspect of the present disclosure provides a device for conducting a nucleic acid amplification reaction involving multiple thermal cycles, comprising an automated thermal cycler configured to (1) receive at least one sample comprising a target nucleic acid and an agent that detects amplified target nucleic acid, and (2) alternatively heat and cool the sample; and a detector configured to detect an optical signal from the sample while the amplification reaction is in progress without removing the sample from the device, wherein the optical signal is related to the amount of amplified target nucleic acid in the sample, wherein the device (1) is dimensioned to have a footprint of less than about 400 cm² and configure to hold a sample container having a height between about 15 mm to 25 mm; (2) weights no more than about 2 kg; and (3) is configured to operate with no more than a total of about 48 V of electricity.

The automated thermal cycler may be capable of controlling a temperature of the sample t within plus or minus 0.5 degrees C. The device may be configured to operate with no more than a total of about 12 V of electricity.

Another aspect of the present disclosure provides a system for conducting nucleic acid amplification, comprising a thermal cycler that (i) receives a reaction mixture comprising a biological sample having a target nucleic acid molecule and reagents necessary to conduct a nucleic acid amplification reaction to generate amplified target nucleic acid molecule(s) as amplification product(s) of the target nucleic acid molecule, and (ii) cycles a temperature of the reaction mixture to perform the nucleic acid amplification reaction to generate the amplified target nucleic acid molecule(s), wherein the thermal cycler has an operating voltage of no more than about 48 V during the nucleic acid amplification reaction; and a computer processor coupled to the thermal cycler and programmed to (i) instruct the thermal cycler to begin cycling the temperature at a first number of heating and cooling cycles to perform the nucleic acid amplification reaction, (ii) change the first number of heating and cooling cycles to a second number of heating and cooling cycles while the thermal cycler is cycling the temperature, and (iii) instruct the thermal cycler to terminate cycling the temperature upon reaching the second number of heating and cooling cycles.

In some embodiments, the system further comprises a detector that detects an optical signal from the reaction mixture while the nucleic acid amplification reaction is in progress without removing the reaction mixture from the thermal cycler. In some embodiments, the optical signal is indicative of a quantity of the amplified target nucleic acid molecule(s) or rate of change of the quantity. In some embodiments, the system further comprises a sealed light transmission path that brings the reaction mixture in optical communication with the detector. In some embodiments, the thermal cycler and the detector are included in a housing. In some embodiments, the housing has a height and/or length of no more than about 15 cm. In some embodiments, the housing has a greatest dimension of no more than about 15 cm. In some embodiments, the housing having the thermal cycler and the detector has a weight of no more than about 2 kg.

In some embodiments, the computer processor is programmed to change the first number of heating and cooling cycles to the second number of heating and cooling cycles upon input received from a user. In some embodiments, the input is received from an electronic display operatively coupled to the computer processor. In some embodiments, the electronic display comprises a user interface with graphical and/or textual elements corresponding to the first number of heating and cooling cycles and the second number of heating and cooling cycles. In some embodiments, the user interface comprises graphical and/or textual elements corresponding to a progress of the nucleic acid amplification reaction with time.

In some embodiments, the thermal cycler comprises a heating element that heats the reaction mixture to increase the temperature. In some embodiments, the thermal cycler comprises a cooling element that cools the reaction mixture. In some embodiments, the heating element is a heating block having a plurality of indentations, wherein each of the plurality of indentations is dimensioned to accept a sample container having the biological sample and/or reagents. In some embodiments, a weight of the system per indentation is no more than 0.2 kg. In some embodiments, each of the plurality of indentations is dimensioned to hold the sample container having a height of no more than 21 mm.

In some embodiments, wherein the first number of heating and cooling cycles includes an initial heating phase followed by an initial cooling phase. In some embodiments, the first number of heating and cooling cycles includes an initial cooling phase followed by an initial heating phase. In some embodiments, the second number of heating and cooling cycles includes a final heating phase followed by a final cooling phase. In some embodiments, the first number of heating and cooling cycles includes a final cooling phase followed by a final heating phase.

In some embodiments, the computer processor is programmed to initiate the nucleic acid amplification reaction by instructing the thermal cycler to subject the reaction mixture to heating. In some embodiments, the computer processor is programmed to terminate the nucleic acid amplification reaction by instructing the thermal cycler to subject the reaction mixture to cooling in the absence of heating. In some embodiments, the operating voltage is no more than 24 V. In some embodiments, the operating voltage is no more than 12 V.

In some embodiments, the system further comprises a power source that supplies power to the thermal cycler during the nucleic acid amplification reaction, wherein the power source operates at the operating voltage. In some embodiments, the power source is a vehicle that provides the operating voltage. In some embodiments, the power source is a battery. In some embodiments, the battery is a lithium ion battery. In some embodiments, the battery is a portable battery. In some embodiments, the battery is configured to be charged with no more than a 48 V input, and wherein the battery provides no more than a 48 V output to power the thermal cycler. In some embodiments, the thermal cycler is disposed in a housing that is separate from the power source, and wherein the thermal cycler and the power source are operatively coupled through a power connector.

In some embodiments, the reaction mixture is in a sample container. In some embodiments, the sample container is a test tube with a lid.

In some embodiments, the thermal cycler is capable of controlling the temperature to within plus or minus 0.1 degrees C. In some embodiments, the reagents include a primer and a polymerization enzyme.

In some embodiments, the reagents include a chemical agent that permits detection of the amplified target nucleic acid molecule(s). In some embodiments, the chemical agent is an optical dye. In some embodiments, the optical dye is an intercalating dye. In some embodiments, the optical dye is configured to hybridize to target nucleic acid molecule. In some embodiments, the amplified target nucleic acid molecule(s) is a plurality of amplified target nucleic acid molecules.

In some embodiments, the thermal cycler cycles the temperature between at least two different temperatures. In some embodiments, the thermal cycler cycles the temperature between at least three different temperatures. In some embodiments, the thermal cycler cycles the temperature between a denaturing temperature, annealing temperature and elongation temperature.

Another aspect of the present disclosure provides a method for conducting nucleic acid amplification, comprising (a) providing a thermal cycler that includes a reaction mixture comprising a biological sample having a target nucleic acid molecule and reagents necessary to conduct a nucleic acid amplification reaction to generate amplified target nucleic acid molecule(s) as amplification product(s) of the target nucleic acid molecule, wherein the thermal cycler has an operating voltage of no more than about 48 V during the nucleic acid amplification reaction; (b) instructing the thermal cycler to cycle a temperature of the reaction mixture at a first number of heating and cooling cycles to perform the nucleic acid amplification reaction; (c) receiving a request to change the first number of heating and cooling cycles to a second number of heating and cooling cycles while the thermal cycler is cycling the temperature; and (d) instructing the thermal cycler to terminate cycling the temperature upon reaching the second number of heating and cooling cycles.

In some embodiments, the request to change the first number of heating and cooling cycles to the second number of heating and cooling cycles is received from a user. In some embodiments, the request is received from an electronic display operatively coupled to the computer processor. In some embodiments, the first number of heating and cooling cycles includes an initial heating phase followed by an initial cooling phase, or vice versa. In some embodiments, the second number of heating and cooling cycles includes a final heating phase followed by a final cooling phase, or vice versa. In some embodiments, the method further comprises, prior to (a), providing power to the thermal cycler from a power source.

Another aspect of the present disclosure provides a system for conducting nucleic acid amplification, comprising a thermal cycler that (i) receives a reaction mixture comprising a biological sample having a target nucleic acid molecule and reagents necessary to conduct a nucleic acid amplification reaction to generate amplified target nucleic acid molecule(s) as amplification product(s) of the target nucleic acid molecule, and (ii) cycles a temperature of the reaction mixture to perform the nucleic acid amplification reaction to generate the amplified target nucleic acid molecule(s); a detector operatively coupled to the thermal cycler, wherein the detector detects an optical signal from the reaction mixture while the nucleic acid amplification reaction is in progress; and a computer processor coupled to the thermal cycler and the detector, wherein the computer processor is programmed to (i) receive the optical signal from the detector while the nucleic acid amplification reaction is in progress, (ii) compare the optical signal or a signal change thereof to a respective threshold signal or signal change, and (iii) upon the optical signal or signal change reaching or exceeding the threshold signal or signal change, instruct the thermal cycler to terminate cycling the temperature and/or generate a notification that is indicative of the optical signal or signal change having reached or exceeded the threshold signal or signal change, wherein the thermal cycler and the detector have an operating voltage of no more than about 48 V.

In some embodiments, the system further comprises a sealed light transmission path that brings the reaction mixture in optical communication with the detector. In some embodiments, the thermal cycler and the detector are included in a housing.

In some embodiments, the thermal cycler comprises a heating element that heats the reaction mixture to increase the temperature. In some embodiments, the thermal cycler comprises a cooling element that cools the reaction mixture. In some embodiments, the heating element is a heating block having a plurality of indentations, wherein each of the plurality of indentations is dimensioned to accept a sample container having the biological sample and/or reagents.

In some embodiments, the computer processor is programmed to instruct the thermal cycler to subject the reaction mixture to cooling in the absence of heating upon the optical signal reaching or exceeding the threshold signal or signal change. In some embodiments, the operating voltage is no more than 24 V. In some embodiments, the operating voltage is no more than 12 V.

In some embodiments, the system further comprises a power source that supplies power to the thermal cycler and detector during the nucleic acid amplification reaction, wherein the power source operates at the operating voltage. In some embodiments, the power source is a vehicle that provides the operating voltage. In some embodiments, the power source is a battery. In some embodiments, the thermal cycler is disposed in a housing that is separate from the power source, and wherein the thermal cycler and the power source are operatively coupled through a power connector.

In some embodiments, the computer processor is programmed to generate and direct the notification for display on an electronic display of a user. In some embodiments, the electronic display is on an electronic device of the user, which electronic device is in network communication with the computer processor. In some embodiments, the notification indicates that cycling the temperature has been terminated.

In some embodiments, the signal change is a first or second derivative of the optical signal with time. In some embodiments, the signal change is a negative first or second derivative of the optical signal with time.

In some embodiments, the optical signal is a fluorescence signal.

In some embodiments, the thermal cycler cycles the temperature between at least two different temperatures. In some embodiments, the thermal cycler cycles the temperature between at least three different temperatures. In some embodiments, the thermal cycler cycles the temperature between a denaturing temperature, annealing temperature and elongation temperature.

Another aspect of the present disclosure provides method for conducting nucleic acid amplification, comprising (a) providing a thermal cycler that includes a reaction mixture comprising a biological sample having a target nucleic acid molecule and reagents necessary to conduct a nucleic acid amplification reaction to generate amplified target nucleic acid molecule(s) as amplification product(s) of the target nucleic acid molecule, wherein the thermal cycler is operatively coupled to a detector that detects an optical signal from the reaction mixture while the nucleic acid amplification reaction is in progress, wherein the thermal cycler and the detector have an operating voltage of no more than about 48 V; (b) receiving the optical signal from the detector while the nucleic acid amplification reaction is in progress; (c) comparing the optical signal or a signal change thereof to a respective threshold signal or signal change; and (d) upon the optical signal or signal change reaching or exceeding the threshold signal or signal change, (i) instructing the thermal cycler to terminate cycling the temperature and/or (ii) generating a notification indicative of the optical signal or signal change having reached or exceeded the threshold signal or signal change.

In some embodiments, the method further comprises instructing the thermal cycler to subject the reaction mixture to cooling in the absence of heating upon the optical signal reaching or exceeding the threshold signal or signal change. In some embodiments, the method further comprises, prior to (a), providing power to the thermal cycler and the detector from a power source. In some embodiments, the method further comprises generating and directing the notification for display on an electronic display of a user.

Another aspect of the present disclosure provides a system for conducting nucleic acid amplification, comprising a thermal cycler that includes a plurality of individually addressable and controllable thermal zones, wherein a given thermal zone (i) receives a reaction mixture comprising a biological sample having a target nucleic acid molecule and reagents necessary to conduct a nucleic acid amplification reaction to generate amplified target nucleic acid molecule(s) as amplification product(s) of the target nucleic acid molecule, and (ii) cycles a temperature of the reaction mixture to perform the nucleic acid amplification reaction to generate the amplified target nucleic acid molecule(s), wherein the thermal cycler has an operating voltage of no more than about 48 V during the nucleic acid amplification reaction; and a computer processor coupled to the thermal cycler and programmed to regulate the amplification reaction in the given thermal zone independently from amplification reactions in other thermal zones of the plurality of individually addressable and controllable thermal zones.

In some embodiments, the system further comprises a detector with plurality of sensors that optically detect optical signals from the plurality of individually addressable and controllable thermal zones, wherein a given sensor of the plurality of sensors detects optical signals from the reaction mixture. In some embodiments, the thermal cycler comprises a heating element that heats the reaction mixture to increase the temperature. In some embodiments, the thermal cycler comprises a cooling element that cools the reaction mixture.

In some embodiments, the plurality of individually addressable and controllable thermal zones includes indentations that are dimensioned to accept sample containers with biological samples and/or reagents. In some embodiments, a weight of the system per indentation is no more than 0.2 kg. In some embodiments, each of the plurality of indentations is dimensioned to hold the sample containers each having a height of no more than 21 mm.

In some embodiments, the thermal cycler comprises a heating element that heats the reaction mixture to increase the temperature. In some embodiments, the thermal cycler comprises a cooling element that cools the reaction mixture.

In some embodiments, the operating voltage is no more than 24 V. In some embodiments, the operating voltage is no more than 12 V.

In some embodiments, the system further comprises a power source that supplies power to the thermal cycler during the nucleic acid amplification reaction, wherein the power source operates at the operating voltage. In some embodiments, the power source is a vehicle that provides the operating voltage.

In some embodiments, the power source is a battery. In some embodiments, the thermal cycler cycles the temperature between at least two different temperatures. In some embodiments, the thermal cycler cycles the temperature between at least three different temperatures. In some embodiments, the thermal cycler cycles the temperature between a denaturing temperature, annealing temperature and elongation temperature.

Another aspect of the present disclosure provides a method for conducting nucleic acid amplification, comprising (a) providing a thermal cycler that includes a plurality of individually addressable and controllable thermal zones, wherein the thermal cycler has an operating voltage of no more than about 48 V during the nucleic acid amplification reaction; (b) receiving a first reaction mixture in a first thermal zone and a second reaction mixture in a second thermal zone of the plurality of individually addressable and controllable thermal zones, wherein each of the first and second reaction mixtures includes a biological sample having a target nucleic acid molecule and reagents necessary to conduct a nucleic acid amplification reaction to generate amplified target nucleic acid molecule(s) as amplification product(s) of the target nucleic acid molecule; and (c) instructing the thermal cycler to independently cycle a first temperature of the first reaction mixture and a second temperature of the second reaction mixture, thereby conducting the nucleic acid amplification reaction in each of the first and second reaction mixtures.

In some embodiments, the method further comprises instructing the thermal cycler to terminate cycling one of the first temperature and second temperature while continuing to cycle the other of the first temperature and second temperature. In some embodiments, the method further comprises (i) providing a detector having a plurality of sensors that optically detect optical signals from the plurality of individually addressable and controllable thermal zones, and (ii) using a first sensor and second sensor of the plurality of sensors to independently detect optical signals from the first reaction mixture and second reaction mixture, respectively.

Another aspect of the present disclosure provides a computer readable medium comprising machine executable code that, upon execution by one or more computer processors, implements any of the methods above or elsewhere herein.

Another aspect of the present disclosure provides a computer system comprising one or more computer processors and a computer readable medium coupled thereto. The computer readable medium comprises machine executable code that, upon execution by the one or more computer processors, implements any of the methods above or elsewhere herein.

Any device, system or method as described above or elsewhere herein may be capable of generating a report comprising information on the nucleic acid amplification. The report may be transmitted to the recipient at a local or remote location using any suitable communication medium, including those described elsewhere herein.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A shows an example of a device for conducting a nucleic acid amplification reaction in accordance with an embodiment of the present disclosure.

FIG. 1B shows another example of a device for conducting a nucleic acid amplification reaction in accordance with an embodiment of the present disclosure.

FIG. 2 shows samples that may be provided within sample containers supported by a device in accordance with an embodiment of the present disclosure.

FIG. 3 shows an example of a thermal cycle in accordance with an embodiment of the present disclosure.

FIG. 4 shows an example of a device and a display in accordance with an embodiment of the present disclosure.

FIG. 5 shows an example of power being provided to a device that includes an energy storage device in accordance with an embodiment of the present disclosure.

FIG. 6 shows an schematic of a battery pack in accordance with an embodiment of the present disclosure.

FIG. 7A shows a bottom view of a battery pack in accordance with an embodiment of the present disclosure.

FIG. 7B shows a side view of a battery pack in accordance with an embodiment of the present disclosure.

FIG. 7C shows another side view of a battery pack in accordance with an embodiment of the present disclosure.

FIG. 7D shows a top view of a battery pack in accordance with an embodiment of the present disclosure.

FIG. 7E shows a perspective view of a battery pack in accordance with an embodiment of the present disclosure.

FIG. 7F shows another perspective view of a battery pack in accordance with an embodiment of the present disclosure.

FIG. 8 shows an internal view of a battery pack in accordance with an embodiment of the present disclosure.

FIG. 9 shows an example of a device for conducting a nucleic acid amplification reaction in accordance with an embodiment of the present disclosure.

FIG. 10 shows an example of dimensions within which a device for conducting nucleic acid amplification may fall, in accordance with an embodiment of the present disclosure.

FIG. 11 shows an example of a device being powered by a vehicle in accordance with an embodiment of the present disclosure.

FIG. 12A shows an example of a connection between a device and a charging port in accordance with an embodiment of the present disclosure.

FIG. 12B shows an example of a connection between a device and a charging point via an adaptor in accordance with an embodiment of the present disclosure.

FIG. 13 shows an example of a method of deploying a device in accordance with an embodiment of the present disclosure.

FIG. 14 shows a computer system that is programmed or otherwise configured to control the operation of a thermal cycler.

FIG. 15 shows an example of a user interface for changing cycle number during runtime.

FIG. 16 shows another example of a user interface for changing cycle number during runtime.

FIG. 17 shows another example of a user interface for changing cycle number during runtime.

FIG. 18 shows another example of a user interface for changing cycle number during runtime.

FIG. 19 shows a plot of optical signal versus time for use in terminating or halting thermal cycling.

FIG. 20 shows another plot of optical signal change versus time for use in terminating or halting thermal cycling.

FIG. 21 shows another plot of optical signal versus time for use in independent thermal cycling.

FIG. 22 shows another plot of optical signal change versus time for use in independent thermal cycling.

### DETAILED DESCRIPTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The term “sample,” as used herein, generally refers to a tissue or a bodily fluid sample. For example, a sample can be but is not limited to a blood sample, or a portion thereof. A sample may contain or be suspected of containing a nucleic acid molecule. The sample can include cellular material. The sample can include nucleic acid material, such as deoxyribonucleic acid (DNA) or ribonucleic acid (RNA). For example, a subject sample can be a biological sample containing one or more nucleic acid molecules. The biological sample can be obtained or obtainable (e.g., extracted or isolated) from a bodily sample of a subject that can be selected from blood (e.g., whole blood), plasma, serum, urine, saliva, mucosal excretions, sputum, stool and tears. The bodily sample can be a fluid or tissue sample (e.g., skin sample) of the subject. In some examples, the sample is obtained from a cell-free bodily fluid of the subject, e.g., whole blood. In such instance, the sample can include cell-free DNA and/or cell-free RNA. In some other examples, the sample is an environmental sample (e.g., soil, waste, ambient air and etc.), industrial sample (e.g., samples from any industrial processes), and food samples (e.g., dairy products, vegetable products, and meat products).

A sample may be of any suitable size or volume. In some examples, a small volume comprises no more than about 5 mL; no more than about 4 mL; no more than about 3 mL; no more than about 2 mL; no more than about 1 mL; no more than about 500 μL; no more than about 250 μL; no more than about 100 μL; no more than about 75 μL; no more than about 50 μL; no more than about 35 μL; no more than about 25 μL; no more than about 20 μL; no more than about 15 μL; no more than about 10 μL; no more than about 8 μL; no more than about 6 μL; no more than about 5 μL; no more than about 4 μL; no more than about 3 μL; no more than about 2 μL; no more than about 1 μL; no more than about 0.8 μL; no more than about 0.5 μL; no more than about 0.3 μL; no more than about 0.2 μL; no more than about 0.1 μL; no more than about 0.05 μL; or no more than about 0.01 μL.

The term “bodily fluid”, as used herein, generally refers to any fluid obtainable from a subject. A bodily fluid may include but not limited to, e.g. blood, urine, saliva, tears, sweat, a bodily secretion, a bodily excretion, or any other fluid originating in or obtainable from a subject. In particular, bodily fluids include but not limited to blood, serum, plasma, bone marrow, saliva, urine, gastric fluid, spinal fluid, tears, stool, mucus, sweat, earwax, oil, glandular secretions, cerebral spinal fluid, semen, vaginal fluid, interstitial fluids derived from tumorous tissue, ocular fluids, placental fluid, amniotic fluid, cord blood, lymphatic fluids, cavity fluids, sputum, pus, meconium, breast milk and/or other secretions or excretions.

The term “nucleic acid,” as used herein, generally refers to a molecule comprising one or more nucleic acid subunits. A nucleic acid may include one or more subunits selected from adenosine (A), cytosine (C), guanine (G), thymine (T) and uracil (U), or variants thereof. A nucleotide can include A, C, G, T or U, or variants thereof including but not limited to peptide nucleic acid (PNA). A nucleotide can include any subunit that can be incorporated into a growing nucleic acid strand. Such subunit can be an A, C, G, T, or U, or any other subunit that is specific to one or more complementary A, C, G, T or U, or complementary to a purine (i.e., A or G, or variant thereof) or a pyrimidine (i.e., C, T or U, or variant thereof). A subunit can enable individual nucleic acid bases or groups of bases (e.g., AA, TA, AT, GC, CG, CT, TC, GT, TG, AC, CA, or uracil-counterparts thereof) to be resolved. In some examples, a nucleic acid is deoxyribonucleic acid (DNA) or ribonucleic acid (RNA), or derivatives thereof. A nucleic acid may be single-stranded or double stranded. A nucleic acid may comprise one or more modified nucleotides, e.g., methylated nucleotides and nucleotide analogs.

The term “polymerase,” as used herein, generally refers to any enzyme capable of catalyzing a polymerization reaction. Examples of polymerases include, without limitation, a nucleic acid polymerase, a transcriptase or a ligase. A polymerase can be a polymerization enzyme or a polymerizing enzyme.

The term “subject,” as used herein, generally refers to an animal or other organism, e.g., a mammalian species (e.g., human), avian (e.g., bird) species, or plant. Mammals include, but are not limited to, murines, simians, humans, farm animals, sport animals, and pets. A subject can be an individual that has or is suspected of having a disease or a pre-disposition to the disease, or an individual that is in need of therapy or suspected of needing therapy. A subject can be a patient.

The present disclosure provides systems and methods for low power thermal cycling. Various aspects described herein may be applied to any of the particular applications set forth below or for any other types of nucleic acid amplification systems. Systems and methods of the present disclosure may be applied as a standalone system or method, or as part of an integrated sample processing system. It shall be understood that different aspects of the present disclosure can be appreciated individually, collectively, or in combination with each other.

A device for conducting nucleic acid amplification may be provided. The device may include a thermal cycler capable of causing one or more samples to undergo multiple thermal cycles. The multiple thermal cycles may cause a nucleic acid of interest to be amplified in the samples, using any thermal cycling based approach (e.g., polymerase chain reaction (PCR)). The device may also include a detector configured to detect an optical signal from the sample. The detector may detect the signal while the reaction is in progress without removing the sample from the device. The signal may be related to the amount of amplified nucleic acid of interest in the sample. The device may be capable of conducting real-time PCR using the thermal cycler and the detector.

The nucleic acid amplification device may be configured to operate at a low voltage power. For example, the device may be configured to operate with no more than a total of about 12 V of electricity, or any other low voltage value described elsewhere herein. Both the thermal cycler and the detector may be powered using a total of no more than 12 V. The device may have a power connector to connect the device to a power source. In some instances, the power source may be a low power source that provides no more than 12 V of power. Optionally, the power source may be a charging port in a vehicle. The power source may be a vehicle battery that may provide low voltage power to the device.

Optionally, the device may have an energy storage unit, such as a battery pack. The battery pack may be on-board the device or may be connected to the device. The battery pack may be charged using a low voltage power source, such as a 12 V power source. The battery pack may be used to power the device, such as the thermal cycler and the detector of the device, using no more than 12 V, or any other low voltage value.

A portable configuration may be provided for the device. In some instances, the thermal cycler may have a small configuration. For example, the device may be no more than about 12 cm tall. The device may have a length of no more than 16 cm. In some instances, the device may weigh no more than about 2 kg.

The device may be deployed to a user location. This may permit the device to be used in various point-of-care (POC) situations. A vehicle may be used to provide power to a device. Providing power to a device may include directly powering one or more components of the device or charging the device. The device may be charged or powered using a vehicle while the vehicle is in operation. The vehicle is considered in operation so long as its ignition is not completely turned off. In some embodiment, the device may be charged or powered while a vehicle is in transit with the device on-board. The device may be used at the POC location to receive a sample. The device may conduct nucleic acid amplification at the POC location, or while in transit. This may advantageously permit a device to be used at locations that may otherwise not be equipped to permit operation of the device. Thus, nucleic acid amplification results can be achieved much more rapidly by reducing the time it may take a sample to be provided to a device, and to receive the results back from the device.

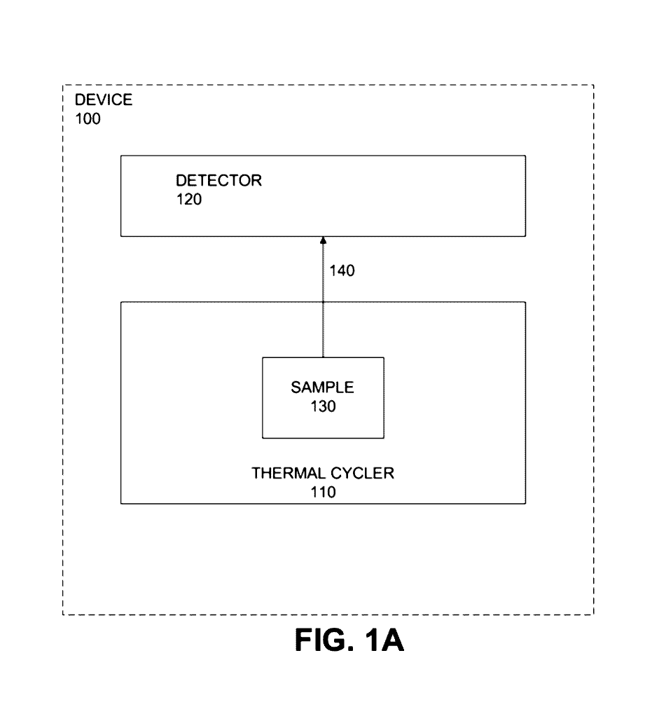

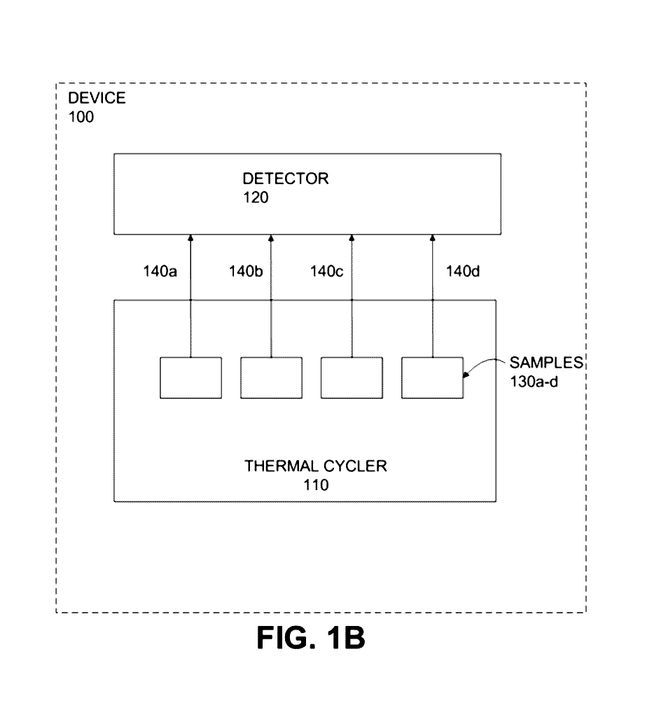

FIG. 1A shows an example of a device for conducting a nucleic acid amplification reaction in accordance with an embodiment of the present disclosure. A device 100 for conducting nucleic acid amplification may include a thermal cycler 110 and a detector 120. The thermal cycler may be configured to accept a sample 130.

The thermal cycler 110 may be capable of receiving the sample 130 which may comprise a target nucleic acid. The sample may also include an agent that detects amplified target nucleic acid (e.g., a detectable nucleic acid binding agent). The sample may also include other reagents for conducting a nucleic acid amplification. Depending on the nature of the target nucleic acid that is to be amplified, other reagents may include reverse transcriptase for conducting reverse-transcriptase coupled PCT, dNTPs, Mg²⁺ ion.

The sample 130 may be a biological sample. The biological sample may be taken from a subject. For example, the sample may be taken from a living subject directly. In some embodiments, the biological sample may include breath, blood, urine, feces, saliva, cerebrospinal fluid and sweat. Any suitable biological sample that comprises nucleic acid may be obtained from a subject. A biological sample may be solid matter (e.g., biological tissue) or may be a fluid (e.g., a biological fluid). In general, a biological fluid can include any fluid associated with living organisms. Non-limiting examples of a biological sample include blood (or components of blood—e.g., white blood cells, red blood cells, platelets) obtained from any anatomical location (e.g., tissue, circulatory system, bone marrow) of a subject, cells obtained from any anatomical location of a subject, skin, heart, lung, kidney, breath, bone marrow, stool, semen, vaginal fluid, interstitial fluids derived from tumorous tissue, breast, pancreas, cerebral spinal fluid, tissue, throat swab, biopsy, placental fluid, amniotic fluid, liver, muscle, smooth muscle, bladder, gall bladder, colon, intestine, brain, cavity fluids, sputum, pus, micropiota, meconium, breast milk, prostate, esophagus, thyroid, serum, saliva, urine, gastric and digestive fluid, tears, ocular fluids, sweat, mucus, earwax, oil, glandular secretions, spinal fluid, hair, fingernails, skin cells, plasma, nasal swab or nasopharyngeal wash, spinal fluid, cord blood, emphatic fluids, and/or other excretions or body tissues.

A subject may be a living subject or a dead subject. The subject may be a human or an animal. In some examples, the subject may be mammal. Examples of subjects may include, but are not limited to simians, avines, canines, felines, equines, bovines, ovines, porcines, delphines, rodents (e.g., mice, rats), or insects.

There are various approaches for obtaining a biological sample from a subject. Non-limiting examples of obtaining a biological sample directly from a subject include accessing the circulatory system (e.g., intravenously or intra-arterially via a syringe or other needle), collecting a secreted biological sample (e.g., feces, urine, sputum, saliva, etc.), surgically (e.g., biopsy), swabbing (e.g., buccal swab, oropharyngeal swab), pipetting, and breathing. Moreover, a biological sample may be obtained from any anatomical part of a subject where a desired biological sample is located.

A biological sample obtained directly from a subject may generally refer to a biological sample that has not been further processed after being obtained from the subject, with the exception of collecting the biological sample from the subject for further processing. For example, blood is obtained directly from a subject by accessing the subject's circulatory system, removing the blood from the subject (e.g., via a needle), and entering the removed blood into a receptacle. The receptacle may comprise reagents (e.g., anti-coagulants) such that the blood sample is useful for further analysis. In another example, a swab may be used to access epithelial cells on an oropharyngeal surface of the subject. After obtaining the biological sample from the subject, the swab containing the biological sample can be contacted with a fluid (e.g., a buffer) to collect the biological fluid from the swab. Alternatively, pre-processing may occur on the biological sample prior to being provided to the device.

In some embodiments, a biological sample has not been purified when provided in a reaction vessel. In some embodiments, the nucleic acid of a biological sample has not been extracted when the biological sample is provided to a reaction vessel. For example, the RNA or DNA in a biological sample may not be extracted from the biological sample when providing the biological sample to a reaction vessel. Moreover, in some embodiments, a target nucleic acid (e.g., a target RNA or target DNA) present in a biological sample may not be concentrated prior to providing the biological sample to a reaction vessel. Alternatively, dilution or concentration of the sample may occur prior to being provided to a device.

The sample 130 may have a target nucleic acid to be amplified. The target nucleic acid may be amplified to generate an amplified product. A target nucleic acid may be a target RNA or a target DNA. In cases where the target nucleic acid is a target RNA, the target RNA may be any type of RNA. In some embodiments, the target RNA is viral RNA. In some embodiments, the viral RNA may be pathogenic to the subject. Non-limiting examples of pathogenic viral RNA include human immunodeficiency virus I (HIV I), human immunodeficiency virus II (HIV II), orthomyxoviruses, influenza viruses (e.g., H1N1, H3N2, H5N1), hepevirus, hepatitis A, hepatitis B, hepatitis C, hepatitis D, hepatitis E, hepatitis G, Epstein-Barr virus, mononucleosis, cytomegalovirus, SARS, West Nile Fever, polio, and measles.

In cases where the target nucleic acid is a target DNA, the target DNA may be any type of DNA. In some embodiments, the target DNA is viral DNA. In some embodiments, the viral DNA may be pathogenic to the subject. Non-limiting examples of DNA viruses include herpes simplex virus, smallpox, and chickenpox. In some cases, a target DNA may be a bacterial DNA. The bacterial DNA may be from a bacterium pathogenic to the subject such as, for example, Mycobacterium tuberculosis—a bacterium known to cause tuberculosis.

The sample 130 may also include an agent that detects amplified target nucleic acid. The agent may be a reporter agent that can yield a detectable signal whose presence or absence is indicative of the presence of an amplified product. The intensity of the detectable signal may be proportional to the amount of amplified product. For example, the detectable signal may be directly linearly proportional, exponentially proportional, reversely proportional, or have any other type of proportional relationship to the amount of amplified product. In some cases, where amplified product is generated of a different type of nucleic acid than the target nucleic acid initially amplified, the intensity of the detectable signal may be proportional to the amount of target nucleic acid initially amplified. For example, in the case of amplifying a target RNA via parallel reverse transcription and amplification of the DNA obtained from reverse transcription, reagents necessary for both reactions may also comprise a reporter agent may yield a detectable signal that is indicative of the presence of the amplified DNA product and/or the target RNA amplified. The intensity of the detectable signal may be proportional to the amount of the amplified DNA product and/or the original target RNA amplified. The use of a reporter agent also enables real-time amplification methods, including real-time PCR for DNA amplification.

Reporter agents may be linked with nucleic acids, including amplified products, by covalent or non-covalent bonds. Non-limiting examples of non-covalent bonds include ionic interactions, Van der Waals forces, hydrophobic interactions, hydrogen bonding, and combinations thereof. In some embodiments, reporter agents may bind to initial reactants and changes in reporter agent levels may be used to detect amplified product. In some embodiments, reporter agents may only be detectable (or non-detectable) as nucleic acid amplification progresses. In some embodiments, an optically-active dye (e.g., a fluorescent dye) may be used as may be used as a reporter agent. An agent for detecting amplified target nucleic acid may be a nucleic acid binding dye. The dye may be a DNA-intercalating dye. Non-limiting examples of dyes include Eva green, SYBR green, SYBR blue, DAPI, propidium iodine, Hoeste, SYBR gold, ethidium bromide, acridines, proflavine, acridine orange, acriflavine, fluorcoumanin, ellipticine, daunomycin, chloroquine, distamycin D, chromomycin, homidium, mithramycin, ruthenium polypyridyls, anthramycin, phenanthridines and acridines, ethidium bromide, propidium iodide, hexidium iodide, dihydroethidium, ethidium homodimer-1 and -2, ethidium monoazide, and ACMA, Hoechst 33258, Hoechst 33342, Hoechst 34580, DAPI, acridine orange, 7-AAD, actinomycin D, LDS751, hydroxystilbamidine, SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21, -23, -12, -11, -20, -22, -15, -14, -25 (green), SYTO-81, -80, -82, -83, -84, -85 (orange), SYTO-64, -17, -59, -61, -62, -60, -63 (red), fluorescein, fluorescein isothiocyanate (FITC), tetramethyl rhodamine isothiocyanate (TRITC), rhodamine, tetramethyl rhodamine, R-phycoerythrin, Cy-2, Cy-3, Cy-3.5, Cy-5, Cy5.5, Cy-7, Texas Red, Phar-Red, allophycocyanin (APC), Sybr Green I, Sybr Green II, Sybr Gold, CellTracker Green, 7-AAD, ethidium homodimer I, ethidium homodimer II, ethidium homodimer III, ethidium bromide, umbelliferone, eosin, green fluorescent protein, erythrosin, coumarin, methyl coumarin, pyrene, malachite green, stilbene, lucifer yellow, cascade blue, dichlorotriazinylamine fluorescein, dansyl chloride, fluorescent lanthanide complexes such as those including europium and terbium, carboxy tetrachloro fluorescein, 5 and/or 6-carboxy fluorescein (FAM), 5- (or 6-) iodoacetamidofluorescein, 5-{[2(and 3)-5-(Acetylmercapto)-succinyl]amino} fluorescein (SAMSA-fluorescein), lissamine rhodamine B sulfonyl chloride, 5 and/or 6 carboxy rhodamine (ROX), 7-amino-methyl-coumarin, 7-Amino-4-methylcoumarin-3-acetic acid (AMCA), BODIPY fluorophores, 8-methoxypyrene-1,3,6-trisulfonic acid trisodium salt, 3,6-Disulfonate-4-amino-naphthalimide, phycobiliproteins, AlexaFluor 350, 405, 430, 488, 532, 546, 555, 568, 594, 610, 633, 635, 647, 660, 680, 700, 750, and 790 dyes, DyLight 350, 405, 488, 550, 594, 633, 650, 680, 755, and 800 dyes, or other fluorophores.

In some instances, a reporter agent may be a sequence-specific oligonucleotide probe that can be optically active when hybridized with an amplified product. Due to sequence-specific binding of the probe to the amplified product, use of oligonucleotide probes can increase specificity and sensitivity of detection. A probe may be linked to any of the optically-active reporter agents (e.g., dyes) described herein and may also include a quencher capable of blocking the optical activity of an associated dye. Non-limiting examples of probes that may be useful used as reporter agents include TaqMan probes, TaqMan Tamara probes, TaqMan MGB probes, or Lion probes.

A reporter agent may be an RNA oliognucleotide probe that may include an optically-active dye (e.g., fluorescent dye) and a quencher positioned adjacently on the probe. The close proximity of the dye with the quencher can block the optical activity of the dye. The probe may bind to a target sequence to be amplified. Upon the breakdown of the probe with the exonuclease activity of a DNA polymerase during amplification, the quencher and dye are separated, and the free dye regains its optical activity that can subsequently be detected.

Optionally, a reporter agent may be a molecular beacon. A molecular beacon may include, for example, a quencher linked at one end of an oligonucleotide in a hairpin conformation. At the other end of the oligonucleotide is an optically active dye, such as, for example, a fluorescent dye. In the hairpin configuration, the optically-active dye and quencher are brought in close enough proximity such that the quencher is capable of blocking the optical activity of the dye. Upon hybridizing with amplified product, however, the oligonucleotide assumes a linear conformation and hybridizes with a target sequence on the amplified product. Linearization of the oligonucleotide results in separation of the optically-active dye and quencher, such that the optical activity is restored and can be detected. The sequence specificity of the molecular beacon for a target sequence on the amplified product can improve specificity and sensitivity of detection.

In some embodiments, a reporter agent may be a radioactive species. Non-limiting examples of radioactive species include ¹⁴C, ¹²³I, ¹²⁴I, ¹²⁵I, Tc99m, ³⁵S, or ³H.

In some embodiments, a reporter agent may be an enzyme that is capable of generating a detectable signal. Detectable signal may be produced by activity of the enzyme with its substrate or a particular substrate in the case the enzyme has multiple substrates. Non-limiting examples of enzymes that may be used as reporter agents include alkaline phosphatase, horseradish peroxidase, I²-galactosidase, alkaline phosphatase, β-galactosidase, acetylcholinesterase, and luciferase.

The sample 130 may be provided with reagents necessary for nucleic acid amplification within the device. In some instances, a reagent may comprise one or more of the following: (i) a reverse transcriptase, (ii) a DNA polymerase, and (iii) a primer set for the target nucleic acid (e.g., RNA). Some examples of reagents may include a commercially available pre-mixture (e.g., Qiagen One-Step RT-PCR or One-Step RT-qPCR kit) comprising reverse transcriptases (e.g., Sensiscript and Omniscript transcriptases), a DNA Polymerase (e.g., HotStarTaq DNA Polymerase), and dNTPs.

In some instances, the sample 130 may be provided within a sample container, such as a reaction vessel. Any components of the sample including the target nucleic acid, agent that detects amplified target nucleic acid, and/or reagents for nucleic acid amplification may be provided within the reaction vessel to obtain a reaction mixture. Any suitable reaction vessel may be used. In some embodiments, a reaction vessel comprises a body that can include an interior surface, an exterior surface, an open end, and an opposing closed end. In some embodiments, a reaction vessel may comprise a cap. The cap may be configured to contact the body at its open end, such that when contact is made the open end of the reaction vessel is closed. In some cases, the cap is permanently associated with the reaction vessel such that it remains attached to the reaction vessel in open and closed configurations. In some cases, the cap is removable, such that when the reaction vessel is open, the cap is separated from the reaction vessel. In some embodiments, a reaction vessel may be sealed, optionally hermetically sealed. The reaction vessel may be fluid-tight.

A reaction vessel may be of varied size, shape, weight, and configuration. In some examples, a reaction vessel may be round or oval tubular shaped. In some embodiments, a reaction vessel may be rectangular, square, diamond, circular, elliptical, or triangular shaped. A reaction vessel may be regularly shaped or irregularly shaped. In some embodiments, the closed end of a reaction vessel may have a tapered, rounded, or flat surface. For example, a flat cap, rounded, cap, or tapered cap may be provided. Non-limiting examples of types of a reaction vessel include a tube, a well, a capillary tube, a cartridge, a cuvette, a centrifuge tube, or a pipette tip.

Any dimensions may be provided for a reaction vessel. The reaction vessel may be configured to contain no more than 0.2 mL or 0.5 mL of sample. The reaction vessel may be configured to contain no more than about 0.01 mL, 0.03 mL, 0.05 mL, 0.07 mL, 0.1 mL, 0.12 mL, 0.15 mL, 0.17 mL, 0.2 mL, 0.22 mL, 0.25 mL, 0.27 mL, 0.3 mL, 0.32 mL, 0.35 mL, 0.37 mL, 0.4 mL, 0.42 mL, 0.45 mL, 0.47 mL, 0.5 mL, 0.52 mL, 0.55 mL, 0.6 mL, 0.7 mL, 0.8 mL, 0.9 mL, 1 mL, 1.1 mL, 1.2 mL, 1.3 mL, 1.5 mL, 1.7 mL, 2 mL, 2.5 mL, 3 mL, 3.5 mL, 4 mL, 5 mL, 6 mL, or 7 mL. The reaction vessel may be configured to contain more than any of the values described herein. The reaction vessel may have a volume configured to contain no more than a volume falling into a range between two of the values described herein.

The reaction vessel may be less than or equal to about 15 mm, 21.5 mm, 21.8 mm, or 22 mm tall. The reaction vessel may have a height of less than or equal to about 1 mm, 2 mm, 3 mm, 4 mm, 5 mm, 6 mm, 7 mm, 8 mm, 9 mm, 10 mm, 12 mm, 13 mm, 14 mm, 15 mm, 16 mm, 17 mm, 18 mm, 19 mm, 20 mm, 21 mm, 22 mm, 23 mm, 24 mm, 25 mm, 27 mm, 30 mm, 35 mm, 40 mm, 45 mm, 50 mm, 55 mm, 60 mm, or 70 mm. The reaction vessel may have a height greater than any of the values described herein. The reaction vessel may have a height falling into a range between any two of the values described herein.

The reaction vessel may have a cross-sectional area of no more than 0.001 mm², 0.005 mm², 0.01 mm², 0.03 mm², 0.05 mm², 0.1 mm², 0.12 mm², 0.15 mm², 0.2 mm², 0.3 mm², 0.4 mm², 0.5 mm², 0.6 mm², 0.7 mm², 0.8 mm², 0.9 mm², 1 mm², 1.1 mm², 1.2 mm², 1.3 mm², 1.5 mm², 1.7 mm², 2 mm², 2.2 mm², 2.5 mm², 3 mm², 3.5 mm², 4 mm², 4.5 mm², 5 mm², 6 mm², 7 mm², 8 mm², 9 mm², 10 mm², 12 mm², 15 mm², 17 mm², 20 mm², 22 mm², 25 mm², 30 mm², 35 mm², 40 mm², or 50 mm². The reaction vessel may have a cross-sectional area less than any of the values described herein. The reaction vessel may have a cross-sectional area falling into a range between any two of the values described herein.

Reaction vessels may be constructed of any suitable material with non-limiting examples of such materials that include glasses, metals, plastics, and combinations thereof. Reaction vessels can be made from optically transparent or translucent materials that may permit an optical signal from within the reaction vessel to leave the reaction vessel. The reaction vessels may be made from a material that may or may not filter an optical signal exiting the reaction vessel. In some instances, the reaction vessels may be formed from a clear material that may permit a detector to view the interior of the reaction vessels. In some instances, the interior of the reaction vessels may be imaged. Alternatively, an amount of optical signal exiting the reaction vessel may be detected and measured.

A thermal cycler may be capable of receiving a reaction vessel. The reaction vessels may be removably provided to the thermal cycler. The reaction vessels may be inserted within a device or taken out of the device. The reaction vessels may be placed onto a supporting component of the thermal cycler or taken off the supporting component.

In alternative embodiments, the sample may be loaded directly into the device without requiring a separate reaction vessel. In some instances, reaction vessels or receptacles may be directly built-into the device.

The thermal cycler 110 may accept the reaction vessel having the sample therein, or may directly receive the sample. The thermal cycler may be capable of alternatingly heating and cooling the sample. Multiple cycles of heating and cooling may be provided. Any temperature profile may be provided for the various heating and cooling cycles.

The thermal cycler may utilize conduction, convection, and/or radiation to heat and/or cool the samples. In one example, a heating block may be provided that may directly contact the sample, or may contact a sample container that contains the sample. In some instances, electricity may be used to resistively heat a heating/cooling system of the thermal cycler. Other techniques, such as induction heating may be used to control the heating/cooling system of the thermal cycler. In some instances Peltier devices may be used to heat or cool the samples in the thermal cycler.

Any type of nucleic acid amplification reaction known in the art may be used to amplify a target nucleic acid and generate an amplified product. Moreover, amplification of a nucleic acid may linear, exponential, or a combination thereof. Amplification may be emulsion based or may be non-emulsion based. Non-limiting examples of nucleic acid amplification methods include reverse transcription, primer extension, polymerase chain reaction, ligase chain reaction, helicase-dependent amplification, asymmetric amplification, rolling circle amplification, and multiple displacement amplification (MDA). In some embodiments, the amplified product may be DNA. In cases where a target RNA is amplified, DNA can be obtained by reverse transcription of the RNA and subsequent amplification of the DNA can be used to generate an amplified DNA product. The amplified DNA product may be indicative of the presence of the target RNA in the biological sample. In cases where DNA is amplified, any DNA amplification method known in the art may be employed. Non-limiting examples of DNA amplification methods include polymerase chain reaction (PCR), variants of PCR (e.g., real-time PCR, allele-specific PCR, assembly PCR, asymmetric PCR, digital PCR, emulsion PCR, dial-out PCR, helicase-dependent PCR, nested PCR, hot start PCR, inverse PCR, methylation-specific PCR, miniprimer PCR, multiplex PCR, nested PCR, overlap-extension PCR, thermal asymmetric interlaced PCR, touchdown PCR), and ligase chain reaction (LCR). In some cases, DNA amplification is linear. In some cases, DNA amplification is exponential. In some cases, DNA amplification is achieved with nested PCR, which can improve sensitivity of detecting amplified DNA products.

Nucleic acid amplification reactions described herein may be conducted in parallel, in some implementations. Parallel amplification reactions may be amplification reactions that can occur in the same reaction vessel and at the same time. Parallel nucleic acid amplification reactions may be conducted, for example, by including reagents necessary for each nucleic acid amplification reaction in a reaction vessel to obtain a reaction mixture and subjecting the reaction mixture to conditions necessary for each nucleic amplification reaction. For example, reverse transcription amplification and DNA amplification may be conducted in parallel, by providing reagents necessary for both amplification methods in a reaction vessel to form to obtain a reaction mixture and subjecting the reaction mixture to conditions suitable for conducting both amplification reactions. DNA generated from reverse transcription of the RNA may be amplified in parallel to generate an amplified DNA product. Any suitable number of nucleic acid amplification reactions may be conducted in parallel. In some cases, at least 1, 2, 3, 4, 5, 6, 7, 8, 9, 10, 11, 12, 13, 14, 15, 16, 17, 18, 19, 20, or more nucleic acid amplification reactions are conducted in parallel.

Time may elapse while nucleic acid amplification reactions are occurring. A detector 120 of the device 100 may be capable of detecting a signal during the time while the nucleic acid amplification reaction is occurring. The detector may be capable of detecting the signal without removing the sample 130 from the device.

In various aspects, the detector 120 may detect amplified product (e.g., amplified DNA product, amplified RNA product). Detection of amplified product, including amplified DNA, may be accomplished with any suitable detection method known in the art. The particular type of detection method used may depend, for example, on the particular amplified product, the type of reaction vessel used for amplification, other reagents in a reaction mixture, whether or not a reporter agent was included in a reaction mixture, and if a reporter agent was used, the particular type of reporter agent use. Non-limiting examples of detection methods include optical detection, spectroscopic detection, electrostatic detection, electrochemical detection, and the like. Optical detection methods include, but are not limited to, fluorimetry and UV-vis light absorbance. Spectroscopic detection methods include, but are not limited to, mass spectrometry, nuclear magnetic resonance (NMR) spectroscopy, and infrared spectroscopy. Electrostatic detection methods include, but are not limited to, gel based techniques, such as, for example, gel electrophoresis. Electrochemical detection methods include, but are not limited to, electrochemical detection of amplified product after high-performance liquid chromatography separation of the amplified products.

The detector 120 may be capable of detecting an optical signal from the sample 130. The optical signal may be a fluorescent or other luminescent signal from the sample. The optical signal may be generated by the sample in response to a stimulation light provided to the sample. A stimulation light may be provided by a light source. The light source may be within the device 100. In some instances, light may be absorbed by the sample, and the sample may emit light. The emitted light may be at the same or different wavelength from the emitted light. In some instances, the optical signal may be a reflection of light from the light source. Alternatively, light may be shined through the sample, and the detector may be capable of detecting the light that passes through the sample.

In some embodiments, information regarding the presence of and/or an amount of amplified product(s) (e.g., amplified DNA product) may be outputted to a recipient. There are various ways to output information regarding amplified product(s). Such information may be provided in real-time while the nucleic-acid amplification is underway. In other instances, the information may be provided once the nucleic acid amplification has been completed. In some instances, some data may be provided in real-time while other data may be presented once the amplification is completed.

In some embodiments, such information may be provided verbally to a recipient. In some embodiments, such information may be provided in a report. A report may include any number of elements, with non-limiting examples that include information regarding the subject (e.g., sex, age, race, health status, etc.), raw data, processed data (e.g. graphical displays (e.g., figures, charts, data tables, data summaries), determined cycle threshold values, calculation of starting amount of target polynucleotide), conclusions about the presence of the target nucleic acid, diagnosis information, prognosis information, disease information, and the like, and combinations thereof. The report may be provided as a printed report (e.g., a hard copy) or may be provided as an electronic report. In some embodiments, including cases where an electronic report is provided, such information may be outputted via an electronic display, such as a monitor or television, a screen operatively linked with a unit used to obtain the amplified product, a tablet computer screen, a mobile device screen, and the like. Both printed and electronic reports may be stored in files or in databases, respectively, such that they are accessible for comparison with future reports.

Moreover, a report may be transmitted to the recipient at a local or remote location using any suitable communication medium including, for example, a network connection, a wireless connection, or an internet connection. In some embodiments, a report can be sent to a recipient's device, such as a personal computer, phone, tablet, or other device. The report may be viewed online, saved on the recipient's device, or printed. There are other suitable approaches for transmitting a report, with non-limiting examples that include mailing a hard-copy report for reception and/or for review by a recipient.

Moreover, such information may be outputted to various types of recipients. Non-limiting examples of such recipients include the subject from which the biological sample was obtained, a physician, a physician treating the subject, a clinical monitor for a clinical trial, a nurse, a researcher, a laboratory technician, a representative of a pharmaceutical company, a health care company, a health care professional, a biotechnology company, a hospital, a human aid organization, a health care manager, an electronic system (e.g., one or more computers and/or one or more computer servers storing, for example, a subject's medical records), a public health worker, other medical personnel, and other medical facilities.

The device 100 that may include the thermal cycler 110 and detector 120 may include a housing. The housing may partially or completely enclose components of the device. The housing may surround components of the device laterally and/or on the top and bottom. The housing may optionally be a rigid structure. For example, the housing may contain the thermal cycler therein. Optionally, the detector may also be contained within the housing. In other implementations, the detector may be outside the housing of the device. The detector may be an integral part of the device. Alternatively, the detector may be removable or separable from the device.

An optical path 140 may be provided between the sample 130 and the detector 120. A signal from the sample may reach the detector via the optical path. An optical signal from a sample may traverse the optical path to reach the detector. The optical path may include direct line-of-sight between the sample and the detector. In some instances, one or more optical elements may be provided between the sample and the detector. Examples of optical elements may include lenses, mirrors, prisms, diffusers, concentrators, filters, dichroics, optical fibers, or any other type of optical elements.

Optionally, the optical path 140 may be provided entirely within a housing of the device 100. The housing may optically isolate the optical path from the surrounding environment. For example, the housing may be light-tight so that little or no interfering optical signals may be provided within the housing that may interfere with the optical path. Light from outside the housing may not be capable of entering the interior of the housing. This may advantageously reduce inaccuracies in the optical signal detected by the detector 120.

The optical path 140 may remain while the nucleic acid amplification is occurring. The detector may be able to continuously or periodically detect signals from the ample while the nucleic acid amplification is occurring via the optical path.

In some instances, a low voltage may be used to power the device 100. For example, 12 V or less may be used to power the device. The low voltage may be used to power the detector and the thermal cycler.

FIG. 1B shows another example of a device for conducting a nucleic acid amplification reaction in accordance with an embodiment of the present disclosure. The device 100 may include a thermal cycler 110 and a detector 120. The thermal cycler may be capable of receiving a plurality of samples 130a-d. Optical paths 140a-d may be provided between the samples and the detector.

In some embodiments, a plurality of samples 130a-d may be provided to the thermal cycler. The thermal cycler may be capable of receiving a plurality of samples. The thermal cycler may be capable of receiving the number of samples loaded therein, or may be capable of receiving more than the samples loaded therein. The thermal cycler may have sites capable of receiving samples, and the sites may or may not all be filled. For example, the thermal cycler may be capable of receiving 8 samples, but may have 8 or fewer, 7 or fewer, 6 or fewer, 5 or fewer, 4 or fewer, 3 or fewer, 2 or fewer, 1 sample, or no samples loaded thereon. The samples may be provided within reaction vessels that may be accepted by the thermal cycler. Alternatively, the sample may be directly provided to the thermal cycler without the reaction vessels, or may be loaded on reaction vessels built into the thermal cycler.

The thermal cycler 110 may have one or more wells. The wells may be configured to accept a reaction vessel or sample directly. The wells may be indentations on a support structure. In some instances, the support structure may be a heating/cooling block. For example, the wells may be formed directly into the heating unit itself. The reaction vessels may be inserted into the wells and may directly contact the heating unit. The reaction vessels and samples therein may experience conductive heating and cooling.

A reaction vessel can be part of an array of reaction vessels. An array of reaction vessels may be particularly useful for automating methods and/or simultaneously processing multiple samples 130a-d. For example, a reaction vessel may be a well of a microwell plate comprised of a number of wells. In another example, a reaction vessel may be held in a well of a thermal block of a thermocycler, wherein the block of the thermal cycle comprises multiple wells each capable of receiving a sample vessel. An array comprised of reaction vessels may comprise any appropriate number of reaction vessels. For example, an array may comprise at least about 2, 4, 6, 8, 10, 12, 14, 16, 18, 20, 25, 35, 48, 96, 144, 384, or more reaction vessels. A reaction vessel part of an array of reaction vessels may also be individually addressable by a fluid handling device, such that the fluid handling device can correctly identify a reaction vessel and dispense appropriate fluid materials into the reaction vessel. Fluid handling devices may be useful in automating the addition of fluid materials to reaction vessels.

The reaction vessels may be individually movable relative to one another. The reaction vessels may be individually removable from the thermal cycler 110. Alternatively, reaction vessels may be connected to one another. In some instances, groups or strips of reaction vessels may be provided that may be collectively moved relative to other groups or strips of reaction vessels.

As discussed, multiple samples 130a-d may be provided to the thermal cycler. The thermal cycler may simultaneously heat and cool the samples within the thermal cycler. Each of the samples may be controlled along the same temperature profile. Alternatively, different profiles may be provided for different samples. In some instances, the temperature profiles of the samples may be individually controllable, or controllable on a group by group or zone by zone basis. The thermal cycler may include a heating/cooling block that may have the same temperature throughout. Alternatively, a temperature gradient may be provided on the heating/cooling block. Different samples may be placed at different positions along the temperature gradient to yield different thermal cycling temperature profiles.

Each sample 130a-d may provide a signal that may be detectable by one or more detectors 120. Any description herein of a detector may apply to a single detector or multiple detectors. For example, if eight samples are provided, a single detector may detect signals from all eight samples, each sample may have its own detector (yielding a total of eight detectors), or multiple samples may be detected by a single detector, wherein multiple detectors may be provided overall. The detector may be capable of receiving optical signals from the samples during nucleic acid amplification of the samples. The detector may receive the optical signals simultaneously. The detector may receive optical signals from the samples continuously or on a periodic basis. In some instances, the detector may sequentially receive signals from the samples on a sequential or step-through basis.

A plurality of optical pathways 140a-d may be provided. In some instances, individualized optical pathways may be provided between the samples 130a-d and the detector 120. The optical pathways may preferably not interfere with one another. In some instances, the optical pathways may be optically isolated from one another. As previously described, optical pathways may include a line-of-sight between the samples and the detector. In one example, a single imaging device, such as a camera, may image the samples simultaneously. In other examples, optical pathways may include optical elements. For example, separate fiber optic pathways may be provided between each sample and the detector. The multiplexing of the samples and optical detectors may permit the device to load and amplify nucleic acid from multiple samples simultaneously.

Alternatively, a single optical pathway may be provided between a plurality of samples 130a-d and the detector 120.

In some instances, a low voltage may be used to power the device 100. For example, 12 V or less may be used to power the device. The low voltage may be used to power the detector and the thermal cycler.

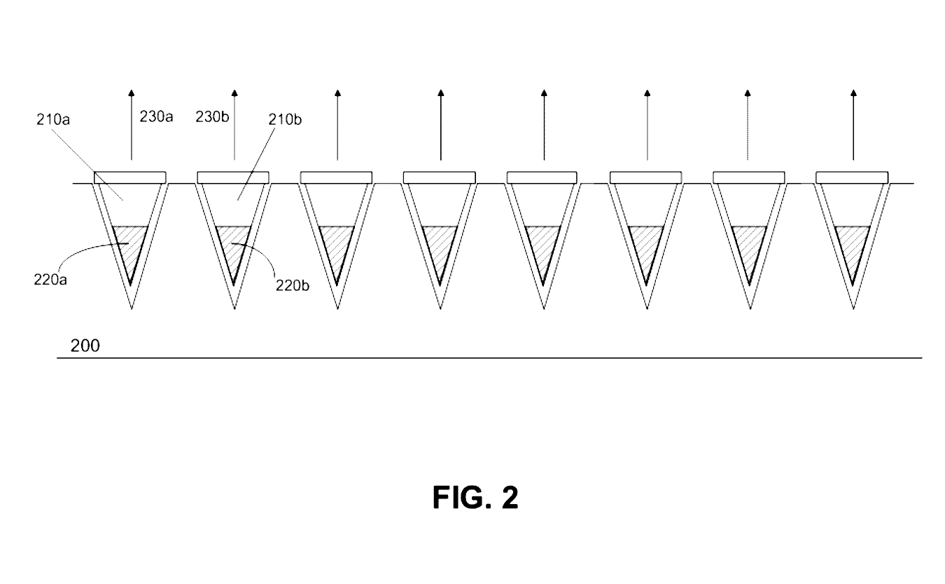

FIG. 2 shows samples that may be provided within sample containers supported by a device in accordance with an embodiment of the present disclosure. The sample containers may be reaction vessels 210a, 210b. The reaction vessels may be supported by a supporting device 200. The supporting device may have one or more indentations into which the reaction vessels may be inserted. The indentations may be wells. The reaction vessels may contain samples 220a, 220b therein. Optical signals 230a, 230b may be emitted from the sample and may leave the reaction vessels.

The supporting device may have one or more indentations built therein. The support device may be a heating and cooling device. Any description of heating herein may also apply to both heating and cooling. In some instances, the support device may be heated using resistive conductive heating. In some instances, the support device may be Peltier device that may be capable of heating and cooling the sample therein. The support device may be a solid block or may include cavities, passageways, indentations, or other features. The support device may be formed from a metallic material. In some instances, the support device may be formed from a material of high thermal conductivity. The support device itself may be a heater, or may be in thermal communication with a heater. For example, the support device may be a thermally conductive block positioned on top of a heating block.

The support device may have any number of indentations therein. For example, the support device may include greater than or equal to about 1, 2, 3, 4, 5, 6, 7, 8, 10, 12, 14, 16, 18, 20, 24, 30, 35, 40, 48, 50, 60, 70, 80, 90, 96, 100, 120, 144, 150, 200, 250, 300, 384, 400, 500, 700, 1000, 1536, 2000 indentations. The support device may include fewer than or equal to about any of the number indentations described herein. In some instances, the number of indentations may fall in a range between any two of the values of described herein. The indentations may be sized and/or shaped to accept one or more reaction vessels 210a, 210b. The outer surface of the reaction vessels may contact interior surfaces of the indentation. The contact may be substantially flush so that the majority of the outer surface area of the reaction vessel contacts the indentation. This may improve thermal contact between the sample contained therein and a heating and cooling element.

The reaction vessels 210a, 210b may have any characteristic or dimension as described elsewhere herein. In some instances, all reaction vessels loaded into the thermal cycler may have the same characteristics. Otherwise, different types of reaction vessels may be loaded thereon. The support may be capable of accepting a single type of reaction vessel or multiple types of reaction vessels. The indentations on the support may all be filled with reaction vessels. Alternatively, one or more empty indentation may remain. A user may have an option of loading the reaction vessels thereon at the user's discretion.

The reaction vessels 210a, 210b may contain a sample 220a, 220b therein. The sample may have any characteristics as described elsewhere herein. The sample may be a reaction mixture that may include a target nucleic acid. The sample may also include a reporter agent and/or any other types of reagents needed for nucleic acid amplification. The samples within the reaction vessels may be from the same subject or from different subjects. The samples may be from the same type of subject (e.g., human or same type of animal) or from different types of subjects. The samples may be the same type of sample or may be different types of samples. For example, they may be different types of biological samples and/or collected from different portions of one or more subjects. The same amount of sample may be provided or varying amounts of sample may be provided.

Optical signals 230a, 230b may be provided from the sample 220a, 220b. The optical signals may leave the reaction vessels 210a, 210b. In some instances, the optical signals may leave via a top of the reaction vessel. In other instances, the optical signals may leave via a bottom or side of the reaction vessel. In some instances, optical elements may be built into the support that may aid in permitting optical signals to escape.

A low voltage may be used to for thermal cycling. In some embodiment, the low voltage may be less than or equal to about 60 V, 50 V, 48 V, 40 V, 30 V, 24 V, 20 V, 18 V, 16 V, 15 V, 14 V, 13 V, 12V, 11 V, 10V, 9 V, 8V, 7 V, 6 V, 5 V, 4 V, 3 V, 2 V, or 1 V to perform the thermal cycling. In some instances, the a low voltage of less than or equal to about 50 V, 40 V, 30 V, 24 V, 20 V, 18 V, 16 V, 15 V, 14 V, 13 V, 12V, 11 V, 10V, 9 V, 8V, 7 V, 6 V, 5 V, 4 V, 3 V, 2 V, or 1 V may be used to perform the combination of thermal cycling and detecting.

In some instances, a low degree of power may be used for thermal cycling, or the combination of thermal cycling and detecting. For instance, about 84 W may be used to perform the thermal cycling and detecting. In some instances, a low power may be less than or equal to about 250 W, 200 W, 150 W, 130 W, 120 W, 110 W, 100 W, 90 W, 85 W, 84 W, 83 W, 80 W, 75 W, 70 W, 65 W, 60 W, 55 W, 50 W, 45 W, 40 W, 35 W, 30 W, 25 W, 20 W, 15 W, 10 W, 5 W, 1 W, 500 mW, 100 mW, 50 mW, 10 mW, 5 mW, or 1 mW. The amount of power used to operate the device may be less than or equal to any of the values described herein. Alternatively, the amount of power used to operate the device may be greater than equal to any of the values described herein. The amount of power used to operate the device may fall into a range between any two of the values described herein. The amount of power used to operate the thermal cycler and detector may have a total less than any of the values described herein. The amount of power used to operate the thermal cycler and detector may have a total greater than any of the values described herein. The amount of power used to operate the thermal cycler and detector may fall into a range between any two of the values described herein.

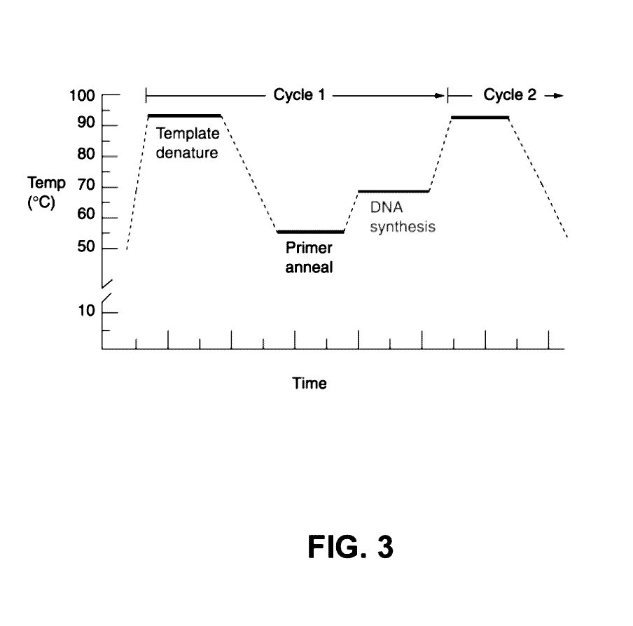

FIG. 3 shows an example of a thermal cycle in accordance with an embodiment of the present disclosure. The thermal cycles may include heating and cooling of a sample. For example, there may be temperature for template denaturing, a temperature for primer annealing, and a temperature for DNA synthesis. The thermal cycler of the device may control the temperature to heat and cool to these temperatures. Temperature measurements are provided by way of example only and are not limiting. Similarly, amounts of time are provided by way of example only and are not limiting.

The thermal cycler may cause the sample to undergo any number of thermal cycles. The nucleic acid amplification may occur over the course of the multiple cycles. Examples of thermal cycling processes are provided as follows, and are not limiting. Any type of thermal cycling technique known in the art may be employed by the device.

In any of the various aspects, primer sets directed to a target nucleic acid may be utilized to conduct nucleic acid amplification reaction. Primer sets generally comprise one or more primers. For example, a primer set may comprise about 1, 2, 3, 4, 5, 6, 7, 8, 9, 10, or more primers. In some cases, a primer set or may comprise primers directed to different amplified products or different nucleic acid amplification reactions. For example, a primer set may comprise a first primer necessary to generate a first strand of nucleic acid product that is complementary to at least a portion of the target nucleic acid and a second primer complementary to the nucleic acid strand product necessary to generate a second strand of nucleic acid product that is complementary to at least a portion of the first strand of nucleic acid product.

For example, a primer set may be directed to a target RNA. The primer set may comprise a first primer that can be used to generate a first strand of nucleic acid product that is complementary to at least a portion the target RNA. In the case of a reverse transcription reaction, the first strand of nucleic acid product may be DNA. The primer set may also comprise a second primer that can be used to generate a second strand of nucleic acid product that is complementary to at least a portion of the first strand of nucleic acid product. In the case of a reverse transcription reaction conducted in parallel with DNA amplification, the second strand of nucleic acid product may be a strand of nucleic acid (e.g., DNA) product that is complementary to a strand of DNA generated from an RNA template.

Where desired, any suitable number of primer sets may be used. For example, about 1, 2, 3, 4, 5, 6, 7, 8, 9, 10, or more primer sets may be used. Where multiple primer sets are used, one or more primer sets may each correspond to a particular nucleic acid amplification reaction or amplified product.

In some embodiments, a DNA polymerase is used. Any suitable DNA polymerase may be used, including commercially available DNA polymerases. A DNA polymerase generally refers to an enzyme that is capable of incorporating nucleotides to a strand of DNA in a template bound fashion. Non-limiting examples of DNA polymerases include Taq polymerase, Tth polymerase, Tli polymerase, Pfu polymerase, VENT polymerase, DEEPVENT polymerase, EX-Taq polymerase, LA-Taq polymerase, Expand polymerases, Sso polymerase, Poc polymerase, Pab polymerase, Mth polymerase, Pho polymerase, ES4 polymerase, Tru polymerase, Tac polymerase, Tne polymerase, Tma polymerase, Tih polymerase, Tfi polymerase, Platinum Taq polymerases, Hi-Fi polymerase, Tbr polymerase, Tfl polymerase, Pfutubo polymerase, Pyrobest polymerase, Pwo polymerase, KOD polymerase, Bst polymerase, Sac polymerase, Klenow fragment, and variants, modified products and derivatives thereof. For certain Hot Start Polymerase, a denaturation step at 94° C. −95° C. for 2 minutes to 10 minutes may be required, which may change the thermal profile based on different polymerases.

A reverse transcriptase is used may be used in accordance with some embodiments of the present disclosure. Any suitable reverse transcriptase may be used. A reverse transcriptase generally refers to an enzyme that is capable of incorporating nucleotides to a strand of DNA, when bound to an RNA template. Non-limiting examples of reverse transcriptases include HIV-1 reverse transcriptase, M-MLV reverse transcriptase, AMV reverse transcriptase, telomerase reverse transcriptase, and variants, modified products and derivatives thereof.

In various aspects, primer extension reactions are utilized to generate amplified product. Primer extension reactions generally comprise a cycle of incubating a reaction mixture at a denaturation temperature for a denaturation duration and incubating a reaction mixture at an elongation temperature for an elongation duration.

Denaturation temperatures may vary depending upon, for example, the particular biological sample analyzed, the particular source of target nucleic acid (e.g., viral particle, bacteria) in the biological sample, the reagents used, and/or the desired reaction conditions. For example, a denaturation temperature may be from about 80° C. to about 110° C. In some examples, a denaturation temperature may be from about 90° C. to about 100° C. In some examples, a denaturation temperature may be from about 90° C. to about 97° C. In some examples, a denaturation temperature may be from about 92° C. to about 95° C. In still other examples, a denaturation temperature may be about 80°, 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., or 100° C.

Denaturation durations may vary depending upon, for example, the particular biological sample analyzed, the particular source of target nucleic acid (e.g., viral particle, bacteria) in the biological sample, the reagents used, and/or the desired reaction conditions. For example, a denaturation duration may be less than or equal to 300 seconds, 240 seconds, 180 seconds, 120 seconds, 90 seconds, 60 seconds, 55 seconds, 50 seconds, 45 seconds, 40 seconds, 35 seconds, 30 seconds, 25 seconds, 20 seconds, 15 seconds, 10 seconds, 5 seconds, 2 seconds, or 1 second. For example, a denaturation duration may be no more than 120 seconds, 90 seconds, 60 seconds, 55 seconds, 50 seconds, 45 seconds, 40 seconds, 35 seconds, 30 seconds, 25 seconds, 20 seconds, 15 seconds, 10 seconds, 5 seconds, 2 seconds, or 1 second.

Elongation temperatures may vary depending upon, for example, the particular biological sample analyzed, the particular source of target nucleic acid (e.g., viral particle, bacteria) in the biological sample, the reagents used, and/or the desired reaction conditions. For example, an elongation temperature may be from about 30° C. to about 80° C. In some examples, an elongation temperature may be from about 35° C. to about 72° C. In some examples, an elongation temperature may be from about 45° C. to about 65° C. In some examples, an elongation temperature may be from about 35° C. to about 65° C. In some examples, an elongation temperature may be from about 40° C. to about 60° C. In some examples, an elongation temperature may be from about 50° C. to about 60° C. In still other examples, an elongation temperature may be about 35°, 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., or 80° C.

Elongation durations may vary depending upon, for example, the particular biological sample analyzed, the particular source of target nucleic acid (e.g., viral particle, bacteria) in the biological sample, the reagents used, and/or the desired reaction conditions. For example, an elongation duration may be less than or equal to 300 seconds, 240 seconds, 180 seconds, 120 seconds, 90 seconds, 60 seconds, 55 seconds, 50 seconds, 45 seconds, 40 seconds, 35 seconds, 30 seconds, 25 seconds, 20 seconds, 15 seconds, 10 seconds, 5 seconds, 2 seconds, or 1 second. For example, an elongation duration may be no more than 120 seconds, 90 seconds, 60 seconds, 55 seconds, 50 seconds, 45 seconds, 40 seconds, 35 seconds, 30 seconds, 25 seconds, 20 seconds, 15 seconds, 10 seconds, 5 seconds, 2 seconds, or 1 second.

In any of the various aspects, multiple cycles of a primer extension reaction can be conducted. Any suitable number of cycles may be conducted. For example, the number of cycles conducted may be less than about 100, 90, 80, 70, 60, 50, 40, 30, 20, 10, or 5 cycles. The number of cycles conducted may depend upon, for example, the number of cycles (e.g., cycle threshold value (Ct)) necessary to obtain a detectable amplified product (e.g., a detectable amount of amplified DNA product that is indicative of the presence of a target RNA in a biological sample). For example, the number of cycles necessary to obtain a detectable amplified product (e.g., a detectable amount of DNA product that is indicative of the presence of a target RNA in a biological sample) may be less than about or about 100 cycles, 75 cycles, 70 cycles, 65 cycles, 60 cycles, 55 cycles, 50 cycles, 40 cycles, 35 cycles, 30 cycles, 25 cycles, 20 cycles, 15 cycles, 10 cycles, or 5 cycles. Moreover, in some embodiments, a detectable amount of an amplifiable product (e.g., a detectable amount of DNA product that is indicative of the presence of a target RNA in a biological sample) may be obtained at a cycle threshold value (Ct) of less than 100, 75, 70, 65, 60, 55, 50, 45, 40, 35, 30, 25, 20, 15, 10, or 5.

The time for which amplification yields a detectable amount of amplified product indicative of the presence of a target nucleic acid amplified can vary depending upon the biological sample from which the target nucleic acid was obtained, the particular nucleic acid amplification reactions to be conducted, and the particular number of cycles of amplification reaction desired. For example, amplification of a target nucleic acid may yield a detectable amount of amplified product indicative to the presence of the target nucleic acid at time period of 120 minutes or less; 90 minutes or less; 60 minutes or less; 50 minutes or less; 45 minutes or less; 40 minutes or less; 35 minutes or less; 30 minutes or less; 25 minutes or less; 20 minutes or less; 15 minutes or less; 10 minutes or less; or 5 minutes or less.

In some embodiments, amplification of a target RNA may yield a detectable amount of amplified DNA product indicative to the presence of the target RNA at time period of 120 minutes or less; 90 minutes or less; 60 minutes or less; 50 minutes or less; 45 minutes or less; 40 minutes or less; 35 minutes or less; 30 minutes or less; 25 minutes or less; 20 minutes or less; 15 minutes or less; 10 minutes or less; or 5 minutes or less.

In some embodiments, a reaction mixture may be subjected to a plurality of series of primer extension reactions. An individual series of the plurality may comprise multiple cycles of a particular primer extension reaction, characterized, for example, by particular denaturation and elongation conditions as described elsewhere herein. Generally, each individual series differs from at least one other individual series in the plurality with respect to, for example, a denaturation condition and/or elongation condition. An individual series may differ from another individual series in a plurality of series, for example, with respect to any one, two, three, or all four of denaturing temperature, denaturing duration, elongation temperature, and elongation duration. Moreover, a plurality of series may comprise any number of individual series such as, for example, at least about or about 2, 3, 4, 5, 6, 7, 8, 9, 10, or more individual series.

For example, a plurality of series of primer extension reactions may comprise a first series and a second series. The first series, for example, may comprise more than ten cycles of a primer extension reaction, where each cycle of the first series comprises (i) incubating a reaction mixture at about 92° C. to about 95° C. for no more than 30 seconds followed by (ii) incubating the reaction mixture at about 35° C. to about 65° C. for no more than about one minute. The second series, for example, may comprise more than ten cycles of a primer extension reaction, where each cycle of the second series comprises (i) incubating the reaction mixture at about 92° C. to about 95° C. for no more than 30 seconds followed by (ii) incubating the reaction mixture at about 40° C. to about 60° C. for no more than about 1 minute. In this particular example, the first and second series differ in their elongation temperature condition. The example, however, is not meant to be limiting as any combination of different elongation and denaturing conditions could be used.

In some embodiments, the ramping time (i.e., the time the thermal cycler takes to transition from one temperature to another) and/or ramping rate can be important factors in amplification. For example, the temperature and time for which amplification yields a detectable amount of amplified product indicative of the presence of a target nucleic acid can vary depending upon the ramping rate and/or ramping time. The ramping rate can impact the temperature(s) and time(s) used for amplification.

Optionally, the ramping time and/or ramping rate can be different between cycles. In some situations, however, the ramping time and/or ramping rate between cycles can be the same. The ramping time and/or ramping rate can be adjusted based on the sample(s) that are being processed.

In some situations, the ramping time between different temperatures can be determined, for example, based on the nature of the sample and the reaction conditions. The exact temperature and incubation time can also be determined based on the nature of the sample and the reaction conditions. In some embodiments, a single sample can be processed (e.g., subjected to amplification conditions) multiple times using multiple thermal cycles, with each thermal cycle differing for example by the ramping time, temperature, and/or incubation time. The best or optimum thermal cycle can then be chosen for that particular sample. This provides a robust and efficient method of tailoring the thermal cycles to the specific sample or combination of samples being tested.

In some embodiments, a target nucleic acid may be subjected to a denaturing condition prior to initiation of a primer extension reaction. In the case of a plurality of series of primer extension reactions, the target nucleic acid may be subjected to a denaturing condition prior to executing the plurality of series or may be subjected to a denaturing condition between series of the plurality. For example, the target nucleic acid may be subjected to a denaturing condition between a first series and a second series of a plurality of series. Non-limiting examples of such denaturing conditions include a denaturing temperature profile (e.g., one or more denaturing temperatures) and a denaturing agent.

An advantage of conducting a plurality of series of primer extension reaction may be that, when compared to a single series of primer extension reactions under comparable denaturing and elongation conditions, the plurality of series approach yields a detectable amount of amplified product that is indicative of the presence of a target nucleic acid in a biological sample with a lower cycle threshold value. Use of a plurality of series of primer extension reactions may reduce such cycle threshold values by at least about or about 1%, 5%, 10%, 15%, 20%, 25%, 30%, 35%, 40%, 45%, 50%, 55%, 60%, 65%, 70%, 75%, 80%, 85%, 90%, or 95% when compared to a single series under comparable denaturing and elongation conditions.

In some embodiments, a biological sample may be preheated prior to conducting a primer extension reaction. The temperature (e.g., a preheating temperature) at which and duration (e.g., a preheating duration) for which a biological sample is preheated may vary depending upon, for example, the particular biological sample being analyzed. In some examples, a biological sample may be preheated for no more than about 60 minutes, 50 minutes, 40 minutes, 30 minutes, 25 minutes, 20 minutes, 15 minutes, 10 minutes, 9 minutes, 8 minutes, 7 minutes, 6 minutes, 5 minutes, 4 minutes, 3 minutes, 2 minutes, 1 minute, 45 seconds, 30 seconds, 20 seconds, 15 seconds, 10 seconds, or 5 seconds. In some examples, a biological sample may be preheated at a temperature from about 80° C. to about 110° C. In some examples, a biological sample may be preheated at a temperature from about 90° C. to about 100° C. In some examples, a biological sample may be preheated at a temperature from about 90° C. to about 97° C. In some examples, a biological sample may be preheated at a temperature from about 92° C. to about 95° C. In still other examples, a biological sample may be preheated at a temperature of about 80°, 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., or 100° C.

In any of the various aspects, the time required to complete the elements of a method may vary depending upon the particular steps of the method. For example, an amount of time for completing the elements of a method may be from about 5 minutes to about 120 minutes. In other examples, an amount of time for completing the elements of a method may be from about 5 minutes to about 60 minutes. In other examples, an amount of time for completing the elements of a method may be from about 5 minutes to about 30 minutes. In other examples, an amount of time for completing the elements of a method may be less than or equal to 120 minutes, less than or equal to 90 minutes, less than or equal to 75 minutes, less than or equal to 60 minutes, less than or equal to 45 minutes, less than or equal to 40 minutes, less than or equal to 35 minutes, less than or equal to 30 minutes, less than or equal to 25 minutes, less than or equal to 20 minutes, less than or equal to 15 minutes, less than or equal to 10 minutes, or less than or equal to 5 minutes.

The automated thermal cycler may be capable of controlling a temperature of a sample precisely to achieve a desired temperature profile. The automated thermal cycler may be capable of controlling the temperature to within about plus or minus 5 degrees C., 4 Degrees C, 3 degrees C., 2 degrees C., 1.2 degrees C., 1 degree C., 0.7 degrees C., 0.5 degrees C., 0.3 degrees C., 0.1 degrees C., 0.05 degrees C., 0.01 degrees C., 0.005 degrees C., or 0.001 degrees C. The automated thermal cycler may advantageously be capable of providing high quality temperature control while operating at a low voltage and/or low power. The automated thermal cycler may be advantageously capable of delivering high quality temperature control while having small dimensions. In some instances, heat blocks may be used. Liquid metal heat blocks may be an example of heat blocks that may be used. A heating system using thermally conductive fluid may optionally be used. Alternatively, no thermally conductive fluid may be used. In some instances, a high density of heating and/or cooling elements may be provided for a heat block.

Detection of signals from the sample undergoing amplification may occur throughout the process. The detection may occur continuously or at one or more points during the amplification process. The sample may emit optical signals throughout the process. The optical signals may be related to the amount of amplified target nucleic acid in the sample.

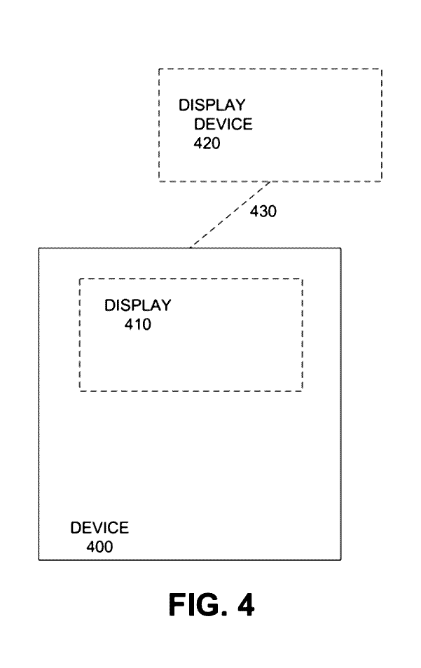

FIG. 4 shows an example of a device and a display in accordance with an embodiment of the present disclosure. The device 400 may be used to conduct nucleic acid amplification of a target nucleic acid in a sample. The sample may be loaded into the device. A thermal cycler of the device may alternating heat and cool the sample. The device may include a detector that may be capable of detecting signals relating to the amplification of the target nucleic acid in the sample in real-time.

Optionally, data relating to the detected signals may be displayed in real-time. For example, data relating to the progress of the nucleic acid amplification and/or results of the nucleic acid amplification may be displayed while amplification is occurring. In some instances, a display 410 may be built-into the device. For example, the display may be provided on a housing of the device. Any description of a display may apply to any type of output module. The display may include a visual display, as well as optional audio or tactile output of information. The display may show information on a screen or other type of user interface (UI). For example, a screen may be built into the device.

In other instances, the data may be shown on a separate display device 420. The separate display device may communicate with the device 400. In some instances, communications may occur via a connection 430. The connection may be a hard-wired connection or a wireless connection. Direct communications may occur between the device and the display device. For example, Bluetooth, infra-red communications, radio, WiFi, or other direct communications may occur. In other instances, indirect communications may occur between the device and the display device. For examples, communications may occur over a network, such as a local area network (LAN), or wide area network (WAN) such as the Internet. In some instances, telecommunications networks may be used (e.g., cellular phone networks, data networks). In some examples, 3G or 4G networks may be used for communications. One or more intermediate devices, such as relay devices (e.g., towers) or router, may be used in communications. Alternatively, no intermediate devices may be used.

A device 400 may have an input module that receives a user request to amplify a target nucleic acid (e.g., target RNA, target DNA) present in a biological sample obtained direct from a subject. Any suitable module capable of accepting such a user request may be used. The input module may comprise, for example, a device that comprises one or more processors. The input module may be built into the device. The input module may be integrated into a housing of the device or accessible from outside the housing.

Alternatively, the input module may be separate or separable from the device. The input module may communicate with the device over a connection, such as those described elsewhere herein. Non-limiting examples of devices that comprise processors include a desktop computer, a laptop computer, a tablet computer (e.g., Apple® iPad, Samsung® Galaxy Tab), a cell phone, a smart phone (e.g., Apple® iPhone, Android® enabled phone), a personal digital assistant (PDA), a video-game console, a television, a music playback device (e.g., Apple® iPod), a video playback device, a pager, and a calculator. Processors may be associated with one or more controllers, calculation units, and/or other units of a computer system, or implanted in firmware as desired. If implemented in software, the routines (or programs) may be stored in any computer readable memory such as in RAM, ROM, flash memory, a magnetic disk, a laser disk, or other storage medium. Likewise, this software may be delivered to a device via any known delivery method including, for example, over a communication channel such as a telephone line, the internet, a local intranet, a wireless connection, etc., or via a transportable medium, such as a computer readable disk, flash drive, etc. The various steps may be implemented as various blocks, operations, tools, modules or techniques which, in turn, may be implemented in hardware, firmware, software, or any combination thereof. When implemented in hardware, some or all of the blocks, operations, techniques, etc. may be implemented in, for example, a custom integrated circuit (IC), an application specific integrated circuit (ASIC), a field programmable logic array (FPGA), a programmable logic array (PLA), etc.

In some embodiments, the input module is configured to receive a user request to perform amplification of the target nucleic acid. The input module may receive the user request directly (e.g. by way of an input device such as a keyboard, mouse, or touch screen operated by the user) or indirectly (e.g. through a wired or wireless connection, including over the internet). Via output electronics, the input module may provide the user's request to the amplification module. In some embodiments, an input module may include a user interface (UI), such as a graphical user interface (GUI), that is configured to enable a user provide a request to amplify the target nucleic acid. A GUI can include textual, graphical and/or audio components. A GUI can be provided on an electronic display, including the display of a device comprising a computer processor. Such a display may include a resistive or capacitive touch screen.

Non-limiting examples of users include the subject from which the biological sample was obtained, medical personnel, clinicians (e.g., doctors, nurses, laboratory technicians), laboratory personnel (e.g., hospital laboratory technicians, research scientists, pharmaceutical scientists), a clinical monitor for a clinical trial, or others in the health care industry.

As previously described, the system comprises an output module operatively connected to the amplification module. In some embodiments the output module may comprise a device with a processor as described above for the input module. The output module may include input devices as described herein and/or may comprise input electronics for communication with the amplification module. In some embodiments, the output module may be an electronic display, such as a display 410 on a nucleic acid amplification device or a separate display device 420. In some cases, the electronic display may comprise a UI. In some embodiments, the output module is a communication interface operatively coupled to a computer network such as, for example, the internet. In some embodiments, the output module may transmit information to a recipient at a local or remote location using any suitable communication medium, including a computer network, a wireless network, a local intranet, or the internet. In some embodiments, the output module is capable of analyzing data received from the amplification module. The output module may analyze information in real-time while amplification is occurring. Some data may be analyzed after the amplification has been completed. In some cases, the output module includes a report generator capable of generating a report and transmitting the report to a recipient, wherein the report contains any information regarding the amount and/or presence of amplified product as described elsewhere herein. In some embodiments, the output module may transmit information automatically in response to information received from the amplification module, such as in the form of raw data or data analysis performed by software included in the amplification module. Alternatively, the output module may transmit information after receiving instructions from a user. Information transmitted by the output module may be viewed electronically or printed from a printer.

One or more of the input module, amplification module, and output module may be contained within the same device or may comprise one or more of the same components. For example, an amplification module may also comprise an input module, an output module, or both. In other examples, a device comprising a processor may be included in both the input module and the output module. A user may use the device to request that a target nucleic acid be amplified and may also be used to transmit information regarding amplified product to a recipient. In some cases, a device comprising a processor may be included in all three modules, such that the device comprising a processor may also be used to control, provide instructions to, and receive information back from instrumentation (e.g., a thermal cycler, a detector, a fluid handling device) included in the amplification module or any other module.

In some instances, low voltage may be used to power the device. Low voltage may be used to power the amplification module and detector. In some instances, low voltage may be used to power the amplification module, detector and output module. Optionally, low voltage may be used to power the input module, amplification module, detector, and output module. Low voltage may be used to power any one or more of the input module, amplification module, detector, and output module. Low voltage as described herein may refer to 12 V or less, or any other voltage values as described elsewhere herein. For example, a total of 12 V or less (or any other voltage value described elsewhere herein) may be used to power the simultaneous use of the amplification module, detector and output module, wherein the detector may detect amplification in real-time, and the output module may optionally show results of detected amplification in real-time.

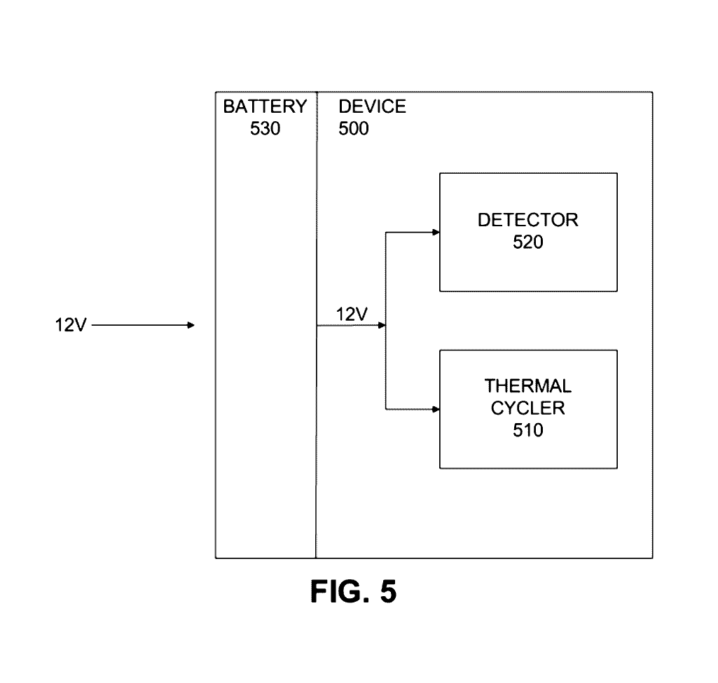

FIG. 5 shows an example of power being provided to a device that includes a battery in accordance with an embodiment of the present disclosure. A device may include a thermal cycler 510 and detector 520 as described elsewhere herein. The device may also be operably linked to an energy storage device 530.

The energy storage device 530 may be a battery pack. The battery pack may be a portable battery pack. The battery pack may comprise one or more batteries. The batteries may be an electrochemical energy storage device. For example, the battery pack may include a single or multiple battery cells. The battery may be a lithium-based battery, such as a lithium ion battery. The battery may have any chemistry, including but not limited to lead acid batteries, valve regulated lead acid batteries (e.g., gel batteries, absorbed glass mat batteries), nickel-cadmium (NiCd) batteries, nickel-zinc (NiZn) batteries, nickel metal hydride (NiMH) batteries, or lithium-ion (Li-ion) batteries.

The energy storage device 530 may be part of the device 500. In one example, the energy storage device may be provided within a housing of the device. The energy storage device may be removable from the device or may be an integral part of the device. In some instances, the energy storage device may be placed within the housing of the device and/or removed from within the housing of the device. Energy storage devices may be swapped or exchanged. In some instances, the energy storage devices may be rechargeable. The energy storage devices may be rechargeable while within the device, or may be removed to be recharged.

In another example, the energy storage device may be directly attached to the device but not within the housing of the device. For example, an external attachment and/or connection may be provided. The energy storage device may directly contact the device housing. The energy storage device may be attached to the device and into place via one or more connector or mechanical fastener. The energy storage device may be separably attached to the device. For example, the energy storage may be attached and detached from the device. Energy storage devices may be swapped. The energy storage device may be rechargeable. The energy storage devices may be rechargeable while attached to the device, or may be separated to be recharged.

The energy storage device may be electrically connected to the device via one or more connector. For example, the connector may be a wire, cable, or other conductive pathway. Optionally, the connector may be a flexible conductive pathway. For example, the energy storage device may be plugged into the device or vice versa. The energy storage device and the device may be separable from one another. Different energy storage devices may be swapped for the device. For example, the device may plug into different energy storage devices. The energy storage device may be rechargeable. The energy storage devices may be rechargeable while electrically connected to the device, or may be separated to be recharged. A physical electrical connection may be provided between the energy storage device and the device. Alternatively, the energy storage device may wirelessly power the device.

The energy storage device may use low voltage to power the device. For example, the energy storage device may provide no more than 12 V or other voltage values described elsewhere herein to power the device. The storage device may use no more than a total of 12 V (or any other voltage value described elsewhere herein) to power the thermal cycler and the detector of the device. Optionally, other components of the device (e.g., input module, output module, light source, processors), may also be powered using no more than a total of 12 V.

The energy storage device may receive a low voltage power when charging the device. For example, no more than 12 V, or other voltage values described elsewhere herein, may be used to charge the energy storage device. The energy storage device may optionally output energy at the same voltage as it receives.

In some instances, when energy is coming in from an external power source, the device may be powered directly from the external power source. In another example, even when energy is coming in from an external power source, the device may be powered through the energy storage device, and the external power source may be used to charge the energy storage device. In some instances, the energy coming in from the external power source may be used to power the device when the energy storage unit is fully charged.

As previously described any low voltage power may be used to power the device. Similarly, any low voltage power may be used to charge the energy storage device. Any reference to low voltage may include a voltage of 50 V or less, 40 V, or less, 35 V, or less, 30 V, or less, 25 V or less, 24 V or less, 22 V or less, 20 V or less, 19 V or less, 18 V or less, 17 V or less, 16 V or less, 15 V or less, 14 V or less, 13.5 V or less, 13 V or less, 12.5 V or less, 12 V or less, 11.5 V or less, 11 V or less, 10.5 V or less, 10 V or less, 9.5 V or less, 9 V or less, 8 V or less, 7 V or less, 6 V or less, 5 V or less, 4 V or less, 3 V or less, 2 V or less, 1 V or less, 500 mV or less, 200 mV or less, 100 mV or less, 50 mV or less, 10 mV or less, 5 mV or less, or 1 mV or less.

The device may be capable of operating at low power. Any combination of components may be capable of operating at low power. For example, the thermal cycler and the detector may be capable of operating at a combined low power. The thermal cycler and detector and input unit may be capable of operating at a combined low power. The thermal cycler, detector, input unit and output unit may be capable of operating at a combined low power. Any reference to a low power may include a power of 250 W or less, 200 W or less, 150 W or less, 130 W or less, 120 W or less, 110 W or less, 100 W or less, 90 W or less, 85 W or less, 84 W or less, 83 W or less, 80 W or less, 75 W or less, 70 W or less, 65 W or less, 60 W or less, 55 W or less, 50 W or less, 45 W or less, 40 W or less, 35 W or less, 30 W or less, 25 W or less, 20 W or less, 15 W or less, 10 W or less, 5 W or less, 1 W or less, 500 mW or less, 100 mW or less, 50 mW or less, 10 mW or less, 5 mW or less, 1 mW or less, or any other power value described elsewhere herein.

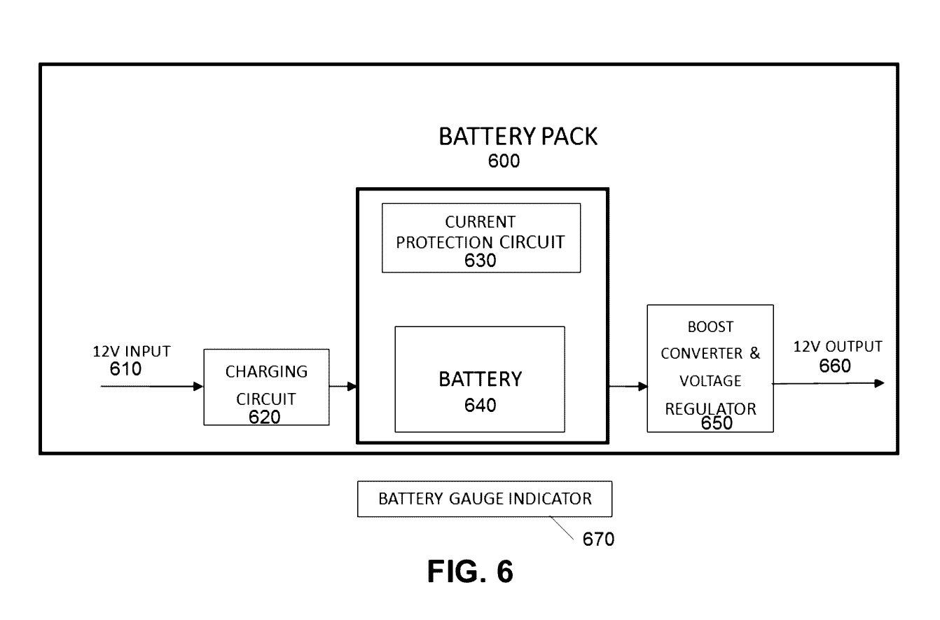

FIG. 6 shows a schematic of a battery pack in accordance with an embodiment of the present disclosure. Any description of a battery pack may apply to any other type of energy storage device and vice versa.

The battery pack 600 may receive a low voltage input 610. For example, the low voltage input may be 12 V or less, or any other voltage described elsewhere herein. The voltage input may be provided from an external power source. In some instances, the external power source may be a charging port in a vehicle or a facility. For example, an electrical outlet or other type of charging port may be used. In another example, the external power source may be a power generation device. In some instances, the power generation device may provide power by use of kinetic energy (e.g., crank or dynamo), renewable energy source (e.g., solar, wind, water, geothermal), chemical, nuclear, or any other type of power generation source. External power sources may include on-grid or off-grid power sources. The voltage input may be direct current (DC) and/or alternating current (AC).

The voltage input may be provided to a charging circuit 620. The charging circuit may be in electrical communication with a current protection circuit 630 and a battery 640. The charging circuit and/or current protection circuit may prevent overcharging of the battery. For example, overvoltage may be prevented. The charging circuit and/or current protection circuit may regulate charging of the battery. A single battery or multiple batteries may be provided in a battery pack. If multiple batteries are provided, they may be connected in series, in parallel or any combination thereof.

The current protection circuit and battery may be coupled to a boost converter and/or voltage regulator 650. In one example, the boost converter may include a voltage-step-up. The voltage-step-up may be DC-DC. The voltage regulator may control the battery pack to maintain constant voltage. For instance, the boost converter and voltage regulator may permit the voltage output 660 from the battery pack to remain constant. The voltage output may optionally be a low voltage, such as 12 V or less, or any other voltage value described elsewhere herein.

In some embodiments, the voltage input 610 may equal the voltage output 660. The voltage input may or may not be constant. Preferably, the voltage output may remain constant. The voltage output may be a voltage used to power a device. The voltage output may be DC.

The output 660 from the battery may be at any current. In some examples, the output may be at 7 amps. The current value may be a maximum current value. Any other embodiments, any current value may be provided, such as about 50 A or less, 30 A or less, 20 A or less, 15 A or less, 13 A or less, 12 A or less, 11 A or less, 10 A or less, 9 A or less, 8 A or less, 7 A or less, 6 A or less, 5 A or less, 4 A or less, 3 A or less, 2 A or less, 1 A or less, 500 mA or less, 200 mA or less, 100 mA or less, 50 mA or less, 10 mA or less, 5 mA or less, or 1 mA or less. In one instance, the output may be 12 V DC with a maximum of 7 A.

The charger power may be at 12 V 7 A DC. In some instances, charger power may be less than or equal to about 84 W. In some instances, the charger power may be less than or equal to about 200 W, 150 W, 120 W, 100 W, 90 W, 88 W, 85 W, 84 W, 83 W, 82 W, 80 W, 75 W, 70 W, 65 W, 60 W, 55 W, 50 w, 45 W, 40 W, 35 W, 30 W, 25 W, 20 W, 15 W, 10 W, 5 W, 3 W, 2 W, 1 W, 500 mw, 100 mW, 50 mW, 10 mW, 5 mW, or 1 mW.

The battery pack may have any capacity. For example, the capacity may be about 13.2 Ah. In other instances, the capacity may be less than or equal to about 100 Ah, 50 Ah, 30 Ah, 25 Ah, 20 Ah, 17 Ah, 16 Ah, 15 Ah, 14 Ah, 13.5 Ah, 13 Ah, 12.5 Ah, 12 Ah, 11 Ah, 10 Ah, 9 Ah, 8 Ah, 7 Ah, 6 Ah, 5 Ah, 4 Ah, 3 Ah, 2 Ah, or 1 Ah.

A gauge indicator 670 may be provided for the battery pack. The gauge indicator may be indicative of a level of charge for the battery pack. In one example, the gauge indicator may include lights that may light up to indicate the level of charge. For example the number of lights that are lit out of the total number of lights may be indicative of the level of battery charge. For example, if four light sources are provided, and all four are lit, the gauge may be indicating that the battery pack is close to 100% charged. If two of the four light sources are lit, the gauge may indicate that the battery pack is about 50% charged. If no light sources are lit, the gauge may indicate the battery pack is about 0% charged. Any number of lights may be provided to provide different gradations of charge. In some instances, a numerical value may be displayed that may be indicative of the level of charge. For example, a number may indicate that the battery pack is about 66% charged. In another example, a color may be displayed that may indicate a level of charge. For example, a green color may indicate that the battery pack is fully charged or has a significant amount of charge remaining. A yellow light may indicate that the battery is running low, and a red light may indicate that the battery is completely discharged or close to being completely discharged and needs to be recharged immediately. In another example, a visual indicator such as a bar may be provided. The level of charge may be indicated how full the bar is. Flashing of lights may indicate level of charge. For example, a steady light may indicate a well-charged battery pack while flashing may indicate that charge level is getting low. Any other type of visual indicator may be displayed to indicate level of charge. In other instances, audio or tactile indicators may be provided to indicate level of charge. For example, when charge is getting low an audio sound may be provided, such as a beeping or words of warning. In another example, when the charge is getting low, the battery pack may vibrate or provide any other type of tactile warning.

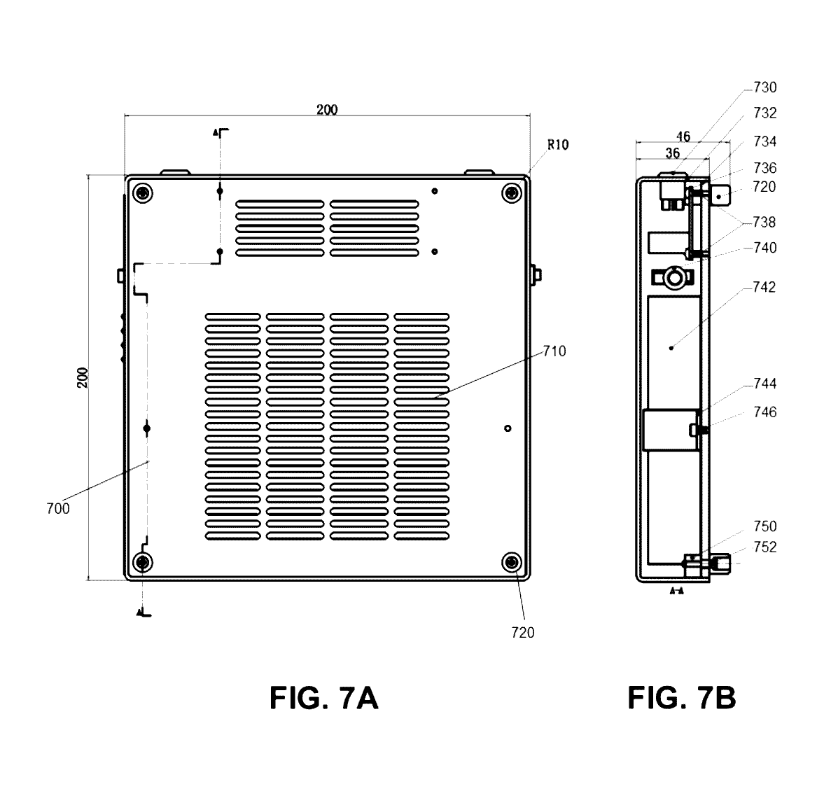

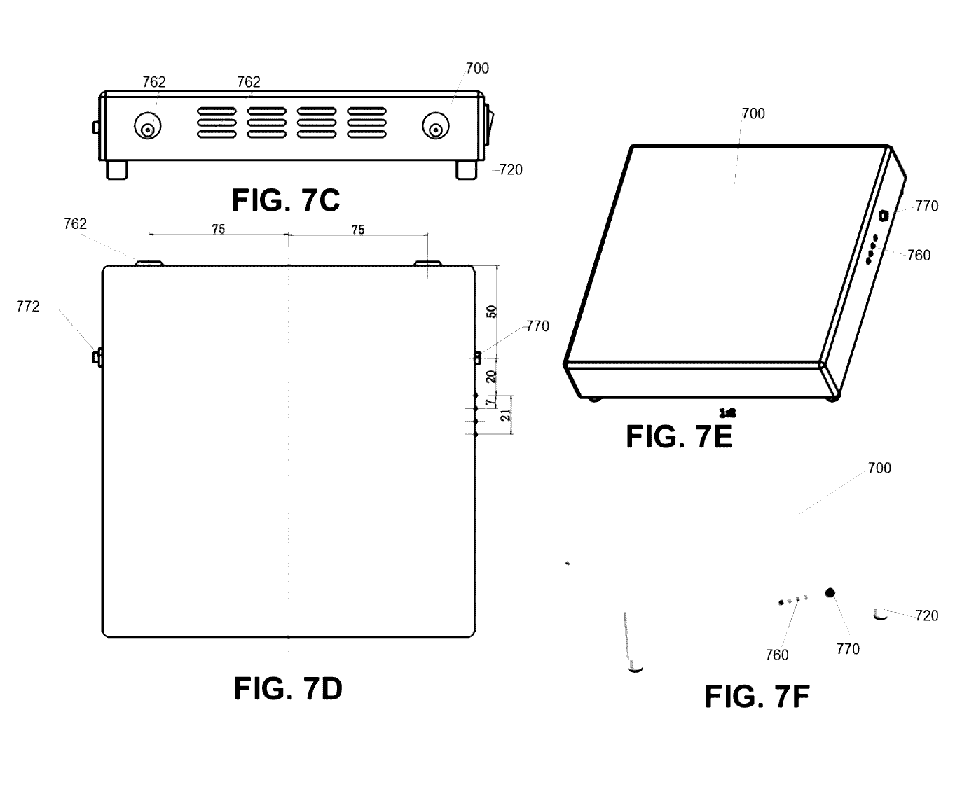

FIG. 7A shows a bottom view of a battery pack in accordance with an embodiment of the present disclosure. The battery pack 700 may optionally include one or more vents 710. The vents may permit heat to escape from the interior of the battery pack. The vents may permit ambient air to circulate within the battery pack. Convection may be used to aid in cooling of the battery pack. Other techniques, such as conduction may be used. Optionally, heat fins, heat sinks, or other type of temperature management systems may be provided for the battery pack.

The battery pack may optionally have one or more stands 720. The stands may raise the battery pack from a surface. The stands may be configured to bear the weight of the battery pack when the battery is resting on the surface. Optionally, the use of stands may raise the bottom surface of the battery pack from the underlying surface. A gap may be provided between the two surfaces. This may permit air to flow within the gap. The vents 710 may thus lead into the air rather than the underlying surface. This may aid in the cooling of the battery pack. Heat exchange may occur more readily underneath the battery pack when the battery pack is raised from the surface via the stands.

FIG. 7B shows a side view of a battery pack 700 in accordance with an embodiment of present disclosure. One or more power outlet and/or inlets 730 may be provided. For example, a DC outlet may be provided. The outlet may be a 12 V outlet. In some instances an inlet may be provided as well. The inlet may be an AC or DC inlet. The inlet may be a 12 V inlet.

The battery pack may include a case 732. The case may be a housing that may cover one or more portions of the battery pack. The case may contain one or more components of the battery pack therein. The components may be completely or partially enclosed within the case. The housing may be formed from a rigid structure. The housing may enclose one or more batteries therein.

A bottom panel 734 may be provided on the battery pack. The bottom panel may support one or more components of the battery pack. The bottom panel may constitute a bottom surface of the battery pack. One or more vents may be provided through or adjacent to the bottom panel.

A battery pack may also include a circuit board 736 therein. The circuit board may be provided within a case of the battery pack. The circuit board may include a charging circuit and/or protection circuit. In some instances, the circuit board may include a boost converter and/or voltage regulator. The circuit board may include charge control/protection capabilities.

One or more stands 720 may be provided on the battery pack. The stands may protrude from the battery pack. The stands may permit the battery to rest on the stands in a stable manner. The stands may create a gap between a bottom surface of the battery pack and an underlying surface.

In some instances, one or more screws 738 may be provided or other types of mechanical fasteners. The screws may attach a circuit board 736 to an underlying structure. Any type of fastening technique may be used to fasten a circuit board within the case of the battery pack. Mechanical fasteners and/or adhesives may be used. Fastening the circuit board may prevent it from moving around in an uncontrolled manner within the battery pack. Fastening the circuit board may also permit the desired electrical connections to remain in contact.

A switch mechanism 740 may be provided. Optionally, the switch mechanism may have a screw nut or other type of attachment. The switch may be used to control one or more function of the battery pack. The switch may be used to turn the battery pack on or off. The switch may be used to turn a battery gauge indicator on or off.

The battery pack may include one or more batteries 742 disposed therein. Any number of batteries may be provided therein. For instance, 1, 2, 3, 4, 5, 6, 7, 8, 9, 10, 11, 12, 13, 14, 15, 16, 17, 18, 19, 20 or more batteries may be provided. One or more battery cells may be connected in series, parallel, or any combination thereof. The battery may be held within the battery pack via a battery holder 744. The battery holder may be attached using a mechanical fastener, such as a hex screw 746. The battery holder may keep the one or more batteries affixed within the case. The holder may or may not allow the battery to be removed from the case. The battery pack may optionally include a screw nut 750 and screw (such as a flat head screw) 752. Any other of fastening mechanism may be employed. The fastener may be used to fasten the stand 720 to the battery case. In some instances, the fastener may be used to fasten one or more batteries within the case.

FIG. 7C shows another side view of a battery pack 700 in accordance with an embodiment of present disclosure. The battery pack may include one or more vents 710. The vents may permit heat to dissipate from one or more components of the battery pack. The vents may permit the exchange of air or other fluid within the battery pack and the outside the battery pack.

The battery pack may optionally include one or more stands 720 that may elevate a battery pack over an underlying surface.

The battery pack may also include a power inlet and a power outlet 762. In some instances, the power inlet may be configured to receive power from an external power source. The power outlet may be configured to connect to a device for conducting nucleic acid amplification. In some instances, a low voltage power, such as 12 V may be provided to the power inlet, and a low voltage power, such as 12 V may exit the battery pack and be used to power the device.

FIG. 7D shows a top view of a battery pack 700 in accordance with an embodiment of present disclosure. A power inlet and power outlet 762 may be provided as described elsewhere herein. The power inlet and power outlet may be provided adjacent to one another or spaced apart from one another. They may be provided on the same side of the battery pack or different sides.

A switch 770 may be provided. The switch may be used to control an aspect of the battery pack. For example, the switch may be a battery capacity switch used to turn a battery gauge indicator 760 on or off. Pressing the switch may show a level of charge for the battery. The battery capacity switch can be designed to show the battery gauge via on or off of one or more indicator lights. For example, one light on is indicative of around 25% battery gauge, two lights is indicative of around 50%, and so on. In alternate embodiments, the switch or another switch may be used to turn a charging mode of the battery on or off, or to turn the battery pack power on or off.

The battery may include a battery gauge indicator 760. The battery gauge indicator may indicate a level of charge for the battery. Any type of battery gauge indicator, such as those described elsewhere herein, may be used.

Optionally the battery may also include a battery switch 772. Pressing the switch may turn the battery pack on or off. The battery gauge 760 can be shown independently upon pressing switch 770, without turning on the main power switch 772. In alternate embodiments, there may be no separate battery capacity switch 770. The battery gauge can be shown once the main switch 772 is turned on.

FIG. 7E shows a perspective view of a battery pack 700 in accordance with an embodiment of the present disclosure. As previously discussed, the battery may include a control switch 770 or other controlling interface. For example, any description of a control switch may also apply to a button, knob, dial, touchscreen, keyboard, mouse, trackball, pointer, joystick, or any other type of user interactive device.

The battery may include a battery gauge indicator 760 as described elsewhere herein. Any other techniques may be employed to provide an indication of the level of charge.

FIG. 7F shows another perspective view of a battery pack 700 in accordance with an embodiment of the present disclosure. A previously mentioned, the battery may include one or more stands 720, a control device 770, and/or a battery gauge indicator 760. As previously described, the battery may accept a power input at 12 V or less and provide a power output as 12 V or less.

The battery pack may require any amount of time to become fully charged. In one example, the charge time (e.g., from empty to fully charged) may be about 5 hours. In some instances, the charging time may be less than or equal to about 20 hours, 15 hours, 12 hours, 10 hours, 8 hours, 7 hours, 6.5 hours, 6 hours, 5.5 hours, 5 hours, 4.5 hours, 4 hours, 3.5 hours, 3 hours, 2 hours, 1 hour, 45 minutes, 30 minutes, 20 minutes, 15 minutes, 10 minutes, 8 minutes, 7 minutes, 6 minutes, 5 minutes, 3 minutes, 2 minutes, 1 minute, 45 seconds, 30 seconds, 15 seconds, or 10 seconds. In some instances, the charging time may be greater than or equal to any of the charge times described herein. The charging time may fall within a range between any two of the values described herein.

The battery pack may have any working duration. The working duration may include the amount of time the battery pack can operate from a fully charged state to a fully discharged state. In some instances, the working duration may be less than the charging time. Alternatively, the working duration may be greater than or equal to the charging time. The working duration may be about 4 hours or less. In some instances, the working duration may be less than or equal to about 20 hours, 15 hours, 12 hours, 10 hours, 8 hours, 7 hours, 6 hours, 5 hours, 4.5 hours, 4 hours, 3.5 hours, 3 hours, 2.5 hours, 2 hours, 1.5 hours, 1 hour, 45 minutes, 30 minutes, 20 minutes, 15 minutes, 10 minutes, 8 minutes, 7 minutes, 6 minutes, 5 minutes, 3 minutes, 2 minutes, 1 minute, 45 seconds, 30 seconds, 15 seconds, or 10 seconds. In some instances, the working durations may be greater than or equal to any of the working durations described herein. The working durations may fall within a range between any two of the values described herein.

Any dimensions may be provided for a battery pack. The batter pack may be portable. The battery pack may be capable of being lifted and carried by a human. The battery pack may be capable of placing in a car. The battery pack may have a maximum dimension (e.g., length, width, height, diagonal, diameter) of no more than about 200 mm. The battery pack may have a maximum dimension of no more than about 1 mm, 3 mm, 5 mm, 7 m, 10 mm, 15 mm, 20 mm, 30 mm, 40 mm, 50 mm, 60 mm, 70 mm, 100 mm, 120 mm, 150 mm, 170 mm, 180 mm, 190 mm, 200 mm, 210 mm, 220 mm, 250 mm, 270 mm, 300 mm, 350 mm, 400 mm, 450 mm, 500 mm, 550 mm, 600 mm, 700 mm, or 1 m. Alternatively, the battery pack may have a maximum dimension greater than any of the dimension values described herein. In some instances, the battery pack may have a maximum dimension falling within a range between any two of the values described herein.

Any footprint may be provided for the battery pack. The footprint may include a lateral cross-sectional area of the battery pack. The footprint may include an area of a surface that the battery pack would occupy when resting on the surface. In some instances, the battery pack may have a footprint of less than or equal to about 1 cm², 5 cm², 10 cm², 15 cm², 20 cm², 25 cm², 30 cm², 40 cm², 50 cm², 60 cm², 70 cm², 80 cm², 90 cm², 100 cm², 120 cm², 150 cm², 200 cm², 250 cm², 300 cm², 350 cm², 400 cm², 500 cm², 600 cm², 700 cm², 800 cm², 900 cm², 1000 cm², 1200 cm², 1500 cm², 1700 cm², or 2000 cm². The battery pack may have a footprint greater than or equal to any of the values described herein. The battery pack may have a footprint falling into a range between any two of the values described herein.

The battery pack may have any volume. In some instances, the battery pack may have the dimensions of about 200 mm×200 mm×50 mm. The battery pack may have a volume of about 2000 cm3. In some instances, the battery may have a volume of less than about 1 cm³, 5 cm³, 10 cm³, 15 cm³, 20 cm³, 25 cm³, 30 cm³, 40 cm³, 50 cm³, 60 cm³, 70 cm³, 80 cm³, 90 cm³, 100 cm³, 120 cm³, 150 cm³, 200 cm³, 250 cm³, 300 cm³, 350 cm³, 400 cm³, 500 cm³, 600 cm³, 700 cm³, 800 cm³, 900 cm³, 1000 cm³, 1200 cm³, 1500 cm³, 1700 cm³, 2000 cm³, 2200 cm³, 2500 cm³, 3000 cm³, 3500 cm³, 4000 cm³, 5000 cm³, 7000 cm³, or 10,000 cm³. The battery pack may have a volume greater than any of the volumes described herein. The battery pack may have a volume falling within a range between any two of the values described herein.

The battery pack may have any weight. For example, the battery pack may weigh less than or equal to about 1.65 kg. The battery pack may weigh less than or equal to about 1 mg, 10 mg, 100 mg, 1 g, 10 g, 100 g, 200 g, 300 g, 400 g, 500 g, 600 g, 700 g, 800 g, 900 g, 1 kg, 1.1 kg, 1.2, kg, 1.3 kg, 1.4 kg, 1.45 kg, 1.5 kg, 1.55 kg, 1.6 kg, 1.65 kg, 1.7 kg, 1.75 kg, 1.8 kg, 1.85 kg, 1.9 kg, 2 kg, 2.2 kg, 2.5 kg, 3 kg, 3.5 kg, 4 kg, 4.5 kg, 5 kg, 6 kg, 7 kg, 8 kg, 9 kg, or 10 kg. The battery pack may weigh more than any of the values described herein. The battery pack may have a weight falling within a range between any two of the values described herein.

Any of the dimensions or characteristics of the battery pack as described herein may be provided separately or in combination with one another. For example, any of the dimensions, footprints, volumes, and/or weights may be combined with one another and/or with any voltage, current, power, capacity, charging time and/or working duration described herein. The battery pack may have any characteristics described herein while being configured to deliver power to a device for conducting nucleic acid amplification having any of the characteristics and/or components described herein, alone or in combination.

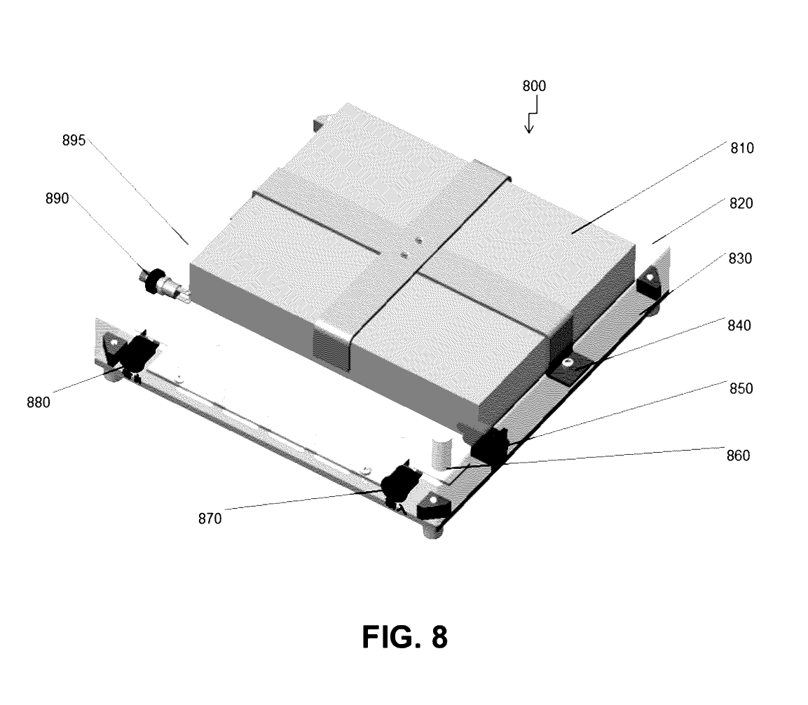

FIG. 8 shows an internal view of a battery pack in accordance with an embodiment of the present disclosure. The battery pack 800 may include one or more batteries 810. Any number or types of batteries may be used as described elsewhere herein. The batteries may be located within a case 820 of the battery pack. The case may partially or completely enclose one or more components therein. The case may substantially isolate components within its interior from the exterior of the battery pack. The case may have any dimensions as described for a battery pack elsewhere herein. The battery pack may have a bottom panel 830. The bottom panel may support one or more components of the battery pack. The bottom panel may optionally form a bottom surface of the battery pack. The bottom panel may be integrally formed with the case or may be a separate piece from the case. The bottom panel may be removable from the case. The bottom panel may be removable to provide a user access to the interior of the battery pack. This may enable the user to swap one or more components of the battery pack (e.g., replacing new batteries or circuits).

The battery pack may include a locking beam 840 that may function as a battery holder. The locking beam may keep the one or more batteries 810 in place. The locking beam may be secured to a bottom panel 830 of the battery. The locking beam may prevent the batteries from moving in three dimensions.

In some instances a switch 850 may be provided. In some instances, the switch may be a power switch for the battery pack. The switch illustrated 850 in FIG. 8 can be the internal portion of switch 772, namely the battery pack switch, used to turn the battery pack on or off. In alternative embodiments, the switch may be used for a battery capacity monitor light power switch. For example, the switch may be turned on to show the remaining level of charge for the battery.

A control panel 860 may be provided within the interior of the battery case 820. The control panel may include circuitry that may control charging and/or discharging of the battery. The control panel may include circuitry for overcharge protection or over-discharge protection. The control panel may regulate the discharging of the battery.

The battery pack may include a power input 870 and a power output 880. In some instances, the power input and output may be accessible from outside the case. The power input and output may include a port, orifice, or jack that may be provided on a surface of the case. A low voltage power input, such as 12 V may be provided into the power input, and a low voltage power output, such as 12 V may come out of the power output.

The battery case may also include a battery capacity switch 890. The battery capacity switch may be used to show the level of charge of the battery. The switch illustrated 890 can be the internal portion of switch 770, namely the battery capacity switch. Pressing the switch may show the battery capacity.

A battery gauge indicator 895 may be provided on the battery pack. The battery gauge indicator may show a level of charge for the battery pack. The battery gauge indicator may be in electrical communication with the battery and/or a circuit associated with the battery. The battery gauge indicator may have any characteristics as described elsewhere herein.

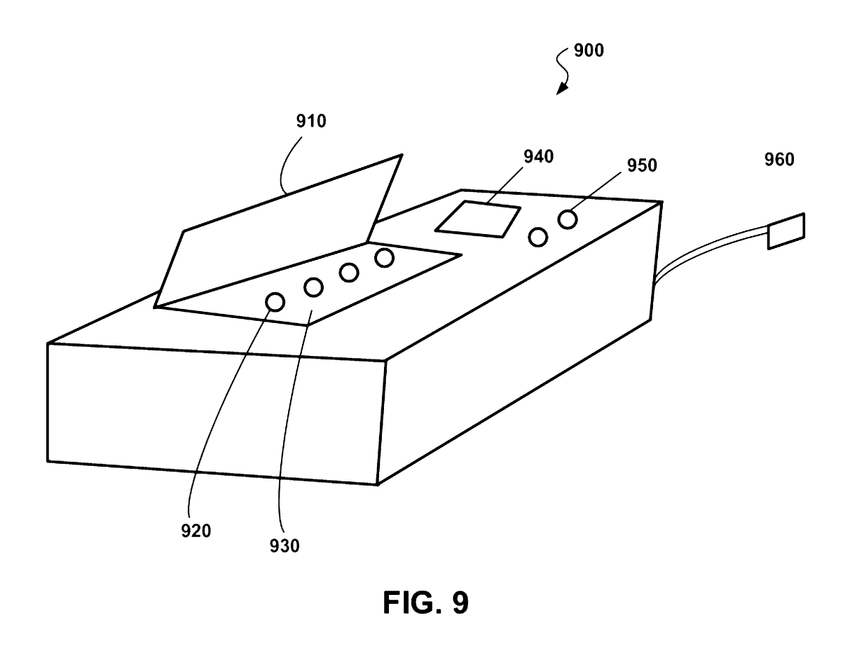

FIG. 9 shows an example of a device for conducting a nucleic acid amplification reaction in accordance with an embodiment of the present disclosure. The device 900 may have a housing that may enclose one or more components of the device. A battery pack may be enclosed within the housing, on an exterior surface of the housing, or may be separate from the rest of the device.

The device may optionally have a lid 910. The lid may open to provide access to a support 930 which may be capable of receiving one or more samples 920. In some instances, the lid may be capable of moving between an open position and a closed position. During the closed position, the samples may be entirely enclosed within the housing. The lid may lie flat over the samples while in the closed position. The lid may optionally form a portion of the housing. The samples may not be removed or added to the device when the lid is in the closed position. During the open position, the samples or samples containers may be exposed to the ambient environment. Samples may be removed or added to the device when the lid is in the opened position.

The support 930 may be used to heat and/or cool the samples. The support may alternatingly heat and cool the samples in accordance with a temperature profile having one or more thermal cycles. The temperature may be any temperature profile, including those described elsewhere herein.

The temperature control may be provided in accordance with pre-programmed instructions. In some instances, the temperature control may be provided in accordance with non-transitory computer readable media comprising code, logic, or instructions to perform the steps for the temperature control. In one aspect, a computer readable medium may comprise machine executable code that, upon execution by one or more computer processors, implements a method of amplifying a target ribonucleic acid (RNA) present in a biological sample obtained from a subject, the method comprising: (a) providing a reaction vessel comprising the biological sample and reagents necessary for conducting nucleic acid amplification, the reagents comprising (i) a DNA polymerase and optionally a reverse transcriptase, and (ii) a primer set for the target nucleic acid, to obtain a reaction mixture; and (b) subjecting the reaction mixture in the reaction vessel to a plurality of series of primer extension reactions to generate amplified product from the target nucleic acid, each series comprising two or more cycles of (i) incubating the reaction mixture under a denaturing condition characterized by a denaturing temperature and a denaturing duration, followed by (ii) incubating the reaction mixture under an elongation condition characterized by an elongation temperature and an elongation duration, wherein an individual series differs from at least one other individual series of the plurality with respect to the denaturing condition and/or the elongation condition.

Computer readable medium may take many forms, including but not limited to, a tangible (or non-transitory) storage medium, a carrier wave medium, or physical transmission medium. Non-volatile storage media include, for example, optical or magnetic disks, such as any of the storage devices in any computer(s) or the like, such as may be used to implement the calculation steps, processing steps, etc. Volatile storage media include dynamic memory, such as main memory of a computer. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution

Optionally a detector may be provided for the device. The detector may optionally be provided within a housing of the device. The detector may be capable of detecting optical signals from the samples. The detector may be capable of detecting optical signals while the lid is closed. The detector may be capable of detecting optical signals while the samples or sample containers are not exposed to an exterior of the device. The detectors may be capable of detecting optical signals while it is not possible to remove or add samples to the device. The detector may be capable of detecting optical signals while the support is heating and cooling the samples. The detector may be capable of detecting optical signals while nucleic acid amplification is occurring within the sample. Detection may occur in accordance with non-transitory computer readable media.

The device may include a display 940 in some embodiments of the present disclosure. The display may include information about operation of the device and/or status of the operation of the device. The display may or may not include information about the progress of the nucleic acid amplification. In some instances, the display may include some information generated based on information received from a detector. This may include real-time information from the detector during the nucleic acid amplification.

One or more controls 950 may be provided. The one or more controls may permit a user to control the device. The controls may be separate from a display or may be integrated into a display. For example, the display may include a touchscreen that may be capable of both displaying information and accepting user input. The controls may accept tactile input, verbal input, and/or visual input (e.g., motions or gestures). The controls may accept a user input to turn the device on or off. The controls may accept user input to initiate a thermal cycling mode or select a thermal cycling mode from a plurality of options. The user may specify details relating to the thermal cycling modes. The user may provide input about detection of the nucleic acid amplification. The user may provide input about display and or transmittal of data resulting from detection of nucleic acid amplification. The user may or may not put information about different energy modes and/or energy storage modes. Display and/or control of the device may occur in accordance with non-transitory computer readable media.

The device may include a power connector 960. The power connector may be used to connect the device to a power source. The power source may be an on-grid power source or off-grid power source. The power source may be a vehicle, such as a passenger vehicle. The power source may be an energy storage device, such as a battery pack described elsewhere herein. The power connector may include a plug, pin, prongs, or other form of electrical connector. The power connector may be capable of receiving a low voltage amount to power the device. In some examples, the low voltage amount may be 12 V or less, or any other voltage amount described elsewhere herein.

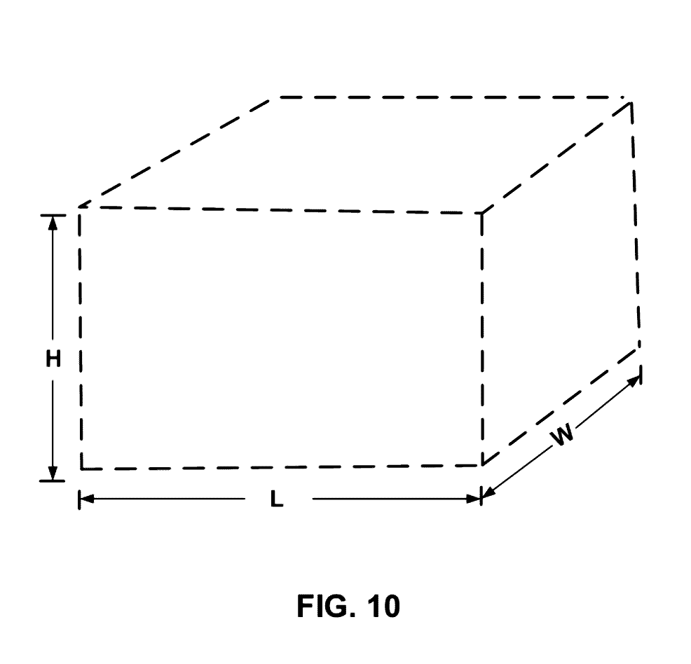

FIG. 10 shows an example of dimensions within which a device for conducting nucleic acid amplification may fall, in accordance with an embodiment of the present disclosure. The device may be a portable device. The device may be capable of being lifted and carried by a human. The device may be capable of being lifted and carried by a human with one hand. The portable device may be capable of being transported via a passenger vehicle. A portable device may be desirable to deploy the device to various locations. The portable device may permit point of care (POC) nucleic acid amplification. This may permit individuals in remote areas to get faster results, which can be useful for disease prognosis and treatment.

The device may have a length L, height H, and/or width W. The device may have any shape. For example, the device may have substantially rectangular prismatic shape, rounded shape, triangular shape, hexagonal shape, cylindrical shape or any other shape. The device may fit within the dimensions illustrated even if the shape of the device does not cause the device to fill in the whole dimensions. The length may refer to the greatest lateral dimension of the device. The height may refer to the distance between the bottom and the highest point of the device. The width may refer to the dimension of the device in a direction orthogonal to the length. Any description herein of a dimension of the device may also refer to a dimension of a housing that may at least partially enclose one or more components of the device.

The device may have a maximum dimension (e.g., length, width, height, diagonal, diameter) of no more than about 15 cm. In some instances, the device may have a housing no more than 10 cm tall. In another example, the device may have a housing no more than 16 cm in length. The device may have a maximum dimension of no more than about 1 mm, 3 mm, 5 mm, 7 m, 10 mm, 12 mm, 15 mm, 17 mm, 20 mm, 25 mm, 30 mm, 40 mm, 50 mm, 60 mm, 70 mm, 75 mm, 80 mm, 85 mm, 90 mm, 97 mm, 100 mm, 105 mm, 110 mm, 120 mm, 130 mm, 140 mm, 150 mm, 160 mm, 170 mm, 180 mm, 190 mm, 200 mm, 210 mm, 220 mm, 230 mm, 240 mm, 250 mm, 270 mm, 300 mm, 350 mm, 400 mm, 450 mm, 500 mm, 550 mm, 600 mm, 700 mm, or 1 m. Alternatively, the device may have a maximum dimension greater than any of the dimension values described herein. In some instances, the device may have a maximum dimension falling within a range between any two of the values described herein.

Any footprint may be provided for the device. The footprint may include a lateral cross-sectional area of the device. The footprint may include an area of a surface that the device would occupy when resting on the surface. In some instances, the device may have a footprint of less than or equal to about 1 cm², 5 cm², 10 cm², 15 cm², 20 cm², 25 cm², 30 cm², 40 cm², 50 cm², 60 cm², 70 cm², 80 cm², 90 cm², 100 cm², 120 cm², 150 cm², 200 cm², 250 cm², 300 cm², 350 cm², 400 cm², 500 cm², 600 cm², 700 cm², 800 cm², 900 cm², 1000 cm², 1200 cm², 1500 cm², 1700 cm², or 2000 cm². The device may have a footprint greater than or equal to any of the values described herein. The device may have a footprint falling into a range between any two of the values described herein.

The device may have any volume. In some instances, the battery may have a volume of less than about 1 cm³, 5 cm³, 10 cm³, 15 cm³, 20 cm³, 25 cm³, 30 cm³, 40 cm³, 50 cm³, 60 cm³, 70 cm³, 80 cm³, 90 cm³, 100 cm³, 120 cm³, 150 cm³, 200 cm³, 250 cm³, 300 cm³, 350 cm³, 400 cm³, 500 cm³, 600 cm³, 700 cm³, 800 cm³, 900 cm³, 1000 cm³, 1200 cm³, 1500 cm³, 1700 cm³, 2000 cm³, 2200 cm³, 2500 cm³, 3000 cm³, 3500 cm³, 4000 cm³, 4500 cm³, 5000 cm³, 5500 cm³, 6000 cm³, 7000 cm³, 8000 cm³, 9000 cm³, or 10,000 cm³. The device may have a volume greater than any of the volumes described herein. The device may have a volume falling within a range between any two of the values described herein.

The device may have any weight. For example, the device may weigh less than or equal to about 2 kg. The device may weigh less than or equal to about 1 mg, 10 mg, 100 mg, 1 g, 10 g, 100 g, 200 g, 300 g, 400 g, 500 g, 600 g, 700 g, 800 g, 900 g, 1 kg, 1.1 kg, 1.2, kg, 1.3 kg, 1.4 kg, 1.45 kg, 1.5 kg, 1.55 kg, 1.6 kg, 1.65 kg, 1.7 kg, 1.75 kg, 1.8 kg, 1.85 kg, 1.9 kg, 2 kg, 2.1 kg, 2.2 kg, 2.5 kg, 2.7 kg, 3 kg, 3.5 kg, 4 kg, 4.5 kg, 5 kg, 6 kg, 7 kg, 8 kg, 9 kg, or 10 kg. The device may weigh more than any of the values described herein. The device may have a weight falling within a range between any two of the values described herein.

Any of the dimensions or characteristics of the device as described herein may be provided separately or in combination with one another. For example, any of the dimensions, footprints, volumes, and/or weights may be combined with one another and/or with any voltage, current, power, described herein. The device may have any characteristics described herein while being configured to conduct nucleic acid amplification and/or real-time detection of the nucleic acid amplification. The device may be a portable device having any of the dimensions described herein while being able to operate at low voltage power. This may advantageously take full advantage of the device's portability, not only in size but ability to be powered from a wider range of power sources and/or have longer battery life.

The device may be configured to accept any number of samples. For example, the device may include any number of indentations, such as those described elsewhere herein. The device may have any number of indentations as described while having any of the dimensions provided. In one example, the device may have 8 indentations. The device may weigh no more than 0.5 kg, 0.4 kg, 0.3 kg, 0.25 kg, 0.2 kg, 0.15 kg, 0.12 kg, or 0.1 kg per indentation. The device may have a footprint of no more than about 500 cm², 300 cm², 200 cm², 150 cm², 100 cm², 70 cm², 60 cm², 50 cm², 40 cm², 30 cm², 20 cm², 10 cm², 5 cm², 1 cm², 100 mm², 10 mm², or 1 mm² per indentation.

The device may be configured to operate using less than or equal to about 25 W, 20 W, 17 W, 15 W, 14 W, 13 W, 12 W, 11 W, 10 W, 9 W, 8 W, 7 W, 6 W, 5 W, 4 W, 3 W, 2 W, 1 W, 500 mW, 100 mW, 50 mW, 10 mW, 5 mW, or 1 mW per indentation.

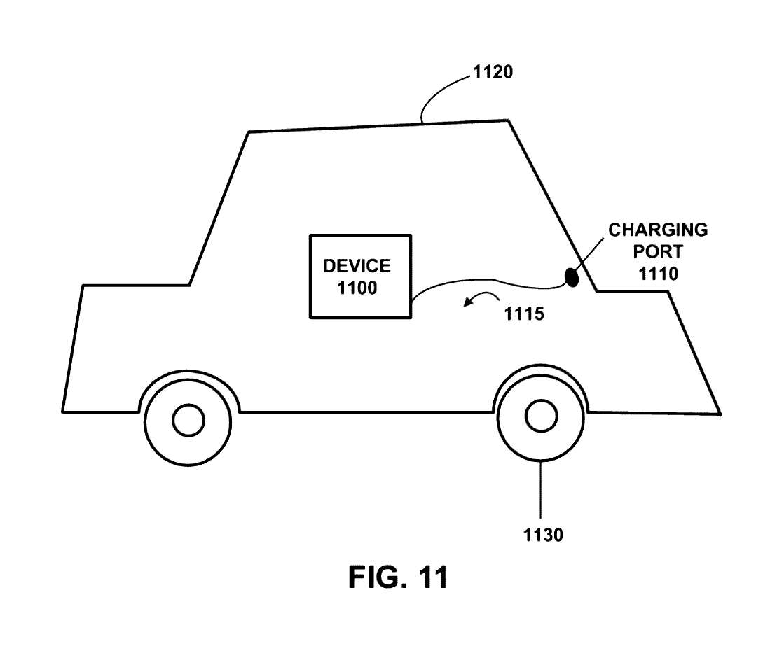

FIG. 11 shows an example of a device being powered by a vehicle in accordance with an embodiment of the present disclosure. A device 1100 may be electrically connected to a charging port 1100 of a vehicle 1120. Electrical energy may flow 1115 from the charging port to the device. The vehicle may be a self-propelled vehicle having one or more propulsion unit 1130.

The device 1100 may be a portable device capable of conducing nucleic acid amplification. The device may be useful for real-time PCR. The device may be capable of operating using low voltage of power. The device may be capable of operating using less than 12 V of power, or any other voltage of power described elsewhere herein. The device may be capable of fitting within a vehicle 1120. The device may be capable of fitting onto a seat of a vehicle. The device may be capable of resting on a lap of an individual sitting within a vehicle.

The vehicle 1120 may be a passenger vehicle. The vehicle may be sedan, hatchback, station wagon, truck, SUV, mini-van, van, jeep, tank, or any other type of automotive vehicle capable of self-propulsion. In some instances, the vehicle may be an airplane, helicopter, train, monorail, subway, boat, ship, or any other type of vehicle. The vehicle may be propelled with aid of an internal combustion engine. The vehicle may be propelled with aid of an electric motor. The vehicle may have a vehicle battery that may power one or more component of the vehicle. The vehicle may be capable of fitting about two, three, four, five, six or more people therein. The vehicle may include one or more propulsion units, such as wheels 1130 that may permit the vehicle to move in an environment.

The vehicle may have a charging port 1110 thereon. The charging port may be in an interior of the vehicle. The charging port may be may be a cigarette lighter receptacle for an automobile. The charging port may be a DC power source. The charging port may be a 12 V receptacle. The charging port may include a socket configured to receive a charging connector. The charging port may be a 12 V auxiliary power outlet of the vehicle. In some instances, the charging port may be a 5 V outlet. The charging port may be a USB standard 5 V outlet. The charging port may provide any low voltage value, such as those described elsewhere herein.

The charging port may be provided in accordance with ANSI/SAE J563 specifications. In some instances, there may be a contact point which may be a center part of the plug, and may carry a positive voltage. A “can” part may also be provided, which may be an outer part of a connector and configured to carry negative voltage. Optionally, the charging port may have a receptacle inner diameter falling between 15-25 mm, or 20-22 mm. In some instances, the receptacle inner diameter may fall within 21.34-21.46 mm, 20.93-21.01 mm, or 21.41-21.51 mm. In some instances, a pilot light may be provided that may indicate when a connection has been made between a power connector and a charging port. In some instances, the charging port may be provided at a front of a vehicle. Alternatively, the charging port may be located anywhere throughout a vehicle.

The charging port may provide power that may originate from a battery of a vehicle. A device electrically connected to a charging port may be powered by a battery of a vehicle. The battery of a vehicle may be a car battery or any type of automotive battery. The vehicle battery may be a starting, lighting, ignition (SLI) battery. The vehicle battery may be a lead-acid battery. Optionally, the vehicle battery may include six galvanic cells that may deliver a total of about 12 V or less. In some instances, a vehicle may have multiple automotive batteries that may deliver a total of about 24 V or less. In some instances, a vehicle may have one or more automotive batteries that may deliver a total of about 48 V or less.

When a power connector of the device 1100 is connected to the charging port 1110 power may flow 1115 from the charging port of the vehicle to the device. The power may flow when the vehicle is operational. The vehicle may or may not be in motion while the vehicle is in operation. The vehicle may be operational when it is powered on and/or the engine is running. The vehicle may be in operation when the vehicle's ignition is not completely turned off. The vehicle may be in operation when one or more wheels of the vehicle are turning. The vehicle may be in operation when the vehicle is in parking mode with the ignition on. The vehicle may be in operation if the vehicle headlights or radio may be turned on. Power may or may not flow to the device when the vehicle is not in operation.

The power may be used to directly operate the device. The power may be used to charge an energy storage unit. The energy storage unit may be used to operate the device. In some instances, one or more set of protocols may be used to govern whether the power flowing to the device is used to directly operate the device or charge an energy storage device that may be used to power the device. In some instances, both actions may simultaneously occur.

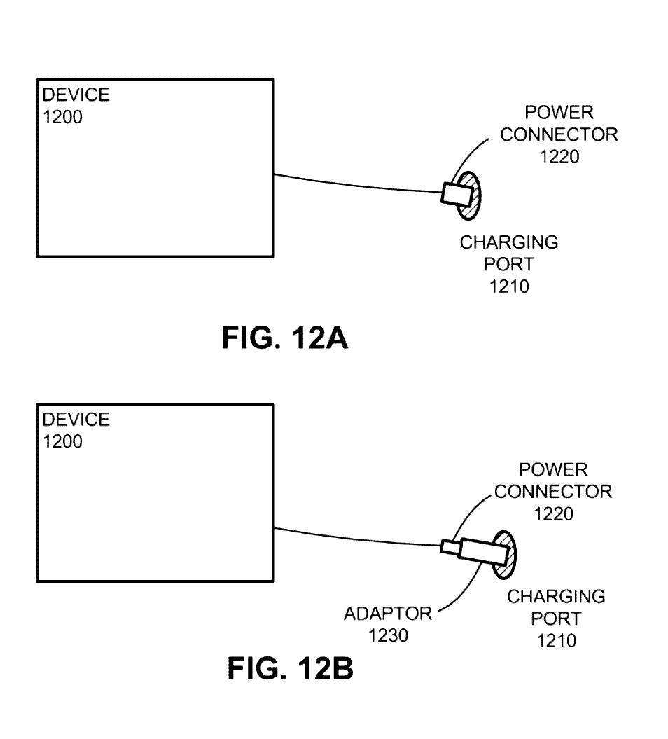

FIG. 12A shows an example of a connection between a device and a charging port in accordance with an embodiment of the present disclosure. The device 1200 may be connected to a charging port 1210 via a power connector 1220. The power connector may include a plug that may fit into the charging port. The device may come equipped with a power connector that may be configured to directly connect to the charging port. The power connector may include one or more prongs, pins, indentations, or conductive surfaces.

The charging port may be capable of providing low voltage power to the device to permit operation of the device. The charging port may be on-board the vehicle. The charging port may be any off-grid charging port. The charging port may be powered by a vehicle battery. The charging port may be any other type of charging port electrically connected to any type of external power source as described elsewhere herein.

FIG. 12B shows an example of a connection between a device and a charging point via an adaptor in accordance with an embodiment of the present disclosure. The device 1200 may be connected to a charging port 1210 via a power connector 1220 and an adaptor 1230. The power connector may not directly fit into the charging port, or may not be configured to regulate the power coming from the charging port for operation of the vehicle. The adaptor may provide one or more of these functions. The adaptor may be provided between the power connector of the device and the charging port.

The adaptor may be configured to physically fit into the charging port. The adaptor may be configured to mechanically and/or electrically connect to the charging port. The power connector may be not be capable of directly mechanically and/or electrically connecting to the charging port. In some instances, the adaptor may or may not provide some power regulation or conversion when providing power to the power connector. For example, the adaptor may convert DC to AC. In another example, the adaptor may modify or regulate voltage and/or current from the charging port to the power connector.

Any description herein of connecting the device to the charging port may or may not include the use of one or more adaptors.

A nucleic acid amplification device may be deployed with aid of one or more vehicles. The nucleic acid amplification device may be a portable device that can be carried within a vehicle. The vehicle may provide power to the nucleic acid amplification device at a low voltage power, such as 12 V or other voltage values described elsewhere herein. The power provided to the device may be used to charge an energy storage unit of the device and/or directly power one or more other component of the device. The power may be provided to the device via a charging port while the vehicle is turned on. The power may be provided to the device while the vehicle is stationary or while the vehicle is in motion. The device may thus advantageously be deployed to multiple locations. These may include remote locations that may otherwise not have the power sources capable of powering the device. These may include remote locations where rolling blackouts may occur so reliable access to power may not be provided.

The nucleic acid amplification device may receive a sample a location. The device may conduct nucleic acid amplification at the location or while the device is in transit to another location. The nucleic acid amplification device may receive the sample while the device is outside the vehicle, or may receive the sample while the device is within the vehicle. The device may receive the sample while the vehicle is stationary or in motion.

The device may be connected to a charging port of the vehicle while it is in operation. Alternatively, the device may be disconnected from a charging port of the vehicle while it is in operation. The device may have an energy storage unit that may store energy while the device is connected to the vehicle. When the device is disconnected from the vehicle, the energy storage unit may be used to power the device. This may permit the device to be charged while in transit to a location. The device may then be taken out of the vehicle and used to conduct nucleic acid amplifications at the location using the stored energy. If the device depletes the charge of the energy storage unit, the device may be re-connected to the vehicle to power the device and/or charge the energy storage unit. Thus, as long as a vehicle is available, a ready power source may be provided for the device. This may advantageously couple transport of a device to a remote location with powering the device at any location to which it has been transported.

Any description herein of a vehicle may also apply to any other type of power source, such as those described elsewhere herein.

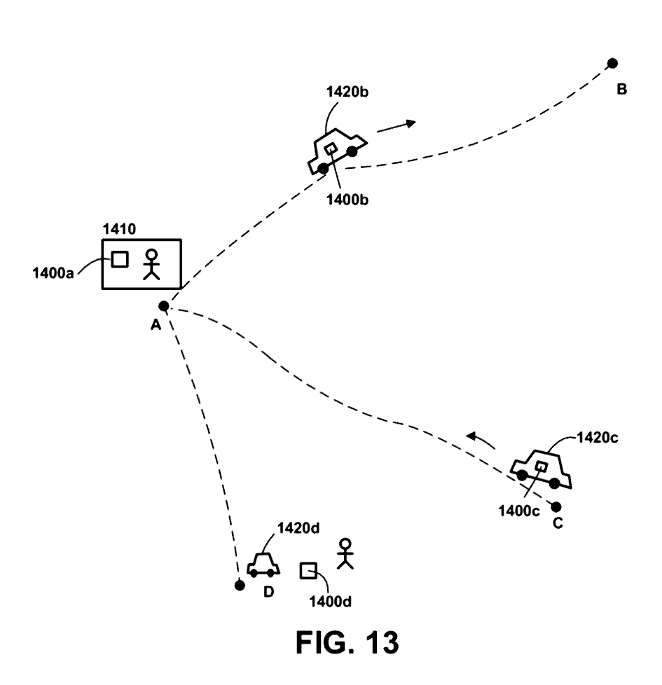

FIG. 13 shows an example of a method of deploying a device in accordance with an embodiment of the present disclosure. One or more different locations A, B, C, D may be provided. The locations may or may not be remote from one another. Infrastructure such as roads (or paved roads) may or may not exist between the various locations.

In one or more of the locations A, a facility 1410 may be provided. The facility may have a structure, such as one or more walls and/or a ceiling. The facility may or may not be a laboratory facility deigned to conduct analysis of biological samples. The facility may or may not be powered by an external power source. The facility may or may not be powered by-the-grid (e.g., via a power utility). In some instances, a device 1400a useful for conducting nucleic acid amplification may be provided at the facility. The device may be powered through the facility. A power source of the facility may be used to power the device. This may or may not be a low voltage power source. A user may be provided to operate the device.

In some instances, samples may be provided from subjects that are in the proximity of the device. For example, samples from subjects at or near location A may be provided. In other instances, samples may be provided from subjects that are at other locations. The remote samples may be sent from the other locations to the facility. In some instances, this may delay results getting back to the subjects or individuals at the other locations.

A vehicle 1420b may be sent to another location B. The vehicle may have a device 1400b for conducting nucleic acid amplification. The device may optionally be electrically connected to the vehicle while the vehicle is in operation. The device may be powered and/or charged by the vehicle when the vehicle is in operation. The device may be powered and/or charged by the vehicle while the vehicle is in motion (e.g., from location A to location B). Permitting a device to be charged while the vehicle is in transit may permit the device to be at a substantially charged state when the device arrives at the destination B. In some instances, the device may be used at the destination to perform nucleic acid amplification at the location. The device may be powered by the vehicle at the location. For example, a car or other type of vehicle may be turned on and used to power a device while the device is running the nucleic acid amplification at the location. Alternatively, the device may operate at the location using an energy storage device that has already been charged. The energy storage device may have been charged while the device was in transit. Charging the device while the device is in transmit may advantageously provide greater flexibility that may allow the vehicle to transported from one location to another. The locations need not have grid power sources, or the use of the device need not rely on grid power sources. Furthermore, the device may be charged to a ready-to-use state while in transit which may save time when the device arrives at a destination.

In some instances, one or more subjects may provide a sample at a destination B. The nucleic acid amplification may occur at the destination. POC testing may permit the results to be provided at the destination. In some instances, real-time PCR or detection may occur, which may permit results to provided in real-time or instantaneously to subjects at the location. This may permit the nucleic acid amplification device to be brought to otherwise remote locations and allow testing that may provide much faster results than other situations. This may be advantageous for disease prognosis and/or treatment. This may also aid in the detection and prevention of spreading infectious diseases.

In some instances, the testing may occur at the destination location. In some instances, the samples may be collected and/or loaded into the device at the destination location C. The device 1400c may be used to perform nucleic acid amplification on the sample at the destination location. The results may be delivered at the destination location. In other implementations, a vehicle 1420c may receive the device and depart the destination location. The vehicle may be on its way to another location A, such as a lab or facility. The device may be capable of performing nucleic acid amplification in the vehicle while the vehicle is in operation. The device may be capable of performing nucleic acid amplification while the vehicle is in transit. The device may be powered by the vehicle to perform the nucleic acid amplification. In some instances, after the samples have been loaded into the device at a location C, the vehicle may make its way to another location. The amplification may occur and/or be completed while the vehicle is in transit. This may save time in getting the device to another location where it may be needed. The results may be detected with aid of an on-board detector. The results may be relayed to a user of the device in real-time. The results may be relayed back to the location C from which the samples were collected. In some instances, the results may be relayed to a facility 1410 which may perform additional analysis.

Powering the device using the vehicle, and permitting nucleic acid amplification and detection while the device is in the vehicle en route may provide greater flexibility and time saving measures. The vehicle transit time may be used, rather than being ‘down time.’ This may aid in maximizing or improving the use of the device when the device is deployed to different locations.

In some instances, a device 1400d may be transported to a destination D with aid of a vehicle 1420d. The vehicle may be capable of being powered and/or charged using the vehicle. The device may be used at the destination. A sample may be collected at the destination from a subject. The device may perform a nucleic acid amplification of the sample at the destination and/or en route from the destination to another location. The device may be powered using the vehicle while performing the nucleic acid amplification. The device may be powered using another power source while performing the nucleic acid amplification. For example, the other power source may be another off-grid power source, or an on-grid power source. In some instances, the device may be powered using an energy storage device while performing the nucleic acid amplification. The energy storage device may have been charged using the vehicle or another source. The device may perform nucleic acid amplification within a vehicle. The vehicle may be in operation while the nucleic acid amplification is occurring. The vehicle may or may not be in transit while the nucleic acid amplification is occurring. Real-time detection may be occurring while the nucleic acid amplification is occurring.

Any of the devices 1400a, 1400b, 1400c, 1400d may have any characteristics of the devices as described elsewhere herein. For example, any of the devices may include a thermal cycler and a detector. The detector may be capable of performing real-time monitoring of the nucleic acid amplification. The device may be capable of operating on low voltage power. For example, the devices may be capable of operating at 12 V or less, or any other voltage level described elsewhere herein.

In some embodiments, a carrying container may be provided for the devices described elsewhere herein. For example, the carrying container may be a suitcase or any other type of container. The carrying container may be configured to hold one, two, three, four, five, six, seven, eight or more nucleic acid amplification devices. The carrying container may be capable of being lifted by a human being. The carrying container may be capable of being carried by a human being using one hand. In some instances, the carrying container may be a suitcase with one or two handles. A human being may be able to lift a suitcase by holding a handle. In other implementations, any number of handles may be provided.

The carrying container may have any dimensions. In some instances, one or more of a length, width, height, diagonal, and/or diameter of a carrying container may be less than or equal to about 1 cm, 5 cm, 10 cm, 15 cm, 20 cm, 25 cm, 30 cm, 35 cm, 40 cm, 45 cm, 50 cm, 55 cm, 60 cm, 65 cm, 70 cm, 75 cm, 80 cm, 85 cm, 90 cm, 95 cm, 100 cm, 110 cm, 120 cm, or 150 cm. Alternatively, one or more dimensions of the carrying container may be greater than or equal to any of the dimensions described herein. One or more dimensions of the carrying container may fall into a range between any two of the values described herein.

The carrying container may enclose one or more of the devices. In some instances, the devices may be partially or entirely enclosed within the carrying container. The carrying container may optionally have one or more compartments into which the devices may be inserted. For example, a plurality of devices or other components may be carried within a suitcase. The suitcase may have multiple compartments that may partially or completely isolate the devices or other components from one another. For example, separate compartments may be provided for one or more nucleic acid amplification devices. The compartments may be sized and/or shaped to accommodate the nucleic acid amplification devices and prevent them from moving around.

The carrying container may also hold one or more battery packs therein. The battery packs may include battery packs that can be used to power the nucleic acid amplification devices. The battery packs may be stored within the carrying container with one or more devices. The battery packs and/or devices may be separated from one another. In some instances, one or more compartments may be provided within the suitcase to separate the battery packs from one another and/or from one or more devices. A carrying case may be provided with a compartment for the device and a compartment for the battery pack. Each compartment may be sized and/or shaped to accommodate their respective component. Components may or may not be swappable between different compartments.

In some embodiments, a battery pack may be provided at a bottom portion of the carrying container. The battery pack may be provided along any edge, side, or surface of the carrying container. A plug-in component from a battery pack may be exposed. For example, when the carrying container is closed, the plug-in component from the battery pack may be exposed. Alternatively, plug-in component may be exposed only when the carrying container is opened. A device may be plugged into the plug-in component of the battery pack for the battery pack to be able to power the device. In one example, the device may be removed from the carrying container and then plugged into a battery pack that is also removed from the carrying container. In another example, the device may be removed from the carrying container and plugged into a battery pack that remains within the carrying container (when the carrying container is opened or is closed). In another example, the device and the battery pack may remain within the carrying container and may be electrically connected to one another.

The carrying container may be able to accommodate any other components. For example, the suitcase may hold small equipment for sample processing and sample storage. For example, the suitcase may hold a dry bath and/or a centrifuge. Each of the components may be stored in separate compartments in the suitcase or may be stored together.

In some embodiments, the compartments of the carrying container may be formed from or lined with a resilient material. The material may cushion the components (which may include the device and/or battery back therein) which may help protect the components. The carrying container may be formed from a rigid or hard exterior. Alternatively, the exterior may be resilient or soft.

The carrying container may aid in transport of the device and associated components. The carrying container may enable the device, battery pack, and/or any other components to be easily transported together. Rather than needing to carry and keep track of separate components, the carrying container may simplify transport of the various components. Since the device may be deployed to remote areas, the carrying container may facilitate the transport and help protect the device and components.

### Systems and Methods for Changing Thermal Cycler Parameters During Runtime

In another aspect, the present disclosure provides a system for changing thermal cycler parameters during runtime, such as while conducting a nucleic acid amplification reaction. The system can comprise a thermal cycler and a computer processor coupled to the thermal cycler. The thermal cycler can be configured to (i) receive a reaction mixture comprising a biological sample having a target nucleic acid molecule and reagents necessary to conduct a nucleic acid amplification reaction to generate amplified target nucleic acid molecule(s) as amplification product(s) of the target nucleic acid molecule, and (ii) cycle a temperature of the reaction mixture to perform the nucleic acid amplification reaction to generate the amplified target nucleic acid molecule(s). The computer processor can be programmed to (i) instruct the thermal cycler to begin cycling the temperature at a first number of heating and cooling cycles to perform the nucleic the amplification reaction, (ii) change the first number of heating and cooling cycles to a second number of heating and cooling cycles while the thermal cycler is cycling the temperature, and (iii) instruct the thermal cycler to terminate cycling the temperature upon reaching the second number of heating and cooling cycles.

The system can further comprise a detector that detects a signal from the reaction mixture while the nucleic acid amplification reaction is in progress. The signal may be an optical signal, electrostatic signal, thermal signal, or electrochemical signal. The signal can be indicative of a quantity of the amplified target nucleic acid molecule(s) or rate of change of the quantity. The detector may detect the signal without removing the reaction mixture from the thermal cycler. The system can further comprise a sealed light transmission path that brings the reaction mixture in sensing communication (e.g., optical communication) with the detector, such as with the aid of one or more optical components (e.g., mirrors and/or lenses).

In some examples, the signal is an optical signal. The detector can include one or more sensors that are sensitive to the optical signal. The detector can include at least 1, 2, 3, 4, 5, 6, 7, 8, 9, 10, 100, 500, 1000, or 10000 individual sensors. The individual sensors can be distributed as independent sensors or independent groups of sensors. The independent sensors or groups of sensors can be independently addressable.

The system can have an operating voltage that is less than 240 V or 120 V during the nucleic acid amplification reaction. In some examples, the operating voltage is no more than about 48 V, 24 V, or 12 V during the nucleic acid amplification reaction. The thermal cycler and/or detector can have an operating voltage that is less than or equal to 240 V, 120 V, 48 V, 24 V, or 12 V. The computer processor can have an operating voltage that is less than or equal to 240 V, 120 V, 48 V, 24 V, or 12 V. Such operating voltage can be achieved, for example using a transformer.

The computer processor can be programmed to change the first number of heating and cooling cycles to the second number of heating and cooling cycles when a condition is fulfilled. The condition can be predetermined, such as by an operator of the system. The predetermined condition may be that the optical signal or signal change reaches or exceeds a threshold. The threshold can be predetermined by a user input before or during of the nucleic acid amplification. Alternatively, the threshold may be calculated and determined by the computer processor. The change can be accompanied with an alert or a message to the user. The signal change may be a first or second derivative of the optical signal with time including those described elsewhere herein. The signal change may be a negative first or second derivative of the optical signal with time including those described elsewhere herein.

In some examples, the predetermined condition is that the number of heating and cooling cycle being performed reaches the first cycle number and the optical signal or signal change fails to reach a threshold signal or signal change. In such circumstances, the computer processor is programmed to instruct the thermal cycler to set a second cycle number which is at least one, two, three, four or five above the first cycle number.

The computer processor can be programmed to change the first number of heating and cooling cycles to the second number of heating and cooling cycles upon input received from a user. The input can be received manually or automatically, such as upon a given condition being met. The system can include an input module that receives the input from the user. Any suitable module capable of accepting such a user request may be used as the input module. Furthermore, the input module may be any suitable input module including examples described elsewhere herein. The input module may receive the user request directly (e.g., by way of an input device such as a keyboard, mouse, or touch screen on an electronic device operated by the user) or indirectly (e.g., through a wired or wireless connection, including over a network). Via output electronics, the input module may provide the user's request to the computer processor. An input module may include a user interface (UI), such as a graphical user interface (GUI), that is configured to enable a user provide a request to amplify the target nucleic acid. A GUI can include textual, graphical and/or audio elements. A GUI can be provided on an electronic display, including the display of a device comprising a computer processor.

The input can be received from an electronic display operatively coupled to the computer processor. The electronic display may be, e.g., an electronic display screen, such as a monitor, a television, a screen operatively linked with a unit used to obtain the amplified product, a tablet computer screen, a mobile device screen, and the like. The electronic display screen may be any suitable electronic display including examples described elsewhere herein. Non-limiting examples of electronic display screens include a monitor, a mobile device screen, a laptop computer screen, a television, a portable video game system screen and a calculator screen. The electronic display screen may include a touch screen (e.g., a capacitive or resistive touch screen) such that graphical elements displayed on a user interface of the electronic display screen can be selected via user touch or gesture with the electronic display screen.

The electronic display may comprises a user interface with graphical and/or textual elements corresponding to the first number of heating and cooling cycles and the second number of heating and cooling cycles. The graphical and/or textual element can be displayed in a manner that permits thermal cycling parameters to be viewed and updated.

The graphical and/or textual elements corresponding to the first number of heating and cooling cycles and the second number of heating and cooling cycles may be images, picture, texts, icons and the like. The graphical and/or textual elements may display a number indicating the total number of heating and cooling cycles in the protocol to be performed, being performed, or having been performed. Upon an input to change the first number of heating and cooling cycles to the second number of heating and cooling cycles, the displayed number can be changed from a first cycle number which indicates the number of cycles in the first number of heating and cooling cycles (hereinafter the “first cycle number”) to a second cycle number which indicates the number of cycles in the second number of heating and cooling cycles (hereinafter the second cycle number). The input may be a user input. The input may be generated automatically by the computer processor.

Alternatively, the graphical and/or textual elements may display a first number indicating the remaining number of heating and cooling cycles in the protocol (hereinafter the “first remaining cycle number”). In this case, upon user input, the displayed first remaining cycle number can be changed to a smaller or larger number corresponding to the second number indicating the remaining number of heating and cooling cycles (hereinafter the “second remaining cycle number”).

The graphical and/or textual elements corresponding to the first number of heating and cooling cycles and the second number of heating and cooling cycles as described herein may be accessible by the user via an input module to change from the first cycle number to the second cycle number, or from the first remaining cycle number to the second remaining cycle number. The user can directly select the graphical and/or textual elements corresponding to the first number of heating and cooling cycles and the second number of heating and cooling cycles as described herein to enter the second cycle number or the second remaining cycle number to effect the aforesaid change.

The user interface may additionally or alternatively comprise a graphical and/or textual element for increasing the number of heating and cooling cycles and a graphical and/or textual element for decreasing the number of heating and cooling cycles. The graphical and/or textual element for increasing the number of heating and cooling cycles may be accessible by the user to effect an increase of the number of the heating and cooling cycles to the second cycle number. The graphical and/or textual element for decreasing the number of heating and cooling cycles may be accessible by the user to effect a decrease of the number of the heating and cooling cycles to the second cycle number. The graphical and/or textual element for increasing the number of heating and cooling cycles may be accessible by the user to effect an increase of the remaining number of heating and cooling cycles to the second remaining cycle number. The graphical and/or textual element for decreasing the number of heating and cooling cycles may be accessible by the user to effect a decrease of the remaining number of heating and cooling cycles to the second remaining cycle number. The graphical and/or textual element for increasing the number of heating and cooling cycles and the graphical and/or textual element for decreasing the number of heating and cooling cycles may be a single element, wherein different input from the user determines whether an increase or decrease of number of heating and cooling cycles or the remaining number of heating and cooling cycles is effected.

If the second cycle number is set by the user input to be smaller than the number of heating and cooling cycles being performed, the second cycle number can be reset to the number of heating and cooling cycles being performed, in some cases accompanied with an alert or an error message to the user. Additionally or alternatively, if the second cycle number is set by the user input to be smaller than the number of heating and cooling cycles being performed, the nucleic acid amplification can be terminated or halted, in some cases accompanied with an alert or an error message to the user. Additionally or alternatively, if the second cycle number is set by the user input to be smaller than the number of heating and cooling cycles being performed, the nucleic acid amplification can be changed back to the first cycle number, in some cases accompanied with an alert or an error message to the user. Additionally or alternatively, if the second cycle number is set by the user input to be smaller than the number of heating and cooling cycles being performed, the user may be prompted by a graphical and/or textual element to choose between or among at least two options which include, without being limited to, resetting the second cycle number to the number of heating and cooling cycles being performed, terminating or halting the nucleic acid amplification, or changing the second cycle number back to the first cycle number.

The user interface may comprise graphical and/or textual elements corresponding to a progress of the nucleic acid amplification reaction with time. The progress may be indicative of a degree of completion of amplification, as may be determined, for example, by a measured signal or signal change.

The user interface may comprise graphical and/or textual elements corresponding to the heating and cooling cycle being performed. The user interface may comprise graphical and/or textual elements showing the parameters of the heating and cooling cycle. The parameters include but are not limited to the heating temperature, the duration of the heating, the cooling temperature, the duration of the cooling, the annealing temperature, the duration of the annealing, the denaturing temperature, the duration of the denaturing, the DNA synthesis temperature, the duration of the DNA synthesis, and the like. The user interface may further comprise a graphical and/or textual element for indicating a present stage of the heating and cooling cycle of nucleic acid amplification. The graphical and/or textual elements showing the parameters of the heating and cooling cycle are accessible by a user to effect a change of any the aforesaid parameters during the progression of the nucleic acid amplification.

The thermal cycler and the detector may be included in a housing. The housing may have a height and/or length of no more than about 15 cm. In some embodiments, the housing has a greatest dimension of no more than about 15 cm. In some embodiments, the housing having the thermal cycler and the detector has a weight of no more than about 2 kg.

The housing may be formed of a metallic material (e.g., aluminum), polymeric material (e.g., plastic), a composite material, or a combination thereof. The housing may be constructed of a single piece or multiple pieces.

The thermal cycler and computer processor can be in the same housing or different housings. In some examples, the thermal cycler is in a first housing and the computer processor is in a separate housing, such as a separate housing or an electronic device of a user (e.g., portable computer or Smartphone).

The thermal cycler may comprise a heating element that heats the reaction mixture to increase the temperature. The heating element may be a resistive heater, radiative heater, thermal heater (e.g., combustion heater), or thermoelectric device, for example. The thermal cycler may comprise a cooling element that cools the reaction mixture. The cooling element may be a convective cooler (e.g., fan) or a cooling block, for example. The heating element may be a heating block having a plurality of indentations, wherein each of the plurality of indentations is dimensioned to accept a sample container having the biological sample and/or reagents.

The weight of the system per indentation may be no more than 0.2 kg. The plurality of indentations may be dimensioned to hold the sample container having a height of no more than 21 mm.

The first number of heating and cooling cycles may include an initial heating phase followed by an initial cooling phase. The first number of heating and cooling cycles may include an initial cooling phase followed by an initial heating phase. The second number of heating and cooling cycles may include a final heating phase followed by a final cooling phase. The first number of heating and cooling cycles may include a final cooling phase followed by a final heating phase.

The computer processor can be programmed to initiate the nucleic acid amplification reaction by instructing the thermal cycler to subject the reaction mixture to heating. The computer processor can be programmed to terminate the nucleic acid amplification reaction by instructing the thermal cycler to subject the reaction mixture to cooling in the absence of heating.

The system as described herein further may comprise a power source that supplies power to the thermal cycler during the nucleic acid amplification reaction, wherein the power source operates at the operating voltage. The power source may be a vehicle that provides the operating voltage. The power source maybe a battery. The battery may be a lithium ion battery. The battery may be a portable battery.

The battery can be configured to be charged with no more than a 48 V input, and the battery may provide no more than a 48 V output to power the thermal cycler. The battery can be charged with an input voltage and output an output voltage. The input voltage may be less than or equal to 240 V, 120 V, 48 V, 24 V, or 12 V. The output voltage may be less than or equal to 240 V, 120 V, 48 V, 24 V, or 12 V. In some cases, the output voltage is higher than an operating voltage of the device, but may be decreased with a transformer (e.g., step-down transformer).

The thermal cycler can be disposed in a housing that is separate from the power source. The thermal cycler and the power source may be operatively coupled through a power connector. The power connector may be an electrical bus, which can include one or more electrically conductive flow paths.

The reaction mixture may be in a sample container. The sample container may be a test tube. The test tube may include a lid. The lid may be closable. The lid may be sealable.

The thermal cycler may be capable of controlling the temperature to within plus or minus 10 degrees C., 5 degrees C., 4 degrees C., 3 degrees C., 2 degrees C., 1 degree C., 0.5 degrees C., or 0.1 degrees C.

The reagents may include a primer and a polymerization enzyme. The primer may be sequence specific or a universal primer, for example. The primer may have a sequence that is selected for a given target nucleic acid sequence. For example, the primer may have a sequence that is selected to assay for a presence of a disease. The polymerization enzyme may be a polymerase, such as DNA polymerase.

The reagents may include a chemical agent that permits detection of the amplified target nucleic acid molecule(s). The chemical agent may be an optical dye. The optical dye may be an intercalating dye. The optical dye can be configured to hybridize to target nucleic acid molecule.

The amplified target nucleic acid molecule(s) may be at least one or a plurality of amplified target nucleic acid molecules. For example, the amplified target nucleic acid molecule(s) are at least 2, 3, 4, 5, 6, 7, 8, 9, 10, 20, 30, 40, 50, 60, 70, 80, 90, 100, 200, 300, 400, 500, 1000, or 10000 amplified target nucleic acid molecules.

During use, a reaction mixture may be provided in the thermal cycler. The reaction mixture can include a biological sample having a target nucleic acid molecule and reagents necessary to conduct a nucleic acid amplification reaction to generate amplified target nucleic acid molecule(s) as amplification product(s) of the target nucleic acid molecule. Next, the thermal cycler may be instructed to cycle a temperature of the reaction mixture at a first number of heating and cooling cycles to perform the nucleic acid amplification reaction. Upon receiving a request to change the first number of heating and cooling cycles to a second number of heating and cooling cycles while the thermal cycler is cycling the temperature, the thermal cycler may be instructed to terminate cycling the temperature upon reaching the second number of heating and cooling cycles.

The request may be received from a user. For example, the user may wish to change the first number of cycles to the second number of cycles and may provide a request for the change on a user interface. Alternatively, the request may be received from a computer program or system, in some cases without user input. Such computer program or system may, for example, monitor a progress of nucleic acid amplification and update the number of cycles accordingly. In some cases, prior to (a), power is provided to the thermal cycler from a power source.

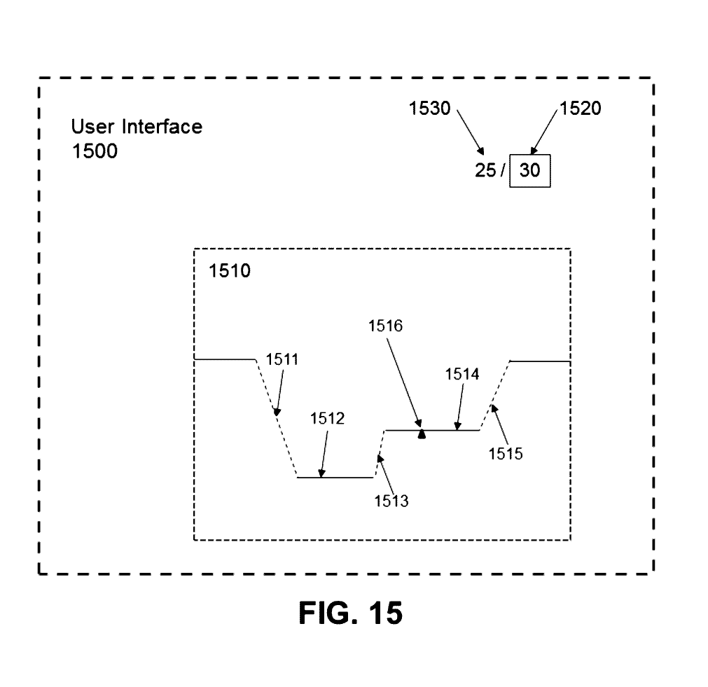

FIG. 15 shows a user interface 1500 for user input to change a first number of heating and cooling cycles to a second number of heating and cooling cycles. The user interface 1500 comprises a graphical element 1510 corresponding to the progress of the nucleic acid amplification reaction with time and a graphical element 1520 corresponding to the first number of heating and cooling cycles and the second number of heating and cooling cycles. The graphical element 1510 comprises several graphical sub-elements 1511-1515, each representing a stage of the nucleic amplification by way of a plot. The graphical element 1510 further comprises a graphical element 1516 for indicating the current status of the nucleic acid amplification reaction. The graphical element 1520 indicates the first number of heating and cooling cycles. The user may use a touchscreen, a mouse, or a keyboard, or any other suitable input module to select the graphical 1520 and enter a second number of heating and cooling cycles, thereby the first number of heating and cooling cycles is changed to the second number of heating and cooling cycles. The user interface 1500 may further comprise a graphical element 1530 which indicates the number of the heating and cooling cycle currently being performed.

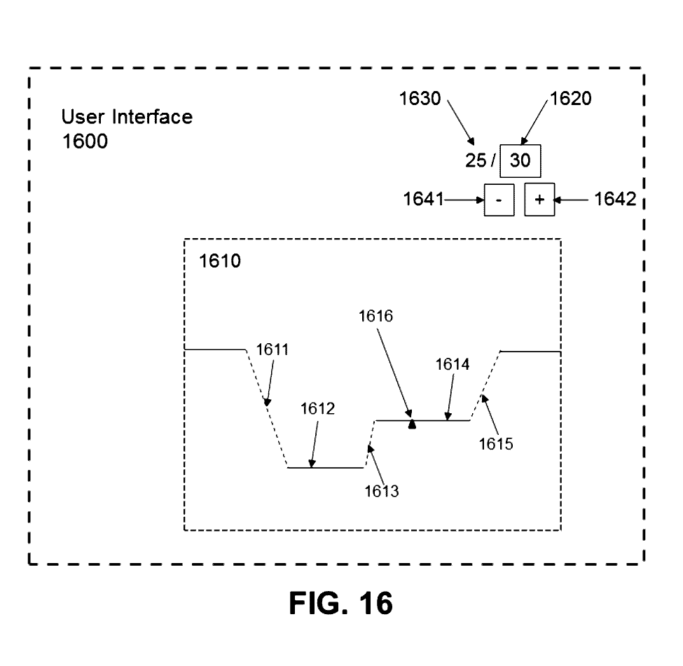

FIG. 16 shows another user interface 1600 for user input to change a first number of heating and cooling cycles to a second number of heating and cooling cycles. The user interface 1600 which comprises a graphical element 1610 corresponding to the progress of the nucleic acid amplification reaction with time and a graphical element 1620 corresponding to the first number of heating and cooling cycles and the second number of heating and cooling cycles. The graphical element 1610 comprises several graphical sub-elements 1611-1615, each representing a stage of the nucleic amplification by way of a plot. The graphical element 1610 further comprises a graphical element 1616 for indicating the current status of the nucleic acid amplification reaction. The graphical element 1620 indicates the first number of heating and cooling cycles. Additionally or alternatively, the user interface 1600 further comprises a graphical element 1641 for decreasing the number of heating and cooling cycles and a graphical 1642 for increasing the number of heating and cooling cycles. The user may use a touchscreen, a mouse, or a keyboard, or any other suitable input module to select the graphical 1620 and enter a second number of heating and cooling cycles, thereby the first number of heating and cooling cycles is changed to the second number of heating and cooling cycles. Additionally or alternatively, the user may use a touchscreen, a mouse, or a keyboard, or any other suitable input module to select and act on the graphical element 1641 to decrease the number of heating and cooling cycles to a second number of heating and cooling cycles, and/or to select and act on the graphical element 1642 to increase the number of heating and cooling cycles to a second number of heating and cooling cycles, thereby the first number of heating and cooling cycles is changed to the second number of heating and cooling cycles. The user interface 1600 may further comprise a graphical element 1630 which indicates the number of the heating and cooling cycle currently being performed.

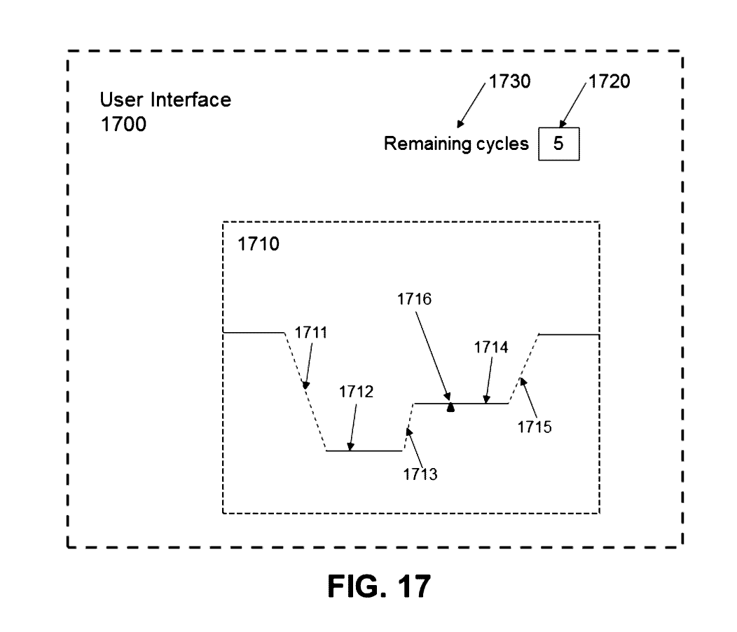

FIG. 17 shows another user interface 1700 for user input to change a first number of heating and cooling cycles to a second number of heating and cooling cycles. The user interface 1700 comprises a graphical element 1710 corresponding to the progress of the nucleic acid amplification reaction with time and a graphical element 1720 corresponding to the first number of heating and cooling cycles and the second number of heating and cooling cycles. The graphical element 1710 comprises several graphical sub-elements 1711-1715, each representing a stage of the nucleic amplification by way of a plot. The graphical element 1710 further comprises a graphical element 1716 for indicating the current status of the nucleic acid amplification reaction. The graphical element 1720 indicates the first remaining cycle number. The user may use a touchscreen, a mouse, or a keyboard, or any other suitable input module to select the graphical 1720 and enter a second remaining cycle number, thereby the first number of heating and cooling cycles is changed to the second number of heating and cooling cycles. The user interface 1700 may further comprise a textual element 1730 which indicates the number displayed in the graphical 1720 is the number of the remaining heating and cooling cycles.

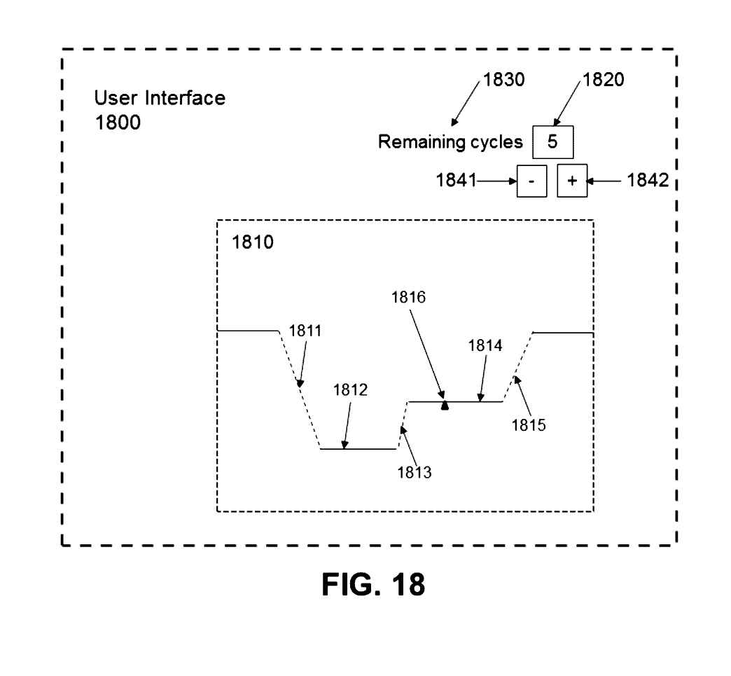

FIG. 18 shows another user interface 1800 for user input to change a first number of heating and cooling cycles to a second number of heating and cooling cycles. The user interface 1800 comprises a graphical element 1810 corresponding to the progress of the nucleic acid amplification reaction with time and a graphical element 1820 corresponding to the first number of heating and cooling cycles and the second number of heating and cooling cycles. The graphical element 1810 comprises several graphical sub-elements 1811-1815, each representing a stage of the nucleic amplification by way of a plot. The graphical element 1810 further comprises a graphical element 1816 for indicating the current status of the nucleic acid amplification reaction. The graphical element 1820 indicates the first remaining cycle number. Additionally or alternatively, the user interface 1800 further comprises a graphical element 1841 for decreasing the number of heating and remaining cooling cycles and a graphical 1842 for increasing the number of remaining heating and cooling cycles. The user may use a touchscreen, a mouse, or a keyboard, or any other suitable input module to select the graphical 1820 and enter a second remaining cycle number, thereby the first number of heating and cooling cycles is changed to the second number of heating and cooling cycles. Additionally or alternatively, the user may use a touchscreen, a mouse, or a keyboard, or any other suitable input module to select and act on the graphical element 1841 to decrease the number of remaining heating and cooling cycles to a second remaining cycle number, and/or to select and act on the graphical element 1842 to increase the number of remaining heating and cooling cycles to a second remaining cycle number, thereby the first number of heating and cooling cycles is changed to the second number of heating and cooling cycles. The user interface 1800 may further comprise a textual element 1830 which indicates the number displayed in the graphical 1820 is the number of the remaining heating and cooling cycles.

### Systems and Methods for Terminating Thermal Cycling

In another aspect, the present disclosure provides a system for terminating thermal cycling during runtime, such as while conducting a nucleic acid amplification reaction. The system may comprise a thermal cycler, a detector operatively coupled to the thermal cycler, and a computer processor coupled to the thermal cycler.

The thermal cycler may receive a reaction mixture and cycle a temperature of the reaction mixture to perform a nucleic acid amplification reaction. The reaction mixture may comprise a biological sample having a target nucleic acid molecule and reagents necessary to conduct the nucleic acid amplification reaction. Thereby amplified target nucleic acid molecule(s) are generated as the amplification product(s) of the target nucleic acid molecule.

The detector may detect a signal from the reaction mixture while the nucleic acid amplification reaction is in progress. The computer processor may be programmed to (i) receive the signal (such as an optical signal) from the detector while the nucleic acid amplification reaction is in progress, (ii) compare the signal or a signal change thereof to a respective threshold signal or signal change, and (iii) upon the signal or signal change reaching or exceeding the threshold signal or signal change, instruct the thermal cycler to terminate cycling the temperature and/or generate a notification that indicates that the signal or signal change has reached or exceeded the threshold signal or signal change.

The signal may be any suitable signal, such as, without limitation, an optical signal, electrostatic signal, thermal signal, or electrochemical signal. In some examples, the signal is an optical signal.

The threshold can be predetermined by a user input before or during of the nucleic acid amplification. Alternatively, the threshold may be calculated and determined by the computer processor. The threshold may be a positive real number. The threshold may be zero. The threshold may be a negative real number.

The intensity of the signal may be proportional to the amount of the amplified product. For example, the intensity signal may be directly linearly proportional, exponentially proportional, reversely proportional, or have any other type of proportional relationship to the amount of amplified product.

The signal may be a fluorescence signal. Alternatively, the signal may be other luminescent signal, such as a luminescence (e.g., chemiluminescence) signal, an absorbance signal, a diffracted signal, a reflected signal, a refracted signal, etc.

The signal change may be a first or second derivative of the signal with time. Upon the first or second derivative of the signal with time reaching or exceeding a threshold, the computer processor may instruct the thermal cycler to terminate cycling the temperature and/or generate a notification that indicates that the first or second derivative of the signal with time has reached or exceeded the threshold. For example, the first derivative of the signal with time may be a slope at different time point along plot of the signal versus time or cycle number. For example, the second derivative of the signal with time may be a rate of slope change, wherein the slope is a slope at different time point along plot of the signal versus time.

The signal change may be a negative first or second derivative of the signal with time. Upon the negative first or second derivative of the signal with time reaching or exceeding a threshold, the computer processor may instruct the thermal cycler to terminate cycling the temperature and/or generate a notification that indicates that the negative first or second derivative of the signal with time has reached or exceeded the threshold. In some examples, upon the negative first derivative of the signal with time reaching or exceeding a threshold while the second derivative of the signal with time is negative, the computer processor may instruct the thermal cycler to terminate cycling the temperature and/or generate a notification that indicates that the negative first derivative of the signal with time has reached or exceeded the threshold while the second derivative of the signal with time is negative. In some examples, upon the negative first derivative of the signal with time reaching or exceeding a threshold while the second derivative of the signal is positive, the thermal cycler may not be instructed to terminate cycling the temperature. For example, the negative first derivative of the signal with time may be the negation of a slope at different time point along plot of the signal versus time. For example, the negative second derivative of the signal with time may be the negation of a rate of slope change, wherein the slope is a slope at different time point along plot of the signal versus time.

Alternatively, in the aforesaid step (iii), upon the signal or signal change reaching or exceeding the threshold signal or signal change, the processor may instruct the thermal cycler not to terminate but to halt cycling the temperature and/or generate a notification that indicates that the signal has reached or exceeded the threshold signal or signal change. The notification may prompt the user to make a decision as to whether to continue the cycling. The user may, via an input module as described herein, instruct the thermal cycler to terminate or resume the cycling.

The system can have an operating voltage that is less than 240 V or 120 V during the nucleic acid amplification reaction. In some examples, the operating voltage is no more than about 48 V, 24 V, or 12 V during the nucleic acid amplification reaction. The thermal cycler and/or detector can have an operating voltage that is less than or equal to 240 V, 120 V, 48 V, 24 V, or 12 V. The computer processor can have an operating voltage that is less than or equal to 240 V, 120 V, 48 V, 24 V, or 12 V. Such operating voltage can be achieved, for example, using a transformer.

The system can further comprise a sealed light transmission path that brings the reaction mixture in optical communication with the detector. The light transmission path can include one or more optical elements selected from mirrors, lenses and prisms.

The thermal cycler and the detector may be included in a housing. The housing may be any suitable housing, including without being limited to those described elsewhere herein. The thermal cycler and computer processor can be in the same housing or different housing. In some examples, the thermal cycler is in a first housing and the computer processor is in a separate housing, such as a separate housing or an electronic device of a user (e.g., portable computer or Smartphone).

The thermal cycler may comprise a heating element that heats the reaction mixture to increase the temperature. The heating element may be any suitable heating element, including but not limited to those described elsewhere herein. The thermal cycler may comprise a cooling element that cools the reaction mixture. The cooling element may be any suitable cooling element, including but not limited to those described elsewhere herein. The heating element may be a heating block having a plurality of indentations, wherein each of the plurality of indentations is dimensioned to accept a sample container having the biological sample and/or reagents.

The computer processor can be programmed to instruct the thermal cycler to subject the reaction mixture to cooling in the absence of heating upon the signal reaching or exceeding the threshold signal or signal change.

The system may further comprise a power source that supplies power to the thermal cycler and detector during the nucleic acid amplification reaction, wherein the power source operates at the operating voltage. The power source may be a vehicle that provides the operating voltage. The power source may be a battery. The battery may be any suitable battery, including without limited to those described elsewhere herein. The battery can be configured to be charged with no more than a 48 V input, and the battery may provide no more than a 48 V output to power the thermal cycler. The battery can be charged with an input voltage and output an output voltage. The input voltage may be less than or equal to 240 V, 120 V, 48 V, 24 V, or 12 V. The output voltage may be less than or equal to 240 V, 120 V, 48 V, 24 V, or 12 V. In some cases, the output voltage is higher than an operating voltage of the device, but may be decreased with a transformer (e.g., step-down transformer).

The thermal cycler can be disposed in a housing that is separate from the power source, and the thermal cycler and the power source may be operatively coupled through a power connector. The power connector may be an electrical bus, which can include one or more electrically conductive flow paths.

The computer processor can be programmed to generate and direct the notification for display on an electronic display of a user. The notification can be, for example, a pop-up or drop-down message on a user interface of an electronic display of the user, an electronic mail (email), an instant message (IM), a text message, or a system notification. In an example, the notification is a drop-down message (e.g., “Hello, the reaction signal has reached a threshold.”). As an alternative or in addition to, the notification may indicate that cycling the temperature has been terminated (e.g., “Hello, thermal cycling has ended”).

The electronic display may be on an electronic device of the user, which electronic device may be in network communication with the computer processor. As an alternative or in addition to, the electronic device may be coupled to (e.g., part of) the housing.

During use, a reaction mixture may be provided in the thermal cycler. The reaction mixture can comprise a biological sample having a target nucleic acid molecule and reagents necessary to conduct a nucleic acid amplification reaction to generate amplified target nucleic acid molecule(s) as amplification product(s) of the target nucleic acid molecule. The thermal cycler may be operatively coupled to a detector that detects a signal from the reaction mixture while the nucleic acid amplification reaction is in progress. Next, the signal may be received from the detector while the nucleic acid amplification reaction is in progress. Next, the signal or a signal change thereof may be compared to a respective threshold signal or signal change. Next, upon the signal or signal change reaching or exceeding the threshold signal or signal change, the thermal cycler may be instructed to terminate or halt cycling the temperature and/or (ii) generating a notification that indicates that the signal or signal change has reached or exceeded the threshold signal or signal change.

The thermal cycler may be instructed to subject the reaction mixture to cooling in the absence of heating. This may be implemented upon the signal reaching or exceeding the threshold signal or signal change.

Prior to use, power may be provided to the thermal cycler and the detector from a power source. The power source may be as described elsewhere herein.

The notification may be generated and directed for display on an electronic display of a user. The electronic display may be any suitable electronic display, including without limited to those described elsewhere herein.

The system and method for terminating or halting thermal cycling may be implemented in combination with any aspect described in other sections herein. For example, the system and method for terminating or halting thermal cycling may have all or some aspects of the system and method for changing thermal cycler parameters during runtime incorporated therein. For example, upon the signal or signal change reaching or exceeding the threshold signal or signal change, the processor may instruct the thermal cycler to halt the cycling and/or generate a notification to prompt the user to change thermal cycler parameters. The user may, via an input module as described herein, change the thermal cycler parameters as described herein. For example, the user may, via an input module as described herein, change the first number of heating and cooling cycles to a second number of heating and cooling cycles. In one example, the user can directly enter the second cycle number or the second remaining cycle number as described elsewhere herein. In another example, the user can increase or decrease remaining cycle number as described elsewhere herein.

If the signal or signal change reaches or exceeds the threshold signal or signal change during a cycle (e.g., in the middle of the cycle), the thermal cycler may be instructed to terminate or halt the temperature cycling after the conclusion of the current cycle.

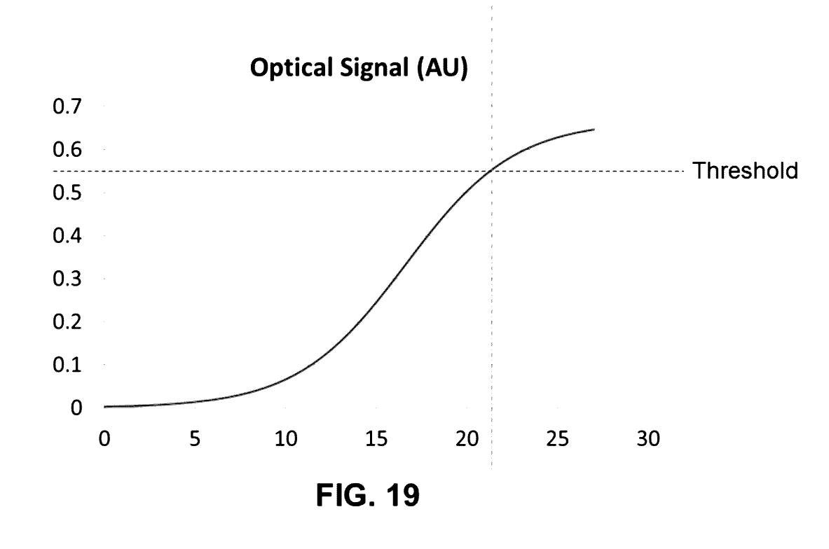

FIG. 19 shows an example plot of signal versus time during nucleic acid amplification. The y-axis is the signal in an arbitrary unit. The x-axis is the number of heating and cooling cycles. The horizontal dashed line represents a predetermined threshold. The intercept of the vertical dashed line on the x-axis represents the time point when the threshold is reached. When the nucleic acid amplification proceeds to the time point, the thermal cycler is instructed to terminate or halt the cycling.

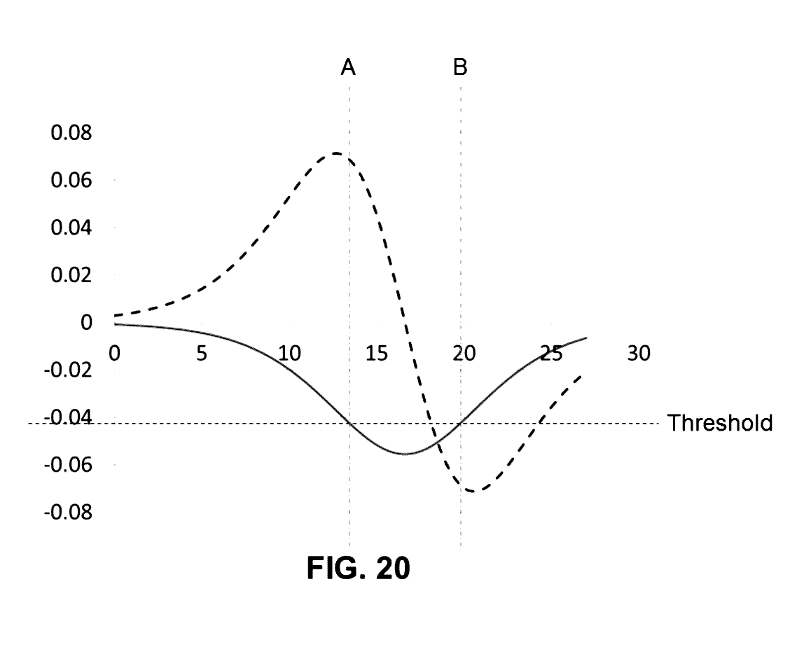

FIG. 20 shows another example plot of the signal changes versus time during nucleic acid amplification. The y-axis is the signal changes in an arbitrary unit. The x-axis is the number of heating and cooling cycles. The solid curve represents the negative first derivative of the signal with time. The dashed curve represents the second derivative of the signal with time. The horizontal dashed line represents a predetermined threshold. The intercepts of the vertical dashed lines A and B on the x-axis represent the two time points when the negative first derivative of the signal with time reaches the threshold. Although on the left of the vertical dashed line A, the negative first derivative of the signal with time exceeds the threshold, the corresponding second derivative of the signal with time remains positive. Hence, the cycling is allowed to proceed. When the nucleic acid amplification proceeds to the time point on the vertical dashed line B, the corresponding second derivative of the signal with time is found to be negative. Consequently, the thermal cycler is instructed to terminate or halt the cycling.

### Systems and Methods for Independent Thermal Cycling

In another aspect, the present disclosure provides a system for independent thermal cycling, such as while conducting a nucleic acid amplification reaction. The system may comprise a thermal cycler and a computer processor coupled to the thermal cycler.

The thermal cycler may include a plurality of individually addressable and controllable thermal zones. Any given thermal zone may (i) receive a reaction mixture, and (ii) cycle a temperature of the reaction mixture to perform a nucleic acid amplification reaction. The reaction mixture may comprise a biological sample having a target nucleic acid molecule and reagents necessary to conduct a nucleic acid amplification reaction to generate amplified target nucleic acid molecule(s) as amplification product(s) of the target nucleic acid molecule.

The computer processor may be programmed to regulate the amplification reaction in the given thermal zone independently from amplification reactions in other thermal zones of the plurality of individually addressable and controllable thermal zones.

The regulation of the amplification reaction in the given thermal zone may include, without being limited to, adding samples and/or reagents to a reaction mixture, taking samples from a reaction mixture, changing thermal cycle parameters (such as cycle numbers, temperature, duration, ramp rate, etc.), making measurements, halting the reaction, terminating the reaction, resuming the reaction, removing a reaction mixture from the thermal zone, loading a reaction mixture to an empty thermal zone, and any combination thereof.

The system may further comprise a detector with plurality of sensors that detect (such as optically, electrostatically, electrochemically, spectrally, or the like) signals from the plurality of individually addressable and controllable thermal zones, wherein a given sensor of the plurality of sensors detects signals from the reaction mixture.

In some cases, more than one sensor may detect signals from one individually addressable and controllable thermal zone. In an example, one sensor may detect optical signals from the given thermal zone, while another sensor may detect electrochemical signals from the same thermal zone. In another example, one sensor may detect fluorescent signal, while another sensor may detect luminescent (e.g., chemiluminescent) signals. In another example, a third sensor may detect spectroscopic signals.

The plurality of sensors may not detect the same signal among them. For example, some sensors may detect optical signals from some thermal zones, while other sensors may detect electrochemical signals from other thermal zones. In another example, some sensors may detect fluorescent signal, while other sensors may detect luminescent (e.g., chemiluminescent) signals. In another example, a third group of sensors may detect spectroscopic signals.

The detector may be operably linked to the computer processor so as to enable the transmission of the signals from the detector to the computer processor. The computer processor may be programmed to regulate the amplification reaction in the given thermal zone based on the signals transmitted from the detector. The computer processor may be programmed to send the signals to the user. The computer processor may be programmed to send a notification and/or alert the user when a condition about a given thermal zone is fulfilled. The condition may be predetermined, such as by an operator of the system. The predetermined condition may be that the signal or signal change in the given thermal zone reaches or exceeds a threshold. The threshold can be predetermined by a user input before or during of the nucleic acid amplification. Alternatively, the threshold may be calculated and determined by the computer processor. The signal change may be a first or second derivative of the signal with time including those described elsewhere herein.

Upon receiving the notification and/or alert, the user may, via an input module as described elsewhere herein, instruct the computer processor to regulate the amplification reaction in the given thermal zone independently from amplification reactions in other thermal zones of the plurality of individually addressable and controllable thermal zones. The computer processor may be programmed to provide, upon the fulfillment of the predetermined condition, a plurality of options in the notification and/or alert to the user, or in a separate notification and/or alert, wherein each option represents a machine executable procedure which, when executed by the computer processor, instructs the computer processor to regulate the given thermal zone. Upon the selection by user input of one option in the plurality of the options, the machine executable procedure corresponding to the option is executed to instruct to computer processor to regulate the given thermal zone.

The notification and/or can be, for example, a pop-up or drop-down message on a user interface of an electronic display of the user, an electronic mail (email), an instant message (IM), a text message, or a system notification. In an example, the notification is a pop-up message with multiple options (e.g., “Hello, the reaction signal in well#4 has reached threshold, do you want to (1) terminate the reaction; (2) add more cycles; (3) put the reaction in hold pattern; or (4) continue reaction.”). Upon the selection by user input of options (1), (2), (3), or (4), the computer processor is instructed to take action accordingly.

The thermal cycler may comprise a heating element that heats the reaction mixture to increase the temperature. The heating element may be any suitable heating element, including but not limited to those described elsewhere herein. The thermal cycler may comprise a cooling element that cools the reaction mixture. The cooling element may be any suitable cooling element, including but not limited to those described elsewhere herein.

The plurality of individually addressable and controllable thermal zones may include indentations that are dimensioned to accept sample containers with biological samples and/or reagents. The device may have any number of indentations as described while having any of the dimensions provided. In one example, the device may have 6, 8, 12, 24, 48, 96, or any other number of indentations. The system may weigh no more than 0.5 kg, 0.4 kg, 0.3 kg, 0.25 kg, 0.2 kg, 0.15 kg, 0.12 kg, or 0.1 kg per indentation. The plurality of indentations can be dimensioned to hold the sample containers each having a height of no more than 1 mm, 2 mm, 3 mm, 4 mm, 5 mm, 6 mm, 7 mm, 8 mm, 9 mm, 10 mm, 12 mm, 13 mm, 14 mm, 15 mm, 16 mm, 17 mm, 18 mm, 19 mm, 20 mm, 21 mm, 22 mm, 23 mm, 24 mm, 25 mm, 27 mm, 30 mm, 35 mm, 40 mm, 45 mm, 50 mm, 55 mm, 60 mm, or 70 mm.

The system can have an operating voltage that is less than 240 V or 120 V during the nucleic acid amplification reaction. In some examples, the operating voltage is no more than about 48 V, 24 V, or 12 V during the nucleic acid amplification reaction. The thermal cycler and/or detector can have an operating voltage that is less than or equal to 240 V, 120 V, 48 V, 24 V, or 12 V. The computer processor can have an operating voltage that is less than or equal to 240 V, 120 V, 48 V, 24 V, or 12 V. Such operating voltage can be achieved, for example using a transformer.

The system may further comprise a power source that supplies power to the thermal cycler during the nucleic acid amplification reaction, wherein the power source operates at the operating voltage. The power source may be a vehicle that provides the operating voltage. The power source may be a battery. The battery may be any suitable battery, including without limited to those described elsewhere herein.

During use, a plurality of individually addressable and controllable thermal zones may be provided in a thermal cycler. A first reaction mixture may be received in a first thermal zone and a second reaction mixture may be received in a second thermal zone of the plurality of individually addressable and controllable thermal zones. Each of the first and second reaction mixtures may include a biological sample having a target nucleic acid molecule and reagents necessary to conduct a nucleic acid amplification reaction to generate amplified target nucleic acid molecule(s) as amplification product(s) of the target nucleic acid molecule

Next, the thermal cycler may be instructed to independently cycle a first temperature of the first reaction mixture and a second temperature of the second reaction mixture, thereby conducting the nucleic acid amplification reaction in each of the first and second reaction mixtures. In some cases, the thermal cycler may be instructed to terminate or halt cycling one of the first temperature and second temperature while continuing to cycle the other of the first temperature and second temperature.

In some case, a detector having a plurality of sensors that detect signals (such as optically) from the plurality of individually addressable and controllable thermal zones may be provided, and a first sensor and second sensor of the plurality of sensors may be used to independently detect signals from the first reaction mixture and second reaction mixture, respectively.

The system and method for independent thermal cycling may be implemented in combination with any aspect described in other sections herein. For example, the system and method for independent thermal cycling may have all or some aspects of the system and method for changing thermal cycler parameters during runtime and/or the system and method for terminating or halting thermal cycling incorporated therein.

For example, upon the signal or signal change of the first reaction mixture reaching or exceeding the threshold signal or signal change, the thermal cycler may be instructed to terminate or halt cycling the first temperature and/or generate a notification that indicates that the signal or signal change has reached or exceeded the threshold signal or signal change while continuing to cycle the second temperature. For example, upon the signal or signal change of the second reaction mixture reaching or exceeding the threshold signal or signal change, the thermal cycler may be instructed to terminate or halt cycling the second temperature and/or generate a notification that indicates that the signal or signal change has reached or exceeded the threshold signal or signal change, while continuing to cycle the first temperature.

For example, upon the signal or signal change of the first reaction mixture reaching or exceeding the threshold signal or signal change, the thermal cycler may be instructed to change the cycler parameters in the first thermal zone, while leaving the cycler parameters in the second thermal zone unchanged. For example, upon the signal or signal change of the second reaction mixture reaching or exceeding the threshold signal or signal change, the thermal cycler may be instructed to change the cycler parameters in the second thermal zone, while leaving the cycler parameters in the first thermal zone unchanged.

For example, upon the signal or signal change of the first reaction mixture reaching or exceeding the threshold signal or signal change, the thermal cycler may be instructed to change a first number of heating and cooling cycles to a second number of heating and cooling cycles in the first thermal zone, while leaving number of heating and cooling cycles in the second thermal zone unchanged. For example, upon the signal or signal change of the second reaction mixture reaching or exceeding the threshold signal or signal change, the thermal cycler may be instructed to change a first number of heating and cooling cycles to a second number of heating and cooling cycles in the second thermal zone, while leaving number of heating and cooling cycles in the first thermal zone unchanged.

For example, when the number of heating and cooling cycle being performed in the first thermal zone reaches the first cycle number as described herein for the first thermal zone and the signal or signal change of the first reaction mixture fails to reach a threshold signal or signal change, the thermal cycler is instructed to set a second cycle number which is at least one, two, three, four or five above the first cycle number for the first thermal zone, while leaving the number of heating and cooling cycles in the second thermal zone unchanged. For example, when the number of heating and cooling cycle being performed in the second thermal zone reaches the first cycle number as described herein for the second thermal zone and the signal or signal change of the second reaction mixture fails to reach a threshold signal or signal change, the thermal cycler is instructed to set a second cycle number which is at least one, two, three, four or five above the first cycle number for the second thermal zone, while leaving the number of heating and cooling cycles in the second thermal zone unchanged.

The signal change may be a first or second derivative of the signal with time. For example, upon the first or second derivative of the signal of the first reaction mixture with time reaching or exceeding a threshold, the thermal cycler may be instructed to terminate or halt cycling the first temperature and/or generate a notification that indicates that the first or second derivative of the signal of the first reaction mixture with time has reached or exceeded the threshold, while continue to cycle the second temperature. For example, upon the first or second derivative of the signal of the second reaction mixture with time reaching or exceeding a threshold, the thermal cycler may be instructed to terminate or halt cycling the second temperature and/or generate a notification that indicates that the first or second derivative of the signal of the second reaction mixture with time has reached or exceeded the threshold, while continue to cycle the first temperature.

The signal change may be a negative first or second derivative of the signal with time. For example, upon the negative first or second derivative of the signal of the first reaction mixture with time reaching or exceeding a threshold, the thermal cycler may be instructed to terminate or halt cycling the first temperature and/or generate a notification that indicates that the negative first or second derivative of the signal of the first reaction mixture with time has reached or exceeded the threshold, while continue to cycle the second temperature. For example, upon the negative first or second derivative of the signal of the second reaction mixture with time reaching or exceeding a threshold, the thermal cycler may be instructed to terminate or halt cycling the second temperature and/or generate a notification that indicates that the negative first or second derivative of the signal of the second reaction mixture with time has reached or exceeded the threshold, while continue to cycle the first temperature. In some examples, upon the negative first derivative of the signal of the first reaction mixture with time reaching or exceeding a threshold and the second derivative of the signal of the first reaction mixture with time being negative, the thermal cycler may be instructed to terminate or halt cycling the first temperature and/or generate a notification that indicates that the negative first derivative of the signal of the first reaction mixture with time has reached or exceeded the threshold and the second derivative of the signal of the first reaction mixture with time is negative, while continue to cycle the second temperature. In some examples, upon the negative first derivative of the signal of the second reaction mixture with time reaching or exceeding a threshold and the second derivative of the signal of the second reaction mixture with time being negative, the thermal cycler may be instructed to terminate or halt cycling the second temperature and/or generate a notification that indicates that the negative first derivative of the signal of the second reaction mixture with time has reached or exceeded the threshold and the second derivative of the signal of the second reaction mixture with time is negative, while continue to cycle the first temperature. In some examples, upon the negative first derivative of the signal of the first reaction mixture with time reaching or exceeding a threshold and the second derivative of the signal of the first reaction mixture with time being positive, the thermal cycler may be instructed to not terminate or halt cycling the first temperature. In some examples, upon the negative first derivative of the signal of the second reaction mixture with time reaching or exceeding a threshold and the second derivative of the signal of the second reaction mixture with time being positive, the thermal cycler may be instructed to not terminate or halt cycling the second temperature.

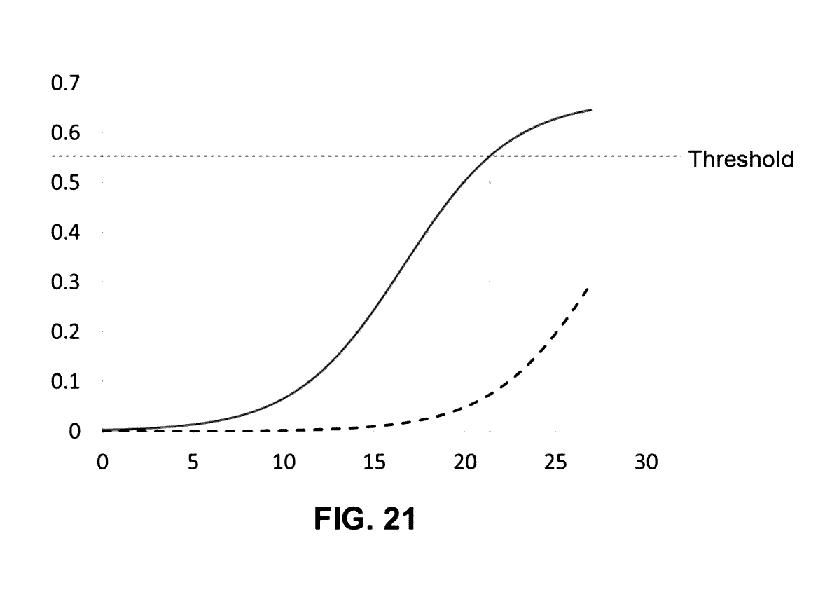

FIG. 21 shows an example plot of signal versus time during nucleic acid amplification. The y-axis is the signal in an arbitrary unit. The x-axis is the number of heating and cooling cycles. The solid curve represents the plot for the first reaction mixture in the first thermal zone. The dashed curve represents the plot for the second reaction mixture in the second thermal zone. The horizontal dashed line represents a predetermined threshold. The intercept of the vertical dashed line on the x-axis represents the time point when the threshold is reached for the first reaction mixture. When the nucleic acid amplification proceeds to the time point, the thermal cycler is instructed to terminate or halt the cycling in the first thermal zone, but allow the cycling in the second thermal zone to proceed.

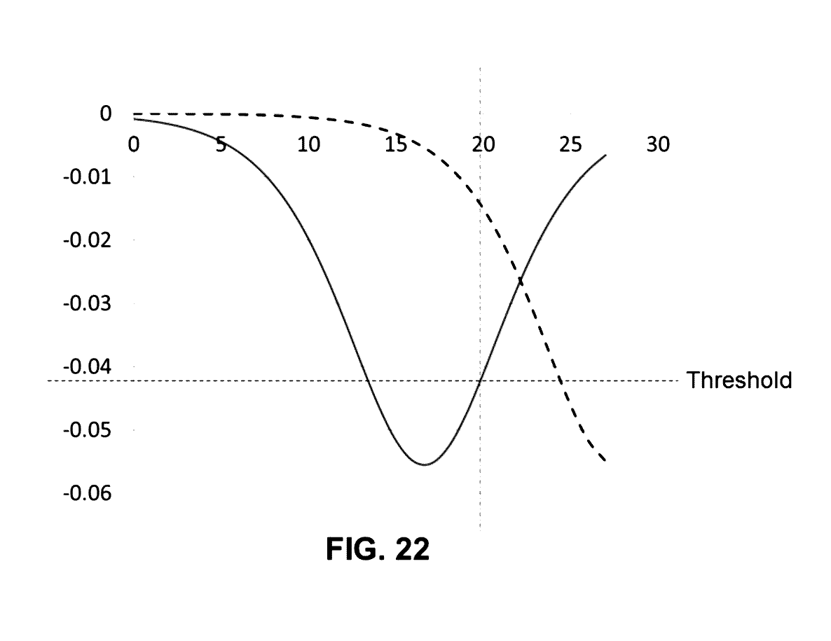

FIG. 22 shows another example plot of signal change versus time during nucleic acid amplification. The y-axis is the negative first derivative of the signal with time in an arbitrary unit. The x-axis is the number of heating and cooling cycles. The solid curve represents the plot for the first reaction mixture in the first thermal zone. The dashed curve represents the plot for the second reaction mixture in the second thermal zone. The horizontal dashed line represents a predetermined threshold. The intercept of the vertical dashed line on the x-axis represents the time point when the threshold is reached for the first reaction mixture while the second derivative of the signal for the first reaction with time (not shown) is negative. When the nucleic acid amplification proceeds to the time point, the thermal cycler is instructed to terminate or halt the cycling in the first thermal zone, but allow the cycling in the second thermal zone to proceed.

Generating Report

The systems as described elsewhere herein may be capable of generating a report comprising information on the nucleic acid amplification. The report may include any number of desired elements, with non-limiting examples that include information regarding the subject (e.g., sex, age, race, health status, etc.) raw data, processed data (e.g. graphical displays (e.g., figures, charts, data tables, data summaries), determined cycle threshold values, calculation of starting amount of target polynucleotide), conclusions about the presence of the target nucleic acid, diagnosis information, prognosis information, disease information, and the like, and combinations thereof.

The report may be transmitted to the recipient at a local or remote location using any suitable communication medium including, for example, a network connection, a hard-wired connection, a wireless connection, a local intranet, or an internet connection. The report can be sent to a recipient's device. Non-limiting examples of the recipient's device include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants.

Direct communication may occur between the system and the recipient's device. For example, Bluetooth, infra-red communications, radio, WiFi, or other direct communications may occur. In other instances, indirect communications may occur between the system and the recipient's device. For examples, communications may occur over a network, such as a local area network (LAN), or wide area network (WAN) such as the Internet. The network may include one or more computer servers, which can enable distributed computing, such as cloud computing. In some instances, with the aid of a computer system, the network may implement a peer-to-peer network, which may enable devices coupled to the computer system to behave as a client or a server. The computer system can communicate with one or more remote computer systems, such as the recipient's device, through the network.

In some instances, telecommunications networks may be used (e.g., cellular phone networks, data networks) for the transmission of the report. Such communications, for example, may enable transmission of the report from one system (e.g., any system for nucleic acid amplification as described herein) into another (e.g., the recipient's device). Thus, another type of media that may bear the report includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the report. In some examples, 3G or 4G networks may be used for communications.

The report may be viewed online, saved on the recipient's device, or printed. In some instances, the report is in the form of a data file. The report may comprise visual, video, and/or audio elements that are understandable and convey meaningful information to the recipient. In some instances, the report is or is included in an electronic message, such as an email or a text message.

There are other suitable approaches for transmitting a report, with non-limiting examples that include mailing a hard-copy report for reception and/or for review by a recipient.

The methods described elsewhere herein may further comprise an operation of generating a report comprising information on the nucleic acid amplification, as described herein.

The report may be transmitted to the recipient at a local or remote location using any suitable communication medium, as described above.

### Computer Control Systems

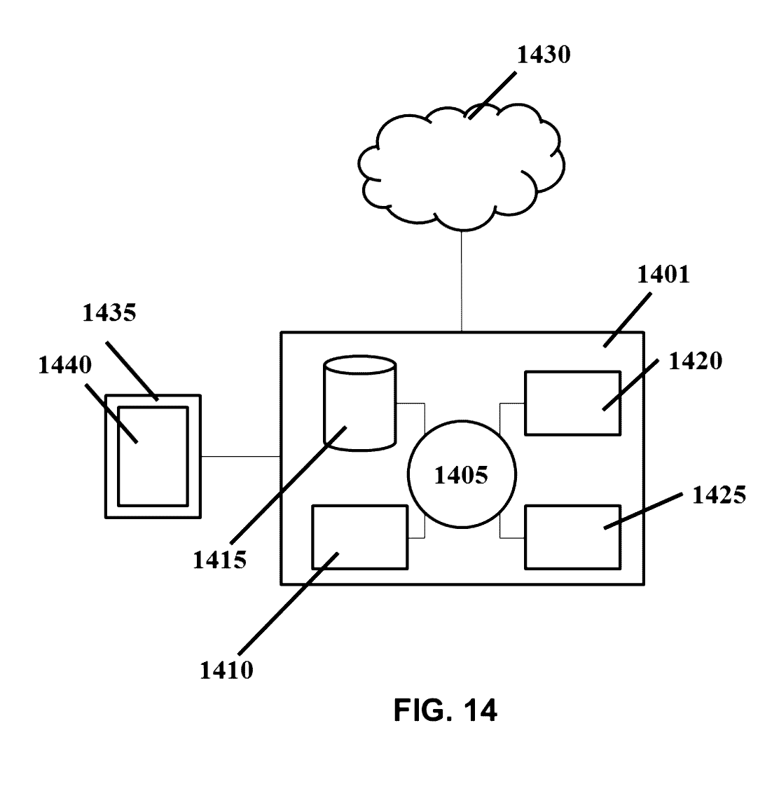

The present disclosure provides computer control systems that are programmed to implement methods of the disclosure. Computer control systems can be configured or integrated within a device (e.g., thermal cycler) of the present disclosure. FIG. 14 shows a computer system 1401 that is programmed or otherwise configured to control the operation of a thermal cycler and collect data. The computer system 1401 can regulate various aspects of thermal cyclers of the present disclosure, such as, for example, target temperature levels, overshooting temperature levels, ramp rates and times, number of cycles, hold times at target temperatures, and data collection. The computer system 1401 can be an electronic device of a user or a computer system that is remotely located with respect to the electronic device. The electronic device can be a mobile electronic device.

The computer system 1401 includes a central processing unit (CPU, also “processor” and “computer processor” herein) 1405, which can be a single core or multi core processor, or a plurality of processors for parallel processing. The computer system 1401 also includes memory or memory location 1410 (e.g., random-access memory, read-only memory, flash memory), electronic storage unit 1415 (e.g., hard disk), communication interface 1420 (e.g., network adapter) for communicating with one or more other systems, and peripheral devices 1425, such as cache, other memory, data storage and/or electronic display adapters. The memory 1410, storage unit 1415, interface 1420 and peripheral devices 1425 are in communication with the CPU 1405 through a communication bus (solid lines), such as a motherboard. The storage unit 1415 can be a data storage unit (or data repository) for storing data. The computer system 1401 can be operatively coupled to a computer network (“network”) 1430 with the aid of the communication interface 1420. The network 1430 can be the Internet, an internet and/or extranet, or an intranet and/or extranet that is in communication with the Internet. The network 1430 in some cases is a telecommunication and/or data network. The network 1430 can include one or more computer servers, which can enable distributed computing, such as cloud computing. The network 1430, in some cases with the aid of the computer system 1401, can implement a peer-to-peer network, which may enable devices coupled to the computer system 1401 to behave as a client or a server.

The CPU 1405 can execute a sequence of machine-readable instructions, which can be embodied in a program or software. The instructions may be stored in a memory location, such as the memory 1410. The instructions can be directed to the CPU 1405, which can subsequently program or otherwise configure the CPU 1405 to implement methods of the present disclosure. Examples of operations performed by the CPU 1405 can include fetch, decode, execute, and writeback.

The CPU 1405 can be part of a circuit, such as an integrated circuit. One or more other components of the system 1401 can be included in the circuit. In some cases, the circuit is an application specific integrated circuit (ASIC).

The storage unit 1415 can store files, such as drivers, libraries and saved programs. The storage unit 1415 can store user data, e.g., user preferences and user programs. The computer system 1401 in some cases can include one or more additional data storage units that are external to the computer system 1401, such as located on a remote server that is in communication with the computer system 1401 through an intranet or the Internet.

The computer system 1401 can communicate with one or more remote computer systems through the network 1430. For instance, the computer system 1401 can communicate with a remote computer system of a user (e.g., personal electronic device). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1401 via the network 1430.

Methods as described herein can be implemented by way of machine (e.g., computer processor) executable code stored on an electronic storage location of the computer system 1401, such as, for example, on the memory 1410 or electronic storage unit 1415. The machine executable or machine readable code can be provided in the form of software. During use, the code can be executed by the processor 1405. In some cases, the code can be retrieved from the storage unit 1415 and stored on the memory 1410 for ready access by the processor 1405. In some situations, the electronic storage unit 1415 can be precluded, and machine-executable instructions are stored on memory 1410.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1401, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1401 can include or be in communication with an electronic display 1435 that comprises a user interface (UI) 1440 for providing, for example, temperature levels, thermal cycling protocol conditions, and signal data from sample volumes. Examples of UI's include, without limitation, a graphical user interface (GUI) and web-based user interface.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

1. A system for conducting nucleic acid amplification, comprising:
a thermal cycler that (i) receives a reaction mixture comprising a biological sample having a target nucleic acid molecule and reagents necessary to conduct a nucleic acid amplification reaction to generate amplified target nucleic acid molecule(s) as amplification product(s) of said target nucleic acid molecule, and (ii) cycles a temperature of said reaction mixture to perform said nucleic acid amplification reaction to generate said amplified target nucleic acid molecule(s), wherein said thermal cycler has an operating voltage of no more than about 48 V during said nucleic acid amplification reaction; and
a computer processor coupled to said thermal cycler and programmed to (i) instruct said thermal cycler to begin cycling said temperature at a first number of heating and cooling cycles to perform said nucleic acid amplification reaction, (ii) change said first number of heating and cooling cycles to a second number of heating and cooling cycles while said thermal cycler is cycling said temperature, and (iii) instruct said thermal cycler to terminate cycling said temperature upon reaching said second number of heating and cooling cycles.

2. The system of claim 1, further comprising a detector that detects an optical signal from said reaction mixture while said nucleic acid amplification reaction is in progress without removing said reaction mixture from said thermal cycler.

3. (canceled)

4. The system of claim 2, further comprising a sealed light transmission path that brings said reaction mixture in optical communication with said detector.

5. The system of claim 2, wherein said thermal cycler and said detector are included in a housing.

6. (canceled)

7. The system of claim 5, wherein said housing has a greatest dimension of no more than about 15 cm and/or a weight of no more than about 2 kg.

8. (canceled)

9. The system of claim 1, wherein said computer processor is programmed to change said first number of heating and cooling cycles to said second number of heating and cooling cycles upon input received from a user.

10. The system of claim 9, wherein said input is received from an electronic display operatively coupled to said computer processor.

11. The system of claim 10, wherein said electronic display comprises a user interface with graphical and/or textual elements corresponding to said first number of heating and cooling cycles and said second number of heating and cooling cycles.

12. (canceled)

13. The system of claim 1, wherein said thermal cycler comprises a heating element that heats said reaction mixture to increase said temperature, and wherein said heating element is a heating block having a plurality of indentations, each of said plurality of indentations dimensioned to accept a sample container having said biological sample and/or reagents.

14. (canceled)

15. (canceled)

16. The system of claim 13, wherein a weight of said system per indentation is no more than 0.2 kg.

17. The system of claim 13, wherein each of said plurality of indentations is dimensioned to hold said sample container having a height of no more than 21 mm.

18.-23. (canceled)

24. The system of claim 1, further comprising a power source that supplies power to said thermal cycler during said nucleic acid amplification reaction, wherein said power source operates at said operating voltage.

25. (canceled)

26. The system of claim 24, wherein said power source is a battery.

27.-30. (canceled)

31. The system of claim 1, wherein said thermal cycler is capable of controlling said temperature to within plus or minus 0.1 degrees C.

32.-37. (canceled)

38. A method for conducting nucleic acid amplification, comprising:
(a) providing a thermal cycler that includes a reaction mixture comprising a biological sample having a target nucleic acid molecule and reagents necessary to conduct a nucleic acid amplification reaction to generate amplified target nucleic acid molecule(s) as amplification product(s) of said target nucleic acid molecule, wherein said thermal cycler has an operating voltage of no more than about 48 V during said nucleic acid amplification reaction;
(b) instructing said thermal cycler to cycle a temperature of said reaction mixture at a first number of heating and cooling cycles to perform said nucleic acid amplification reaction;
(c) receiving a request to change said first number of heating and cooling cycles to a second number of heating and cooling cycles while said thermal cycler is cycling said temperature; and
(d) instructing said thermal cycler to terminate cycling said temperature upon reaching said second number of heating and cooling cycles.

39. The method of claim 38, wherein said request to change said first number of heating and cooling cycles to said second number of heating and cooling cycles is received from a user.

40. The method of claim 39, wherein said request is received from an electronic display operatively coupled to said computer processor.

41. The method of claim 38, wherein said first number of heating and cooling cycles includes an initial heating phase followed by an initial cooling phase, or vice versa.

42. The method of claim 38, wherein said second number of heating and cooling cycles includes a final heating phase followed by a final cooling phase, or vice versa.

43. (canceled)

44. A system for conducting nucleic acid amplification, comprising:
a thermal cycler that includes a plurality of individually addressable and controllable thermal zones, wherein a given thermal zone (i) receives a reaction mixture comprising a biological sample having a target nucleic acid molecule and reagents necessary to conduct a nucleic acid amplification reaction to generate amplified target nucleic acid molecule(s) as amplification product(s) of said target nucleic acid molecule, and (ii) cycles a temperature of said reaction mixture to perform said nucleic acid amplification reaction to generate said amplified target nucleic acid molecule(s), wherein said thermal cycler has an operating voltage of no more than about 48 V during said nucleic acid amplification reaction; and
a computer processor coupled to said thermal cycler and programmed to regulate said amplification reaction in said given thermal zone independently from amplification reactions in other thermal zones of said plurality of individually addressable and controllable thermal zones.

45. The system of claim 44, further comprising a detector with plurality of sensors that optically detect optical signals from said plurality of individually addressable and controllable thermal zones, wherein a given sensor of said plurality of sensors detects optical signals from said reaction mixture.

46. (canceled)

47. (canceled)

48. The system of claim 44, wherein said plurality of individually addressable and controllable thermal zones includes indentations that are dimensioned to accept sample containers with biological samples and/or reagents.

49. The system of claim 48, wherein a weight of said system per indentation is no more than 0.2 kg.

50. The system of claim 48, wherein each of said plurality of indentations is dimensioned to hold said sample containers each having a height of no more than 21 mm.

51. (canceled)

52. (canceled)

53. The system of claim 44, further comprising a power source that supplies power to said thermal cycler during said nucleic acid amplification reaction, wherein said power source operates at said operating voltage.

54. The system of claim 53, wherein said power source is a vehicle that provides said operating voltage.

55. The system of claim 53, wherein said power source is a battery.

56. (canceled)

57. The system of claim 56, wherein said thermal cycler cycles said temperature between at least three different temperatures.

58. (canceled)

59. A method for conducting nucleic acid amplification, comprising:
(a) providing a thermal cycler that includes a plurality of individually addressable and controllable thermal zones, wherein said thermal cycler has an operating voltage of no more than about 48 V during said nucleic acid amplification reaction;
(b) receiving a first reaction mixture in a first thermal zone and a second reaction mixture in a second thermal zone of said plurality of individually addressable and controllable thermal zones, wherein each of said first and second reaction mixtures includes a biological sample having a target nucleic acid molecule and reagents necessary to conduct a nucleic acid amplification reaction to generate amplified target nucleic acid molecule(s) as amplification product(s) of said target nucleic acid molecule; and
(c) instructing said thermal cycler to independently cycle a first temperature of said first reaction mixture and a second temperature of said second reaction mixture, thereby conducting said nucleic acid amplification reaction in each of said first and second reaction mixtures.

60. The method of claim 59, further comprising instructing said thermal cycler to terminate cycling one of said first temperature and second temperature while continuing to cycle the other of said first temperature and second temperature.

61. The method of claim 59, further comprising (i) providing a detector having a plurality of sensors that optically detect optical signals from said plurality of individually addressable and controllable thermal zones, and (ii) using a first sensor and second sensor of said plurality of sensors to independently detect optical signals from said first reaction mixture and second reaction mixture, respectively.

62.-66. (canceled)
